(19) United States
(12) Patent Application Publication
(10) Pub. No.: US 2007/0156573 A1
(43) Pub. Date: Jul. 5, 2007

(54) Methods and systems for commoditizing interest rate swap risk transfers

(76) Inventors: Philip Howard Whitehurst, London (GB); Hassan Armand, London (GB)

Correspondence Address: WILMER CUTLER PICKERING HALE AND DORR LLP, 399 PARK AVENUE, NEW YORK, NY, 10022, US

(21) Appl. No.: 11/645,404

(22) Filed: Dec. 26, 2006

Related U.S. Application Data
(63) Continuation-in-part of application No. 11/387,974, filed on Mar. 24, 2006.
(60) Provisional application No. 60/714,424, filed on Sep. 6, 2005.

(51) Int. Cl. G06Q 40/00

(52) U.S. Cl. 705/37

(57) ABSTRACT

A data structure method, class, system and computer program product for trading a commoditised financial claim. The claim obligates one party to pay on demand to a second party on any date an amount transparently determined with reference to a market quote for pre-specified spot-starting benchmark interest rate swap contracts prevailing immediately prior to that payment date. The claim may be a debt obligation of a third party settled on a spot basis. In one optional embodiment, the claim is in securitised form that settles through a securities clearing system, can be traded simultaneously by several dealers, can be listed on major stock exchanges and can be rated by debt rating agencies. There is a linear intra-day and index-linked overnight relationship between (i) the market rate for the pre-specified reference constant maturity swap and (ii) the payment obligation. Alternative bilateral and futures contract embodiments are also disclosed.

### CROSS-REFERENCE TO RELATED APPLICATIONS

This application is a continuation in part of application U.S. patent application Ser. No. 11/387,974 filed Mar. 24, 2006 entitled “METHODS AND SYSTEMS FOR COMMODITIZING INTEREST RATE SWAP RISK TRANSFERS,” which claims priority to U.S. provisional application 60/714,424 filed Sep. 6, 2005. This application also claims priority under 35 U.S.C. § 119 to PCT application U.S. 06/34709 filed Sep. 6, 2006 and entitled “METHODS AND SYSTEMS FOR COMMODITIZING INTEREST RATE SWAP RISK TRANSFERS,” which is herein incorporated by reference in its entirety.

### BACKGROUND OF THE INVENTION

1. Field of the Invention

The present invention relates to the field of interest rate risk management. A number of financial products are available to market participants for managing this risk. The Interest Rate Swap (“IRS”) contract is one such product. The present invention enlarges the set of IRS-risk-based products available to risk managers.

2. Background of the Invention

IRS contracts are long-term bi-lateral agreements between two parties. Individual transactions are executed by private negotiation within an active market. They are generally governed by master documentation, also bi-lateral, necessary to cover the complexities of the relationship between the parties.

Suppliers communicate prevailing IRS market prices to customers via live quoted spot rates Li_{q} (“Live Quotes”) for Reference IRS through assorted media, including printed, verbal and electronic. As illustrated in FIG. 1, Live Quotes Li_{q} are typically displayed electronically as a pre-configured array 10,12 of Reference Tenors κ 2002 with continuously varying quoted figures, in columns headed “Bid” and “Ask”, alongside.

As represented in FIG. 17A, a Reference IRS is concisely identified by its denomination currency RCDC 1001 and constant maturity κ 2002. By selecting RCDC, a new Interest Rate Derivative structure (cIRD class 2000) is constructed and instantiated which draws upon pre defined Yield Curve conventions (YCurve class 1000) specific to RCDC. Each Reference IRS object inherits a set of market conventions, including κ-specific attributes and methods, partially summarised by participants as Quotation 27. Market conventions include fixed payment frequency 1009, fixed daycount fraction 1041, fixed date adjustment centres for payment 1007, floating rate designated maturity 1010, floating daycount fraction 1025, floating fixing offset 1028, floating date adjustment centres for fixing 1004 and for payment 1007 and payment date adjustment business day convention 1008. Users may set and save these conventions where necessary. By loading the set of conventions, a full contract template applicable for use on each trade date can be produced.

in FIG. 1, bid 28B and ask 28A Live Quotes Li_{q} for Reference IRS are made in terms of the percentage rate for the fixed leg. At execution, additional commercial terms Fixed Rate 28E, Notional Amount (currency and amount) 13, Pay/Receive 17 and Counterparty 15 translate the contract template into a fully-defined IRS transaction confirmation. Specifics relating to Counterparty 15 may modify the purely generic template, for example by introducing credit-driven early termination features, though these contract attributes may not be transferable.

Trade date fₛᵢ 14 unambiguously defines all date schedules for fixed 22 and floating 26 cashflows for that day's Reference IRS contract template, including Effective Date sᵢ 2045, and Termination Date s(κ)ᵢ 2038, through application of the market conventions 27. However, customers trading on day fₛᵢ may also select a non-generic Effective Date s(ng)ⱼ 2045 for quotation. s(ng)ⱼ will drive a distinct date schedule. Where s(ng)ⱼ is in the future, a pricing engine is required to derive the fair value forward swap rate F_{q}(IRSⱼ) running from that date. The pricing engine converts the cashflows generated by applying a library of methods to the contract specification into a rate F_{q}(IRSⱼ) by applying a library of methods to an input term structure of Live Quote Li_{q} and deposit market data. Revaluation of existing positions is achieved by applying the same processes, in this case with s(ng)ⱼ in the past, and solving for present value PV_{q} as opposed to rate. In both cases, the link between Li_{q} and F_{q}(IRSⱼ)/PV_{q} is opaque.

Techniques which additionally require volatility inputs also exist for converting forward swap rate F_{q}(IRSⱼ) into forward CMS rate F_{q}(CMSⱼ). A constant maturity swap (“CMS”) rate is related to its IRS rate cousin in referring to an identical underlying swap contract, but the cashflow schedule is truncated to a single payment, in this case on date sⱼ. CMS is a widely used technique, popular for capturing swap rate observations as single cashflows. However, as with F_{q}(IRSⱼ), the linkage between ultimate contractual pay-out, interim contract value and Live Quotes Li_{q} is not transparent.

By executing contracts with an Effective Date s(ng)ⱼ set in the future, customers may be attempting to reduce the problems associated with execution-date-driven date/cashflow schedules. The forward date will roll down ultimately to coincide with the spot date, at which point the contract value will be linked more transparently to Live Quotes Li_{q} as opposed to interpolated rates. In example FIG. 1, contract 2 executed as a forward IRS on trading day fₛᵢ 14 coincides with a spot contract executed off a Live Quote Li_{q} when trading on day fₛⱼ 31. However, the value relationship remains non-linear even here.

Although implemented by numerous commercially available analytics software packages and systems, the methodologies for deriving forward swap rates are sufficiently complex as to obscure the link between input curve and rates F_{q}(IRSⱼ) & F_{q}(CMSⱼ). This would not be a problem in itself, but combined with the large set of swap contracts which emerge from trading the limited family of Live Quotes Li_{q}, there is no method which can standardise the relationships into factors which are relevant for a sufficiently wide set of users. This means exit price transparency is constrained.

Customers can recreate price transparency for themselves by seeking competing assignment quotes when they exit a position. However, a customer is required to communicate numerous transaction terms in order to identify the contract to a third party. These include Counterparty, RCDC, Notional Amount, Pay/Receive, Fixed Rate, Fixed Leg Conventions, First Floating Fixing, Floating Leg Conventions, Effective Date and Reference Tenor. These details must then be input into a pricing engine as described above. Once known, PV_{q} may be subject to further checking processes before an executable price is quoted to a customer. This process is highly inefficient for customer and supplier alike.

The issues described above amount to frictional costs associated with IRS execution. Aside from these execution-related issues, there are equally important pre- and post-execution inefficiencies in the existing IRS dealing framework, including but not limited to the following areas:
(1) transferability—IRS contracts are bi-lateral, each party requiring the consent of the other to modify the terms of the contract. Transfer can take place only by permissoned assignment, and this severely constrains liquidity;
(2) revaluation—Complex financial methodologies as described for exit execution must be applied to revalue outstanding IRS positions. This information is necessary for day-to-day position management;
(3) creditworthiness—counterparties are exposed to each other to honour their obligations to pay cashflow streams into the future. Without sufficient creditworthiness, or mechanisms to provide collateral, counterparties cannot enter the market;
(4) operational support—users need to acquire pricing and booking systems and to maintain back-office processing areas to monitor and exchange ongoing payments streams. This represents a long-term cost burden.
(5) legal/documentation—IRS participants must generally set up an ISDA Master Agreement with every potential supplier to govern transactions, and each can involve a lengthy and costly negotiation. Additionally, each individual swap transaction requires its commercial terms to be documented, which represents a frictional cost at execution;
(6) accounting treatment—changes in international accounting legislation (IAS39, FAS133) have created a complicated environment in which to report a fair and accurate picture in a company's accounts of the results of IRS activity;
(7) regulation—entering into an IRS contract can create a notionally unlimited liability, and the IRS product is defined as a “Derivative”. Many operators are barred by their regulators from dealing “Derivatives” because of the scale of liability they can come to represent;
(8) regulatory capital—suppliers, and some customers, are required to put aside solvency capital to cover exposures associated with their IRS transactions which are costly and not always closely related to the economic risks

### BRIEF SUMMARY OF THE INVENTION

The present invention includes the identification, evaluation and determination of a live spot quote L_{q} for a notional Reference IRS, denoted a Curve Point, related to the live spot quote Li_{q} for a real Reference IRS, in which the value associated with any first fixing on the floating leg of the equivalent real Reference IRS is applied as an offsetting adjustment over the fixed leg of that Reference IRS.

The present invention includes the identification, evaluation and determination of daily rate roll adjustment index factors for each Curve Point.

A first embodiment of the invention is a computer implemented method of trading interest rate risks between a first party trading a first interest rate risk, to a second party for a second interest rate risk. The first interest rate risk is adjusted daily, so that the value of the trade can be determined by reference to a live spot quote for the relevant Curve Point.

Other features of this first embodiment include only trading the interest rate risks for a period of time, where that period of time may be fixed or open-ended. Further, this period of time may be prematurely ended, either by the choice of the parties, or automatically. Another feature of the first embodiment of the invention is that the trading of interest rate risks can be done expressed in either a risk amount or a notional amount. Another feature of the first embodiment of the invention is that the value of trade can be determined based on a published index value that can change daily. Where the change to the index value is based on market data. Another feature of the first embodiment of the invention is that trading can be done on a securities exchange with or without the use of an electronic trading platform.

In all embodiments of the invention, the value of the first interest rate risk is calculated by setting an initial value upon the execution of the trade, then adjusting the initial value on a once-daily basis with reference to a published index value. This index value is derived from market data. The daily value adjustment can also account for trading between different currencies.

In all embodiments of the invention trading of interest rate risk can be done using a graphical user interface displaying an interest rate curve along with at least one interest rate risk instrument. This interface can also be used to present additional information.

By providing a novel data structure, method, class, system and computer program product, these and other objects are fulfilled, as summarised below. The invention advances existing technologies and, through the application of proprietary solutions, Embodiment A represents a powerful innovation in securitising IRS risk and Embodiment D represents a powerful innovation in facilitating the exchange of IRS risk via a futures contract.

Through increased standardisation of the input contract terms, and most critically by taking advantage of the Live Quote Li_{q} set as a permanent reference point, the present invention makes IRS risk transfer more efficient. We eliminate the need for individual users to derive F_{q}(IRSⱼ)/F_{q}(CMSⱼ) for their individual contracts, and move to a regime relying solely on prevailing Live Quotes Li_{q} to produce present values PV_{q}.

Positions in instruments of Embodiment B have very close parallels with spot FX positions. The position in the second interest rate risk is financed by an opposite position in the first interest rate risk, whose balance is set with reference to its initial value. This opening balance adjusts daily, first by application of an interest-based cost/credit attributable to the first interest rate risk position and second by application of an index-based dividend attributable to the second interest rate risk position.

On one hand, by the present invention, share-like securities of Embodiment A can be created which commoditise risk transfer and have unique identification codes within public instrument classifications. These securities possess a permanent and transparent linkage to Live Quotes L_{q}. A price can be quoted, potentially by multiple dealers, upon communication of this identification code, and can be acted on by customers able to settle securities transactions. Tickets can be written by specifying 3 further trade attributes, namely size (currency & risk amount), buy/sell & counterparty. This method and system applies equally for both acquisition and disposal.

On the other hand, we can by Embodiment B of the present invention create open-ended and dated bi-lateral CFDs for which exit execution is as simple as entry execution. Customers can trade from Live Quotes L_{q} made by a dealer's generic IRS trading systems, having communicated Curve Point (e.g “10Y EUR”), size (expressed in risk amount as opposed to notional amount) and Counterparty. Exit price (or prevailing mark-to-market) can be calculated easily and transparently from knowledge of a single additional contract attribute, prevailing Fixed Rate. This takes advantage of the market conventions implicit within the Live Quote L_{q}.

Embodiment C can be differentiated from Embodiment B for example by the additional step of relating the Reference IRS-indexed return to the conventional concept of a principal amount and reapplying a gearing, for example PV01-driven, to the L_{q}-based risk. This is equivalent to manipulating the index components so as to generate total return measures (“T-R Indices”) for the IRS markets. These T-R Indices will capture the development of the present value of positions made up of cash (typically 100% at inception) and a Live Quote-based risk position of given scale.

Embodiment D is a margined CFD, which can for example be brought to market in the form of a futures contract. As well as forming the basis for a contract which could be listed on major international and domestic futures exchanges (each an Exchange), the data structure, method and system of embodiment D could also form the basis for OTC margined contract-for-difference, for example between a bookmaker licensed to take bets on financial market instruments & indicators and its clients.

In the remainder of the document, we may use the following references:

(1) leveraged securities Embodiment A may be referred to as a RateShare or SwapShare; (2) the open-ended FX-style Embodiment B, and margin-traded CFD of Embodiment D traded off-Exchange, may be referred to as Rolling Spot or as Curve Points; (3) a closed-ended swap-style Embodiment B may be referred to as an iMID OIS; (4) a deleveraged Embodiment C capturing total return may be referred to as a Demand Deposit, a Fund, an exchange-traded fund or ETF, a Note, or an exchange-traded note or ETN; (5) Embodiment D traded on an Exchange may be referred to as Curve Point Futures or iMID Futures.

Transferability—Users may be able to buy and sell instruments of Embodiments A & D amongst a trading community. This third party liquidity exceeds that for standard bi-lateral IRS contracts.

Revaluation—Market prices will be available for instruments of Embodiments A & D. All embodiments have a contractual pay-out for value spot connected by simple arithmetic to L_{q}. By this method and system, a more direct and straightforward valuation of holdings is possible for users.

Creditworthiness—In all embodiments, the ability to present risk to every point of the yield curve within contracts which settle spot is a clear advantage. For Embodiment B, parties still need credit lines towards each other; however, the tenor of necessary lines in shortened relative to the Reference IRS risk. In the remaining embodiments, there is no longer a swap between the parties. With embodiment C, a customer effectively collateralises their position with 100% in cash, such that all exposure is from deposit-maker towards deposit-taker. With Embodiment A, the inventive contracts carry an effective cash margin. Holders have risk to the Issuer; Dealers have only DvP risk to buyers. With Embodiment D, buyers and sellers place position-related margins with the Exchange or other trading account provider as demanded under their wider commercial arrangements. The central clearing associated with futures positions means trading of this type could additionally benefit from becoming anonymous.

Trade Capture—Transactions in Embodiments A, B & D are significantly quicker and cheaper to capture than those in conventional IRS. Security and FX ticket processing is much cheaper than for privately-negotiated derivatives.

Cashflow processing—In embodiments A & C, cashflows occur only upon acquisition and disposal of positions. There are no ongoing intermediate flows. This has clear advantages over conventional IRS contracts. Optional alternative embodiments A & C, in which intermediate cashflows occur, can be created and may have advantages in context of certain customers.

Legal—Under Embodiments A, C & D, the need for an ISDA Master between counterparties is eliminated. For Embodiment A, it is replaced by a requirement for securities dealing Terms of Business, a document which is significantly quicker to put in place. For Embodiment D, potential users need to agree to the commercial terms of the Exchange/product provider, and be empowered for dealing CFDs/futures. Embodiment C can be transacted under an ISDA or under other deposit contracting regimes, subject to local regulatory authorisation, or could be packaged as an exchange-traded fund. Embodiment B may be conducted under ISDA or other derivatives documentation frameworks, or may be integrated within FX terms of business.

Documentation—Tickets in Embodiments A & D will be of type familiar to securities or futures traders, being significantly shorter and more standardised than a typical conventional IRS confirmation.

Accounting treatment—The inventive instruments do not, arguably, meet the definitions of a “Derivative” under IAS39. They settle spot as opposed to settling at a future date. The instruments of Embodiment A & C may also involve an initial investment greater than for a conventional Reference IRS, the “underlying” whose value they track. Both characteristics are tests for a derivative under IAS39. The present invention is then a means for replicating IRS risk in at least one embodiment without the need to enter into contracts classified as derivative contracts. Following on from this observation, there is greater flexibility in the accounting treatments available for the instruments.

Regulation—Following on from a non-derivative accounting treatment, and from the observation that embodiment A is a strict asset of the holder, the instruments may attract a less punitive classification by regulators, and may be deemed eligible investments for users currently prohibited from trading “Derivatives”. Such treatments will be specific to jurisdiction, user and regulator configurations.

Transparency of IRS-based risk transfer—By improving the transferability and portability of IRS risk, particularly via Embodiments A,B & D, the present invention introduces greater execution transparency for many users.

Transparency of the Indices—The inventive indices SNIP & SNIPR are new to market users. In one preferred optional embodiment, the rules associated with producing SNIP & SNIPR and other derived indices will be made publicly available. In a further optional embodiment, an existing trade body, for example ISDA®, can be considered as the publication sponsor for the indices. Irrespective, adoption of the indices by major suppliers in contracts will bring credibility to end-users. By these optional methods and systems, the usefulness of the inventive contracts is enhanced.

Regulatory Capital—Embodiments of the present invention provide both outright and net regulatory capital savings. Regulatory capital is defined as capital which a regulated firm must set aside to cover losses associated with position exposures. Exposures are categorised as deriving from operational, credit and market risk. The regulatory capital requirement is not always closely related to economic risk. An impending regime change, from BASEL I to BASEL II, complicates the reference frame, but certain generalisations can be made.

First, so-called BIS add-ons are maturity-based. A shorter contract maturity, as facilitated by the present invention, will lead to a smaller capital charge.

Second, IRS risk governed under ISDA documentation does not net for regulatory capital purposes against securities financing transactions (SFTs), generally governed under a GMRA. With Embodiment A of the present invention, offered alongside a repo transaction, IRS risk is contracted as an SFT. It will now have the advantage of netting against other SFTs.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a schematic diagram of IRS trade execution as effected on automated electronic platforms, and the financial contracts which result.

FIG. 2 is a business process flow diagram illustrating the main processes applicable over the lifecycle of instruments of the present invention.

FIG. 3 is a schematic representation of the New Instrument Launch Assessment Process for instruments of Embodiment A.

FIG. 4 is a schematic representation of the New Instrument Launch Preparation Process for instruments of Embodiment A.

FIG. 5 is a schematic representation of the New Instrument Trade Capture Process for instruments of Embodiment A.

FIG. 6 is a schematic representation of the processes associated with launch, trading and expiry of futures contract embodiment D of the present invention.

FIG. 7 illustrates the process of consolidating market input data.

FIG. 8A is a schematic diagram of data, calculation and storage requirements of the index calculation process of embodiments A, B & C of the present invention.

FIG. 8B is a schematic diagram of data, calculation and storage requirements of the index calculation process of embodiment D of the present invention.

FIG. 8C tabulates the combinations of instruments and positions in instruments and their associated interpretation for risk consolidation and adjustment factor calculation.

FIG. 8D tabulates preferred margin configurations, in both SNIP- and SNIPR-regimes, across market rate scenarios and instruments. For bi-lateral embodiment B, margins are expressed from an end-user's perspective; we reverse them to get the market-maker's perspective

FIG. 9A is a flow diagram showing the attributes, methods and formulas for calculating the SNIF component of the SNIP index.

FIG. 9B is a flow diagram showing the attributes, methods and formulas for calculating the CC component of the SNIP index.

FIG. 9C is a flow diagram showing the attributes, methods and formulas for calculating the QC component of the SNIP index.

FIG. 9D is a flow diagram showing the attributes, methods and formulas for calculating the SNIF component of the SNIP index when using an optional curve-building embodiment to account for movements in money-market rates between fixing time and close.

FIGS. 10A and 10B shows an example of SNIP and ELA index display screens.

FIG. 11A illustrates example windows leading to execution of bi-lateral instruments of the present invention over an electronic platform integrated with IRS execution.

FIG. 11B illustrates example windows relating to execution of bi-lateral instruments of the present invention over an electronic platform integrated with spot foreign exchange execution.

FIG. 12 follows from FIG. 11A and illustrates example windows leading to execution of security instruments of the present invention over an electronic platform.

FIG. 13 illustrates an example transaction ticket in a security embodiment of the present invention, including the Rate/Price and PV01/Notional toggles.

FIG. 14 illustrates a novel instrument display structure for security instruments of the present invention, allowing co-ordinate sensitive display to aid evaluation and execution.

FIGS. 15A and 15B illustrate example instrument attribute displays via which users can view execution and pre-execution security instrument data respectively.

FIG. 16 is a flow diagram showing the attributes, methods and formulas for calculating the Trigger Chance.

FIGS. 17A 17B & 17C are schematics illustrating the classes, interfaces and calculations according to the present invention.

FIGS. 18A and 18B are a schematic illustration of the cross-functional processing systems of the present invention.

FIGS. 19A, 19B, 19C and 19D are event trace diagrams for ownership transfer instruments of embodiment A of the present invention, respectively secondary market buying and selling, safeguard termination processing, holder put processing and issuer call processing.

FIG. 20A shows an example display configuration for inventive instrument windows and first order risk report, alongside example index series data, following the position described in FIG. 11B, wherein the risks are reported from an IntraDay perspective.

FIG. 20B shows an example display configuration for inventive instrument windows and first order risk report, alongside example index series data, following the position described in FIG. 11B, wherein the risks are reported from an Overnight perspective.

FIG. 20C shows the first order risk report displayed in FIG. 20B along with additional second order risk data.

### DETAILED DESCRIPTION OF THE EMBODIMENTS OF THE INVENTION

The dependence of contractual cashflows on execution date for otherwise identical transactions is a major obstacle in efforts to commoditise IRS risk transfer. It is also an important contributor to high production costs. A limited family of benchmark IRS quotes Li_{q} lead to a much larger family of executed contracts. Commoditisation efforts to date, such as Exchange-traded futures, have focussed on pre-selecting an arbitrary standard IRS contract with a fixed absolute Effective Date, and trading some function of the present value of its future cashflows. Major drawbacks of this approach are the lack of transparency between prevailing quotes Li_{q} and contract prices, and the methodological complexity in the pricing relationship. Efforts to create open-ended instruments have been restricted to long-only securitised products, with imprecise factors attempting to account for periodic roll. In all cases, poor design has led to limited customer uptake.

However, contract payments and interim contract values are not transparently related to Live Quotes L_{q}. Most importantly, they are currently tradable only with CMS fixings on fixed absolute dates. There is no equivalent of the entry/exit timing flexibility delivered within the inventive product framework, which standardises relative date relationships and renders open-ended spot-settled contracts possible.

We outline four embodiments of the present invention by way of example, while noting that these examples do not to exhaust the set of alternative embodiments of the invented data structure, method and system. The embodiments described differ most fundamentally in terms of the degree of leverage available to users.

We describe bi-lateral, futures and security embodiments of the present invention, which have an economic performance linked directly, permanently and transparently to Live Quotes L_{q}. These instruments are characterised by a linear intra-day relationship between their spot pay-out and L_{q}. For positions held overnight, an index adjustment factor ELAᵢ, described in detail below, must be applied to the contracts (or in case of Embodiment D in relation to positions in the contracts). The index value accounts for risks held and resets the fair contract value (or in case of Embodiment D position value) such that the linear intra-day relationship is re-established for trading on the next good business day.

By application of a novel data structure, method and system of the present invention over existing practices in the IRS market, these index adjustment factors ELAᵢ can be identified, produced and distributed. The precise formulation varies according to the contract context.

The inventive adjustment factors SNIPᵢ below capitalise the fair-value overnight roll when considering a Live Quote L_{q} as a risk-bearing asset in its own right. SNIPRᵢ is the rate equivalent of SNIPᵢ, being a spot/next financing rate for risk-bearing asset L_{q} analogous to a spot/next LIBOR rate for a cash balance.

For all inventive contracts, the value evolution can be governed by application of (i) capitalisation factors SNIPᵢ or (ii) rate factors SNIPRᵢ. We choose between these two regimes, which will yield identical results ignoring rounding, to maximise operational convenience.

The SNIP & SNIPR indices are core indices within the inventive product family. In combination with inception cash positions and ongoing daily mark-to-market valuations, we can create derived indices which apply to embodiments with great flexibility over investment leverage. Where these embodiments possess a maximum or minimum pay-out, a further option component to the derived instrument index is identified and valued.”

The data structure, method and system presented enables the creation of an index credible to market participants as a valid independent reference source for use in financial contracts.

We describe in detail the methods used to produce the preferred embodiments outlined. We also describe the implementation of these methods to create a robust trading environment for examples of the output products. They have been engineered to fit within existing trading systems where possible, with extensions to these systems described where necessary or informative. Trading of the inventive contracts by suppliers involves risks which are of a quantified scale and a familiar type.

As a final measure, we describe a method and system for communicating the factors, and for identifying and communicating other real-time instrument data which increases the usefulness of the inventive instruments.

Design Approach

The design approach for the data sets and associated software of the present invention adopts C++ language and an object-oriented (“OO”) methodology. The approach is also implemented and qualified using spreadsheets.

The inheritability and polymorphism which are central to an OO design approach allow us to take advantage of existing interest rate derivatives (IRD) system solutions, given that many underlying algorithms, methods and data structures are shared. As a result, the differences associated with the present invention can be highlighted and kept concise. Throughout this document, and with regard to computer software delivery systems mentioned here, the terms Class, Object and Parts are used interchangeably. They are based on C++ Classes, comprised of Attributes(Properties), Events/Signals(change in status) and Actions/Methods.

Time-critical calculations involving both static data and market data are implemented using DLLs. All the critical data structures are stored in shared memory using STL collection classes.

The helper classes and functions, such as system functions, C++ libraries functions, I/O streams and SQL server database tools which are used but not altered by this invention, are excluded from the description.

With respect to interfacing to the classes and data structures which define and implement both the prior art and the inventive instruments, we take the following approach:
a) Generalised data type class SIRD. This provides arrays of characters. It is used as a generic data class for data types required by IRD class member attributes, action and methods. It provides a full range automatic conversion from and to numeric types, including integer, unsigned, short, long, double, float and char. It also handles text date to number conversion. All attributes are of type SIRD class. Where needed, this also provides an interface to underlying mathematical and financial libraries.
b) Access to data, or attributes. A complete attribute interface includes (i) member functions which return the value of the attribute and set the value of the attribute; and (ii) events (signals) to notify other parts when the value of the attribute changes. The setting of an attribute member function is performed by setAttributeName(attributeType aAttribute) e.g. setCalculationDate(“Dec. 9, 2005”). This approach applies to all the class attributes mentioned in this application. The functions are not listed. The get member function value of an attribute is defined in the form of attributeType& attributeName( ) e.g. calculationDate( ). This approach applies to all the class attributes mentioned in this application. The functions are not listed. In the above example, a call to calculationDate( ) returns Dec. 9, 2005.
c) Access to the behaviour of a part, or actions. These represent tasks which any class or part can ask any other part to perform. Examples include “calculate CCi”, “open a window” or “add an iMID instrument object to a collection of iMID instruments” (portfolio).
d) Event notification. By signalling events, a class (part) can notify other parts that its state has changed. For example, the DAᵢ calculator signals an event to notify other listening objects when it has completed the calculation or when it has encountered an error; or the end-of-the-day timer signals an event when it is expired; or a safeguard event handler can signal an event when the market rates reaches the lower or upper barriers. Events can also be signalled when the value of a part attribute changes, such as when interest, rate volatility(Vol field) is changed either manually or by market data feed input handlers.

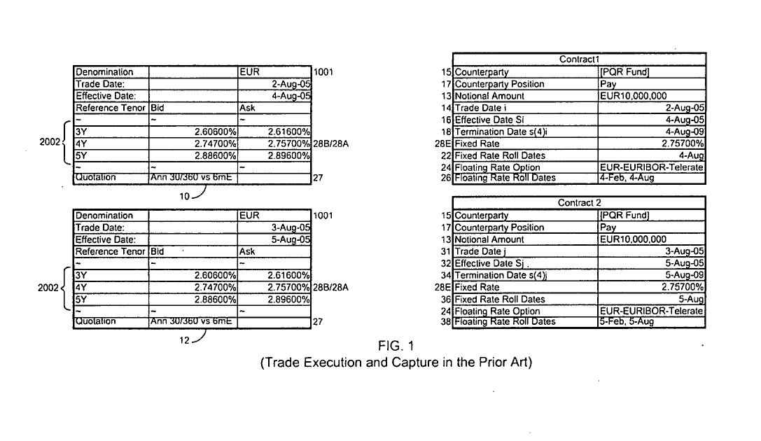

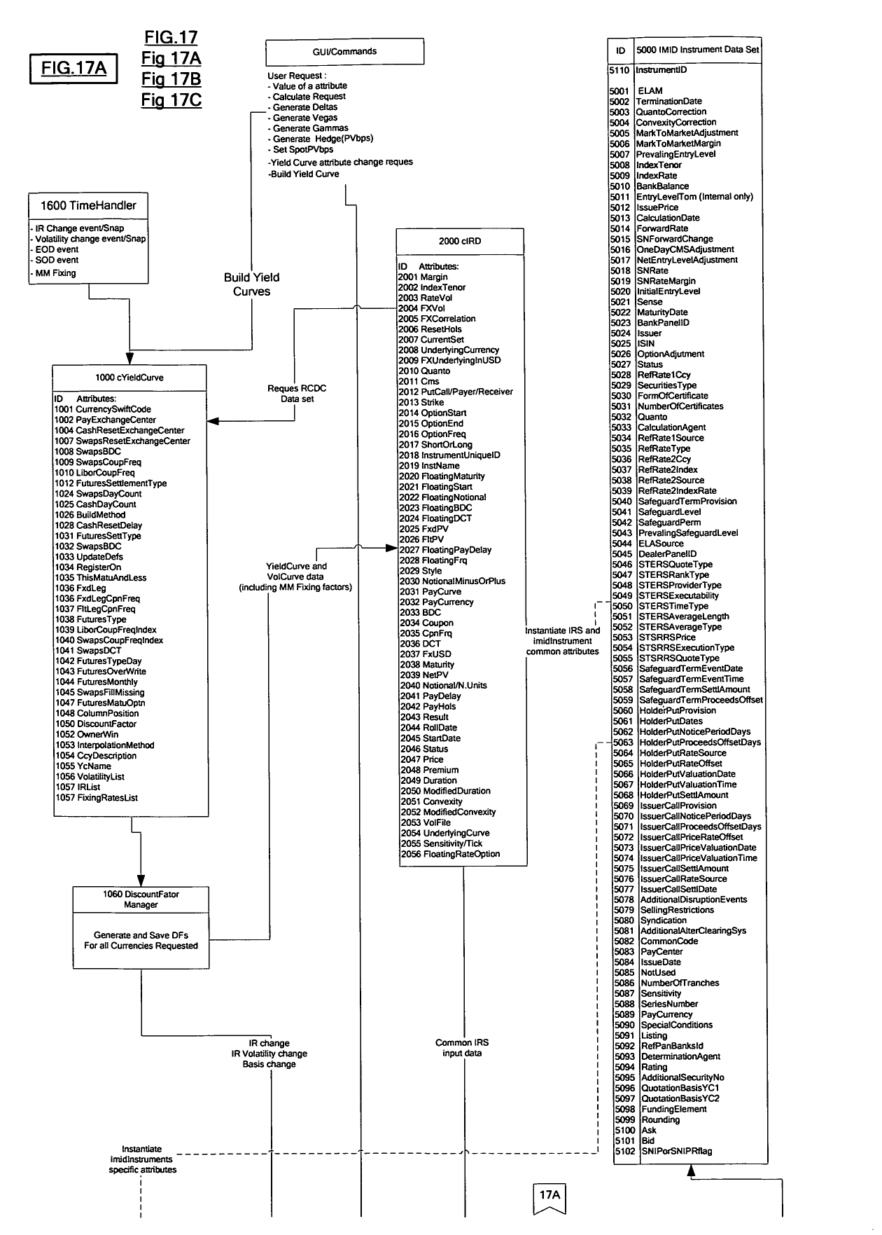

The inventive instruments inherit substantially from prior art handler classes and libraries. We limit our class descriptions to functionality and calculations required to integrate successfully between the inventive instruments and the prior art. We have the following prior art classes:
1—Yield Curve Class (cYCurve) 1000. This prior art superclass is responsible for requesting, receiving and maintaining market data feeds such as rates for Money Market, Futures and Swaps and IR Volatility instruments. It also manages currency conventions, exchange holiday centres, quotations basis and interpolation methods. Each curve can be customised according to the requirements of the specific inventive instrument 5000. The curve 1055 is then named to identify the configuration. During iMID instrument build and calculation, the instrument conventions and quotation basis attributes are instantiated from the particular configuration of named curve 1055.
2—Interest Rate Derivatives class (cIRD) 2000 (illustrated in FIG. 17A). This is a prior art superclass providing calculation attributes, functions and methods for Prior Art illustrated in FIG. 1. It provides handlers for existing vanilla, exotic and structured interest rate derivative instruments including but not limited to Fixed, Floating, Swaps, CMS, Bonds, Options, Cap and Floors.

We have the following inventive instrument data set and classes, extending IRD:
1—iMIDInstrument Record 5000: This is a generalised data structure for maintaining all aspects of an IMID instruments from inception to termination. These records are stored and maintained in database for day-to-day processing and updates.
2—cImidInstrument 3000: cImidInstrument class is a derived class from cIRD 2000 superclass. It inherits and extends the capabilities of cIRD to handle ELA Index and End-Of-Day (EOD) calculations 1700. Specifically cIRD's CMS, Option, Forward Rate and Convexity Correction calculations are used in accordance with this invention.
   Curve Point Instantiation

In the prior art, quoted IRS rates Li_{q} are a gateway into IRS contracts with fixed absolute dates. The κ-year IRS rate quoted on one day does not lead into the same IRS contract as that quoted on another day.

By the present inventive framework, we can come to treat quotes Li_{q} as a gateway into positions in a point, fixed relative to the quotation date, along the yield curve. We do so by a process of manipulation. We label these discrete spot-relative points along the yield curve as Curve Points. Positions taken one day homogenise with those taken on other days. The directly additive or offsetting nature of these positions distinguishes the inventive regime from the prior art.

Each Curve Point is defined by a set of attributes and methods identical to those which define a Reference IRS, save for the permanence of the relative date schedule.

For a generic spot-starting IRS, the first short-rate fixing FLT_{Fi}¹ on the floating leg typically occurs on the trade date fₛᵢ. This fixing relates to a defined source 2056 and to a defined floating index tenor 2028, with start date sᵢ and maturity date s(1₁)ᵢ. Once fixed, the first payment on the floating leg of the swap become known.

The presence and timing of the fixing gives rise to an effect which can be relevant to the relationship between Curve Point quotes L_{q} and IRS quotes Li_{q} within a given day. One relationship prevails prior to the short-rate fixing, and is supplanted by a second relationship after the short-rate fixing. We refine our notation by denoting the live IRS quotes made during these periods as Li(a)_{q} and Li(p)_{q} respectively.

In an optional embodiment, as derived in Annex A.vi, we define the following relationships with the live quotes L_{q} for inventive instrument business (explicitly showing the κ-dependence of the quote which is generally suppressed):
L_{q,κ}=Li(a)_{q,κ}
L_{q,κ}=Li(p)_{q,κ}+δ_{q,κ}

Rates Li(p)_{q,κ} are forward-starting Par-coupon instruments; rates L_{q,κ} are their spot-starting equivalents.

For many ongoing processing functions, excluding the generation of SNIFᵢ and live instrument pricing, Curve Point quotes and Reference IRS quotes are interchangeable on a practical level, for example in calculating CCᵢ, QCᵢ, MAᵢ, and OAᵢ. This has the operational benefit that adjustments δ_{q,κ} may be omitted from trade maintenance regimes where agreed between the parties, and may rely on Reference IRS rates.”

### Security Issuance Framework (Embodiment A)

Securitisation involves the repackaging of (non-marketable) expected future contracted cashflows to create standardised marketable investment securities. The issuance framework described here facilitates delivery of the interest rate risk profile of the present invention to potential users in securitised form.

Leveraged IRS risks are often packaged in securitised form as warrants, essentially an option profile in securitised form. Warrant prices do not move one-for-one with their underlying on an intra-day basis, and they experience time decay when held overnight.

By inserting a publicly-known in-the-money termination mechanism into instruments of embodiment A, the time limit can be removed. Combined with the overnight indexing process, this leads to one-for-one intra-day performance of the instrument price relative to its underlying Live Quote L_{q}. It also means that the instruments do not suffer from time decay.

The type of issuance framework described is well known and already implemented within large international banks with significant fixed income markets activities. However, because it is unfamiliar as far as IRS risk transfer is concerned, we provide a summary here.

A security of Embodiment A is an asset of one party, the Holder (lender) and a liability of a second party, the Issuer (borrower). This differs fundamentally from a swap transaction, which can potentially become and asset or a liability of either contracting party. This difference is one of the critical characteristics of embodiment A of the invention.

The security is launched primarily for the benefit of potential users, by which term we mean the set of potential market-makers, traders, buyers, investors or holders. Nonetheless, we need an Issuer of the securities.

In one optional embodiment, we create a special purpose company (“SPC”) to act as Issuer. This allows the greatest degree of control over the method and system by which users of the invention can be serviced.

In an alternative embodiment, the Issuer is found from within the set of security Dealers or their parent organisations. Use of this type of issuer is likely to involve lower issuance costs. Since these securities would be associated with an individual Dealer, this is a good alternative for individual Dealer indices or end-user pockets.

A third alternative is to use an existing financial institution, of very high credit quality and low risk-weighting, from outside the set of parties otherwise involved.

In all cases, the Issuer uses the issuance of securities to generate funding for its general activities. It has no desire to retain the economic exposures associated with the securities themselves. It will convert the risks acquired from securities issuance into a conventional funding profile through the use of hedging derivative contracts.

The securities themselves will be senior debt obligations of the Issuer. For SPC issuance, the obligations will be secured by hedging contracts with security Dealers and other supplier banks, in the form of deposits and swaps. Specifically, each individual series of securities (“Series”) will be secured by a segregated set of hedging contracts. This standard technique provides comfort to Holders, and enables rating agencies, such as Moody's, S&P & Fitch, to rate each Series as a function of the ratings of the hedge partners. Each Series may take the form of bearer or registered securities.

Since there will be many Series outstanding at any given time, and an ongoing demand for issuance of new Series, a security issuance program (“Program”) will be set up for the Issuer. This acts as the master framework for operational purposes, with each Series benefiting from the set of services laid out in an Agency Agreement. This will cover the responsibilities of the Issuer and of the security Dealers, as well as defining the roles of issuing & paying agent (“IPA”), registrar, transfer and calculation agents.

The Program also acts as a reference with respect to common instrument characteristics, thereby representing a method and system for efficiency in documentation. Each Series is governed by a Pricing Supplement, which defines the commercial terms and conditions applicable for that Series. It cross-references the Program definitions unless specifically over-ridden.

The Series are represented by a global security, which in the case of bearer instruments will be deposited on the Issue Date with a common depositary for inclusion within the chosen clearing systems, such as Euroclear/Clearstream or any other clearing system available as part of the Program framework. The Program allows for efficiencies in the listing of a Series on one or more major stock exchanges, according to a process of prior approval of the Program in the first instance, or by mutual recognition. It allows similar efficiencies in obtaining a credit rating from one or more of the major rating agencies, following a process of review and vetting of the Program documents.

The instruments settle spot within the chosen clearing system(s) under standard securities settlement practices (Delivery versus Payment, DvP). Each Series will have an ISIN (International Stock Identification Number) and/or other relevant securities codes according to the market(s)/system(s) in which it is traded.

By this method, parties trading the risk have no requirement for term credit lines towards each other. Equally, there are no long-lived cashflow obligations in either direction. Thirdly, parties need access to a securities settlement account and need securities dealing terms of business in place with each other, rather than more onerous than master IRS framework documents.

Buyers have no exposure to the seller other than a DvP settlement risk (generally 2 business days), and are exposed to the Issuer up to a maximum equal to the invoice amount for the securities. The seller is exposed to the short-term DvP risk on the buyer, and incurs no exposure to the Issuer. Also, since the securities settle spot, for embodiments in which there are no distributions, there are no ongoing cashflow streams to capture and manage.

The jurisdiction of the Issuer is chosen such that payments in respect of instruments launched under the Program umbrella will not be subject to withholding or deduction in that jurisdiction (subject to certain exceptions). The instruments will be governed by the governing law of a major international financial centre, such as English law. Certain selling restrictions will apply.

### Issuance of Individual Series (Embodiment A)

In a preferred embodiment, instruments will be issued with a perpetual maturity, subject to early termination provisions defined in the Pricing Supplement, and will not carry any distributions. Instruments can be issued which possess a scheduled maturity date, and which offer periodic distributions, such as the aggregate Entry Level Adjustment credit over a pre-specified period where positive, subject to demand.

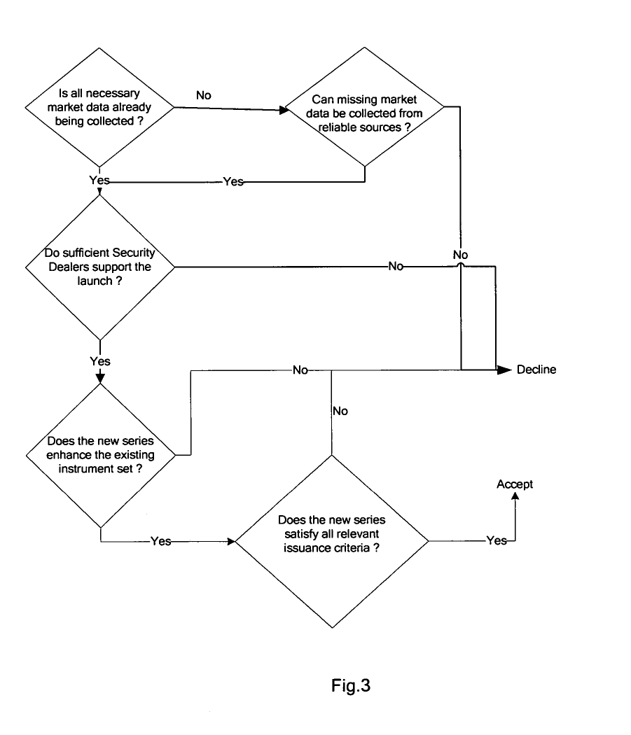

Security Dealers, whether individually or as groups, may initiate the launch of new Series with a New Instrument Launch Request 100. On receipt, the administrator conducts a New Instrument Launch Assessment Process 200 as per FIG. 3. Amongst other things, the process identifies data required for index calculation on the new Series but not already collected, and assesses whether such data can be sourced. The process may also address new Series compliance issues. As a result of the process, a decision to accept or decline the new Series is made.

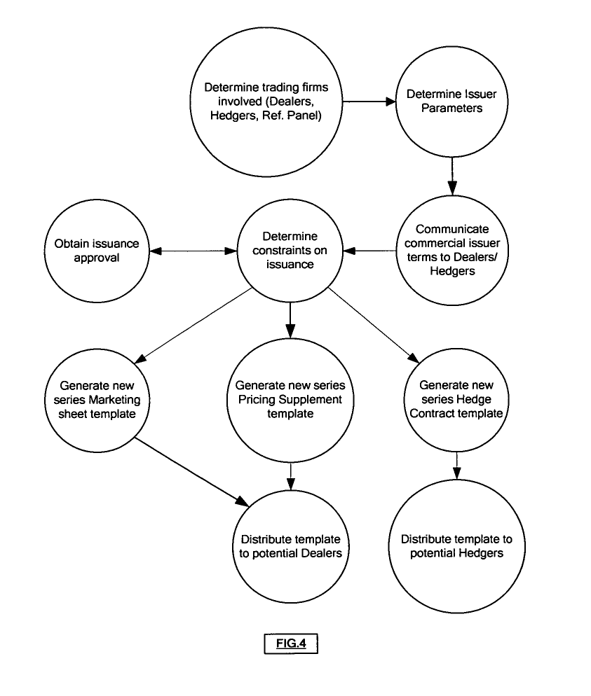

Upon acceptance, the administrator conducts a New Instrument Launch Preparation Process 300 as per FIG. 4. A set of potential participating parties (Dealers, Issuers, Reference Panel Banks and potential hedge providers) may be identified. Commercial terms applicable for each Issuer, such as funding level, as well as any constraints within which Dealers operate in finalising potential execution terms, may be determined.

Record builder 600 creates templates 5000 for security and derivative contracts which are saved into database 220. Record builder 600 enables report server 900 to create pro form a documents to serve as a basis for (i) the Pricing Supplement for the new Series, and (ii) the Hedging Derivative Contracts between the Issuer and Hedge Counterparties (potentially multiple).

Record builder 600 produces templates 5000 based upon a data structure which encompasses both securities market terminologies & definitions and derivatives market terminologies & definitions. The necessary derivatives contracts employ the various ISDA definition schemes, and an FpML version has been devised. The underlying data structure for the inventive contracts has been translated into FpML-, ISDA- and securities markets schemas and data structures to the extent possible. For a full elucidation of the inventive instruments, both the ISDA- and FpML-definition schemes require extension and modification, and the appropriate finalised form of the extension will be discussed with the controlling bodies in due course.

The prepared pro form a datafiles and documents are communicated to the requesting security Dealers and identified Hedge Counterparties by the report server 900. These parties are now primed and may proceed to execution, furnished with matching base terms and conditions.

In cases where immediate issuance is not possible, further elements enter the process. The desire for each Series to be traded by multiple dealers may elongate the issuance process when developing further issuance currencies, and the administrator may intermediate in the provision of standardised data sets to prospective security Dealers in an index validation process. In emerging currencies especially, the risk appetites of Dealers may vary across a panel, and the administrator may be responsible for arriving at mutually acceptable instrument parameters such as Safeguard Premium levels. A set of rules will be developed between the involved parties to cover frequently arising issues. Examples of such rules might be that (i) the Issue Price of an instrument must be sufficiently high for OA₁ to equal zero at the degree of rounding employed, or that (ii) new Series on pre-specified terms are issued as soon as the likelihood that an existing Series will experience Safeguard Termination rises above a given threshold.

### Optional Method and System of Trade Capture (Embodiment A)

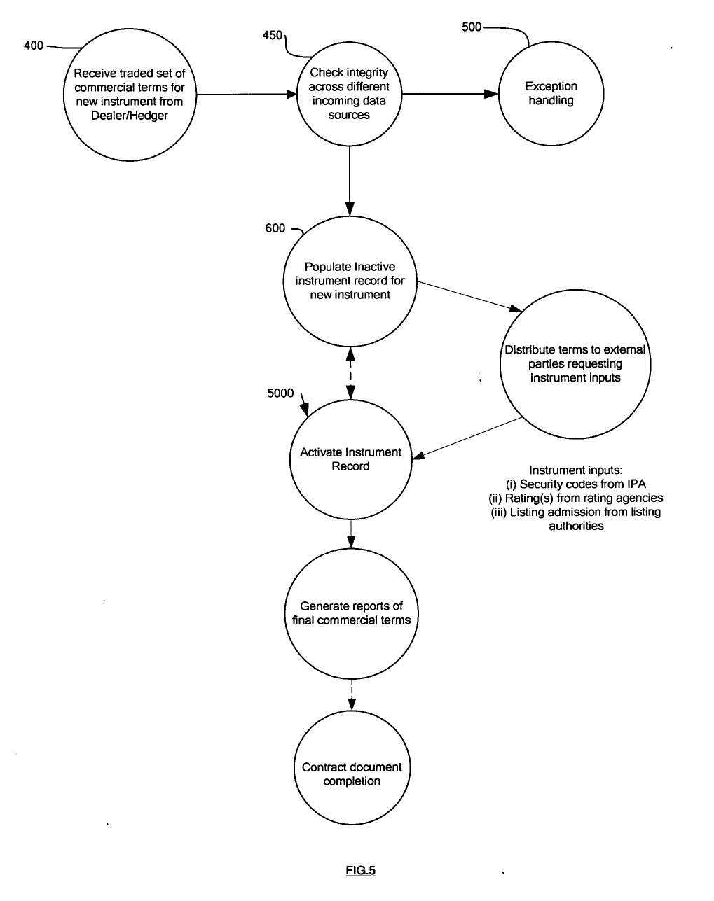

Upon execution, the group 5023 of involved security Dealers and Hedge Counterparties provide the administrator with filled-in execution copies 400 of the templates, which are then used by the record builder 600 in the New Instrument Trade Capture Process illustrated in FIG. 5.

Amongst other parts of this record building process, the inactive instrument record 5000 is populated with the incoming data. An integrity check 450 between incoming documents is performed to validate commercial terms. Non-matching terms are managed via an exception handler 500. The report server 900 communicates executed terms once validated to (i) the IPA with a request to be assigned an ISIN 5025 and series number 5088; (ii) a listing agent potentially with a request to be admitted for listing 5091 on an exchange; (iii) a rating agency potentially with a request for the instrument to be assigned a rating 5094. The instrument record 5000 is activated upon receipt back from the IPA of securities codes and Series number. This information is incorporated into datafiles for communication to the security Dealers and Hedge Counterparties. The administrator may also have responsibilities with respect to management of the completion of signed copies of Pricing Supplement and Hedging Derivative Contracts. Copies of these documents for signature will be exchanged as long-form text documents.

The IPA lodges the signed Pricing Supplement together with a Global Security with the Common Depositary for Euroclear Bank S.A./N.V. as operator of the Euroclear system (“Euroclear”), or according the procedures appropriate given the clearing system used. The securities are then established within the chosen clearing system used, and are credited to the IPA's account. The security Dealers are then able to buy the securities, in exchange for cash which will be passed by the IPA to the Issuer's account, to support the component DAᵢ within the Entry Level evolution.

### Futures Contract Issuance Framework (Embodiment D)

This issuance framework facilitates delivery of the interest rate risk profile to potential users in the form of an Exchange-listed futures contract, or as a margined CFD offered by an individual dealer on a bi-lateral basis. References to futures contracts/Futures Contract Series below should also be taken as references to margined CFDs traded outside recognised Exchanges.

A position in a futures contract can potentially become and asset or a liability of either contracting party. However, unlike embodiment B, trading counterparties are not at risk to each other, but rather against the central clearing agent acting on behalf of the Exchange.

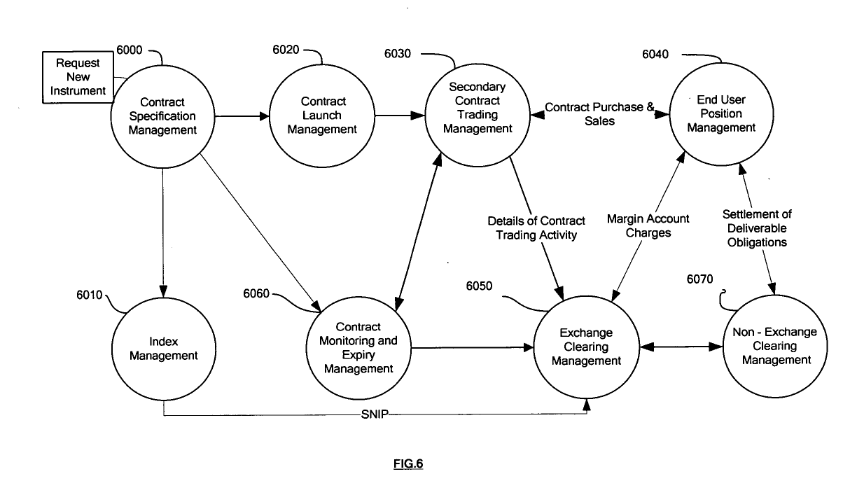

We illustrate the full process in FIG. 6. The Exchange sets the contract specifications via process 6000 prior to launch. These include quotation basis, trading unit, price units, all covered in Instrument Embodiments a), and instrument codes, as well as contract expiry definitions covered separately below. There is no limit on the scale of the open interest in a given contract, as distinct from the securities of Embodiment A.

The Exchange also sets rules and procedures for Secondary Trading Management 6030. These include trading calendar, trading hours, trading system and margin requirements, and are covered in Secondary Market (Embodiment D). It is also likely to provide and maintain systems and services in support of secondary trading

Regarding contract expiry, futures contracts typically have an expiry date. This expiry date represents a point at which trading in the contract ceases and outstanding positions are settled against an Exchange Delivery Settlement Price FDSP. This often takes the form of physical delivery of the contract underlying in exchange for a cash payment (“Physical Settlement”). It can alternatively take the form of a cash payment in isolation (“Cash Settlement”).

One of the major obstacles to creating a futures contract based on IRS rates relates to this physical delivery of the underlying, for the reasons given previously in Background of the Related Art. By the present invention, we create two solutions to these problems.

In a first optional embodiment, we make possible a Futures Contract Series for which there is no expiry date, and which therefore runs in perpetuity. As a result, we eliminate the need for this physical delivery step and process. Positions taken can be held for as long as process 6030 is maintained by the Exchange. As such, we have created a clear advantage over existing technologies.

In a second optional embodiment, the Futures Contract Series can be assigned an expiry date, in line with many existing futures contracts. Here, we introduce the need for a process 6060 to govern contract expiry monitoring and management. Recognising the objections to physical delivery of the underlying conventional IRS contract, we propose a novel instrument as eligible for delivery under Physical Settlement, being an instrument of the type described in optional embodiment A of the present invention. Eligible deliverable obligations will be defined by a set of rules and criteria within process 6000 including Reference IRS, Issuer credit quality and outstanding issue amount.

Within process 6060, FDSP for the Futures Contract Series is set. In one optional embodiment, FDSP is set by the Exchange as the trading price of the Futures Contract Series at the expiry time on the expiry date of the contract. Price FDSP can be translated to and from a reference rate AFDSP for the underlying Reference IRS on the expiry date according to the direct arithmetic relationship in (1Fa) or (1Fb) as appropriate. In a second optional embodiment, FDSP is set by reference to one of a number of existing benchmark Reference IRS fixings. In a third optional embodiment, a new market rate fixing could be established for the purpose.

For Cash Settlement, contract positions are valued at FDSP and a final Margin Account settlement made. Users are thereby forced to exit the risk position.

For Physical Settlement, once FDSP is set, securities of a type described in embodiment A are assigned a futures delivery price P_{FDSP} equal to the difference between the prevailing Entry Level for the security on expiry date i for value sᵢ and Λ_{FDSP}(P_{FDSP}=η(Λ_{FDSP}−ELᵢ)). Each security therefore has its own P_{FDSP}. We translate contract position sizes into securities position sizes in a straightforward process according the ratio of their price sensitivities to a 1 basis point move in the underlying Reference IRS.

The concept Pay/Receive is absent from the Futures Contract Series. It is present for instruments of embodiment A. The Exchange must set rules regarding the delivery of Payer and/or Receiver securities in settlement of open contract positions at expiry. In one optional arrangement, holders of a long Futures Contract Series position with quotation basis (1Fa) receive Receiver securities against payment of cash equal to P_{FDSP} for that security; holders of a short position deliver eligible Receiver securities against receipt of cash equal to P_{FDSP} for that security. Other optional arrangements are possible. In all cases, the settlement mechanism is a pre-defined part of the contract specification.

Input Data Manager 1600

Market data is required for the performance of both Real-time and EOD processes.

Real-time processes will be offered in support of trading in individual contracts of the present invention. Safeguard Event management is the most critical of these, as applies in embodiment A. The provision of a live projection of tonight's SNIPᵢ would be a further example.

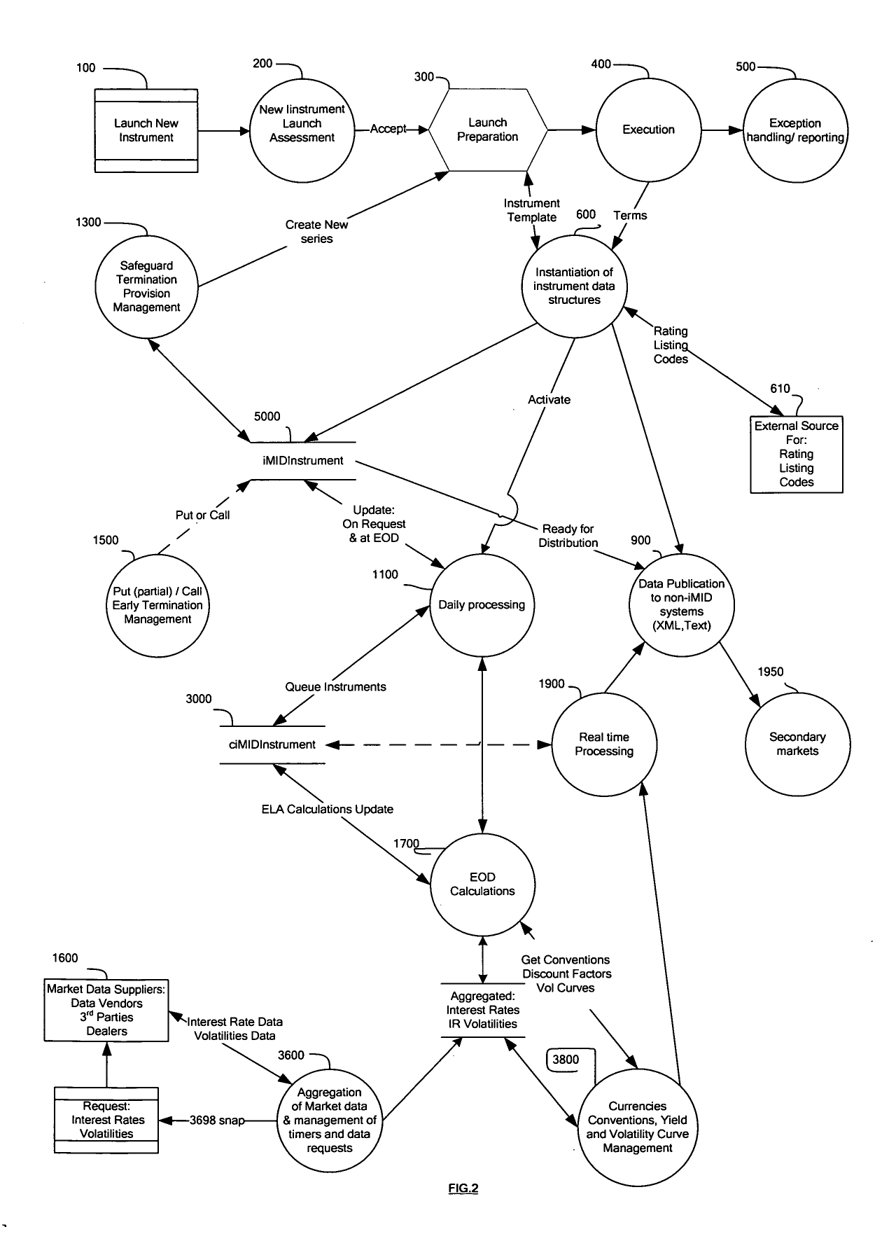

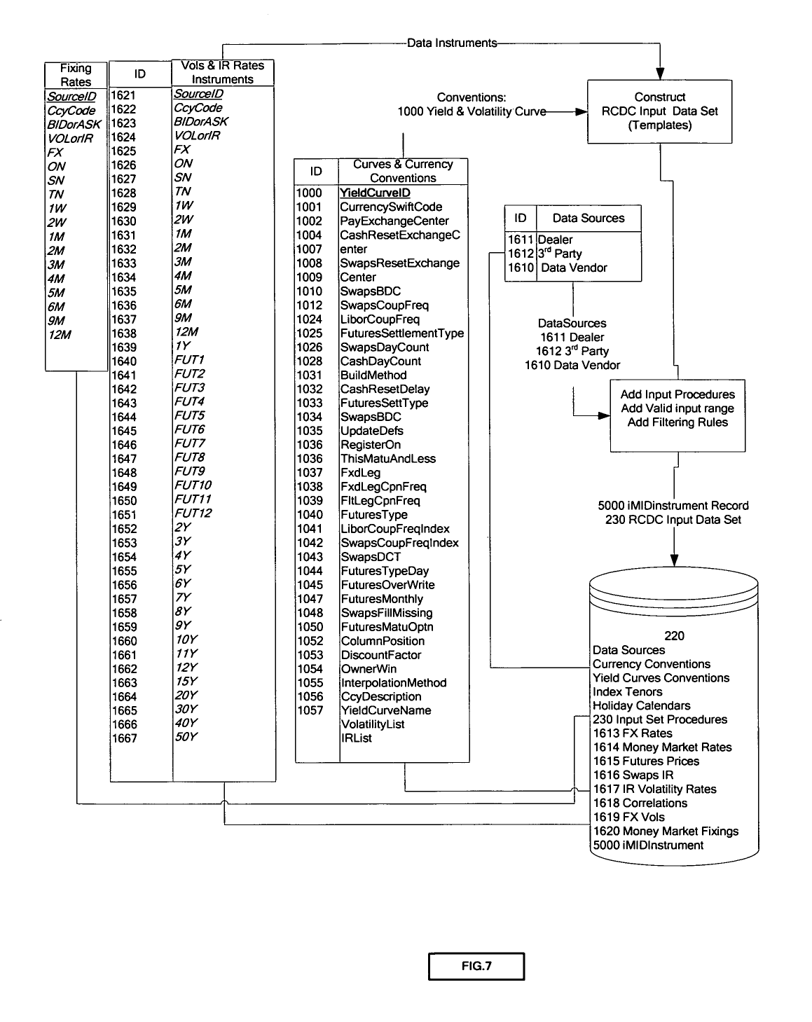

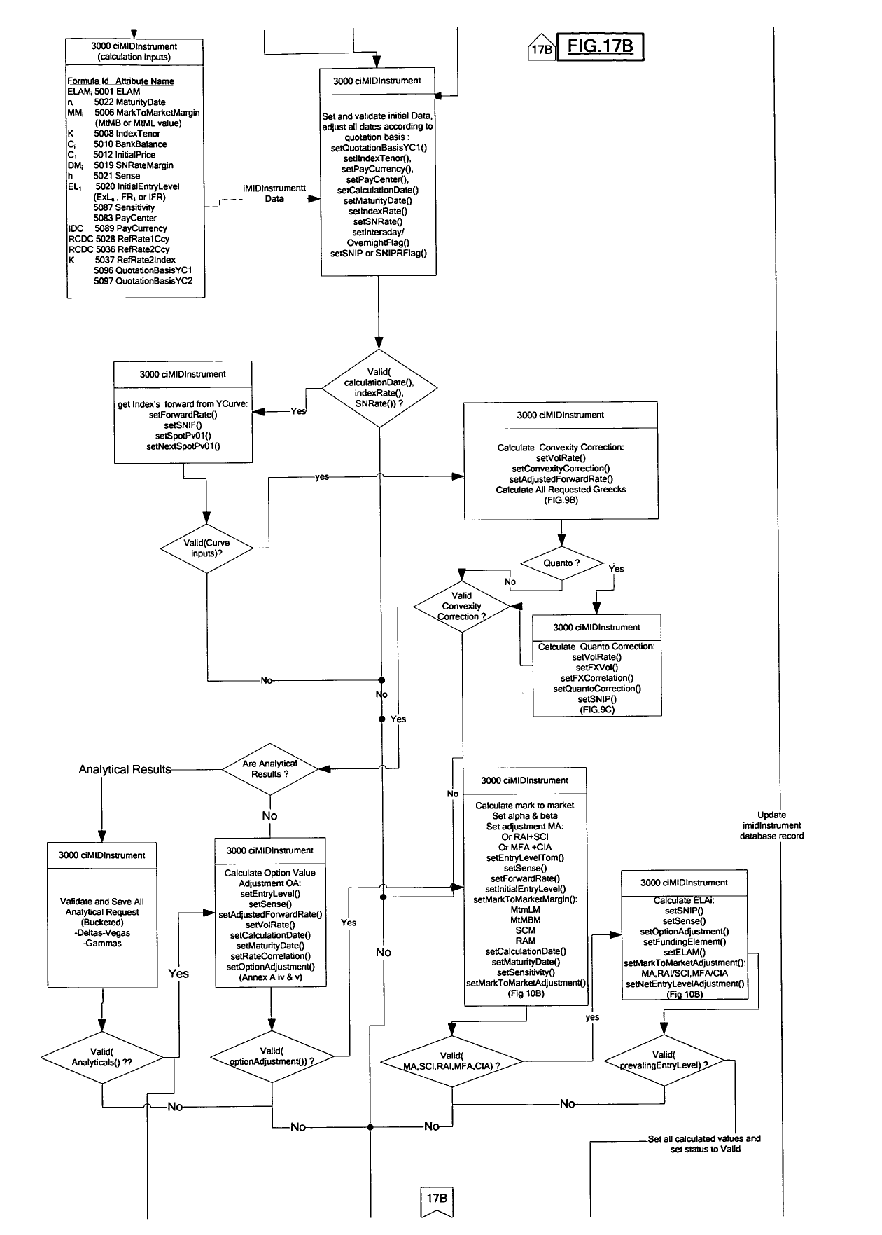

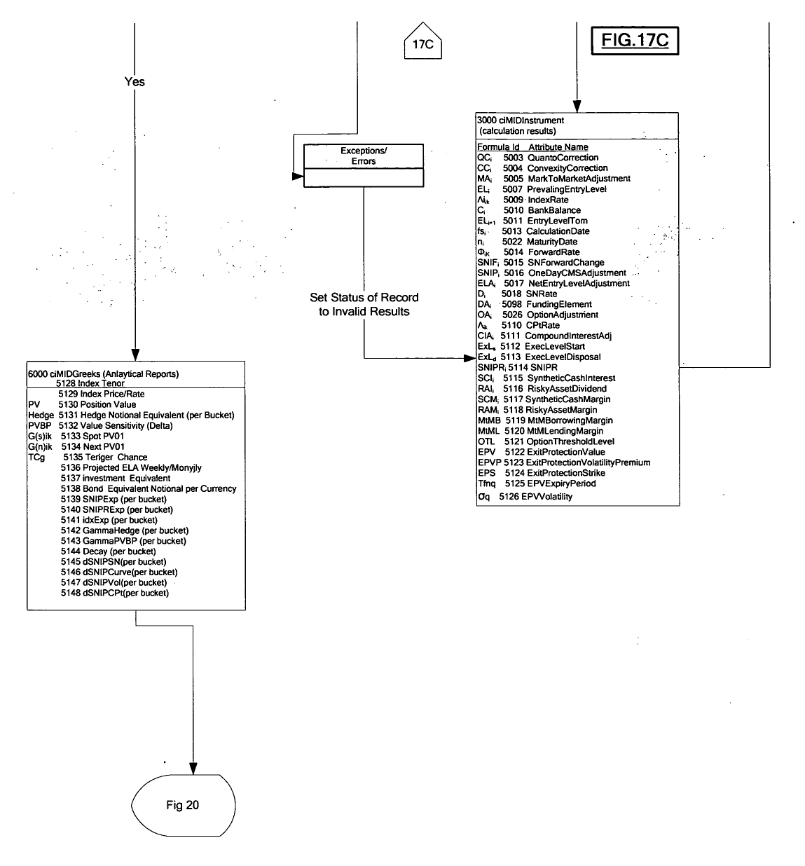

FIG. 2, FIG. 7 and FIGS. 18A & 18B jointly show the process of consolidating market data to be used as inputs to EOD processes 1700. EOD processes 1700 are performed once daily in respect of each instrument.

Market data 1600 will come from three source classifications. Dealer 1611 are defined as individual firms engaged in the trading of Index-linked instruments. Third Parties 1612 are defined as individual non-Dealer firms. Vendor 1610 are defined as commercial market data vendors, for example money brokers or information vendors.

From each source, incoming data may be in the form of a continuous live feed, or be prompted by timed request to the data supplier. Continuously fed data will be subject to periodic snapshot for data management purposes.

For each outstanding instrument 5000 recorded in the database 220, an input data set is compiled. This lists the required data items (each an Instrument Input Data Item), in preparation for receipt of the corresponding values (each an Instrument Input Data Item Value) from identified sources.

Individual instruments may require Input Data Items from across the source classifications as well as from multiple providers within a source classification.

These data requirements are then consolidated into a master Input Data Set, including sources, and translated into currency-specific templates per source.

Where there is a requirement to receive data by timed request to a provider, rules and procedures will be established to govern the nature and timing of the request, the nature and timing of the response, the nature of data integrity checks & filters applied to the response and the nature and timing of fallback provisions.

From the potentially multiple Dealer 1611, Third Party 1612 & Vendor 1610 Input Data Sets (each such set an Instrument Source Panel), a set of committed data 230 is created for use in ELA calculation process 1700 as follows.

First, each Instrument Input Item Value will be subject to a data integrity check 3601. Values will be passed through filters and be excluded from the averaging process according to pre-specified rules. The rules, for example quantified tolerances, are specific to the input variable, will be agreed with Dealers and licensees, and may be made public for users of the instruments as Input Data Integrity Rules.

Collected values, having passed these integrity checks, may be further filtered prior to deriving an average, for example by way of a ranking. A Committed Instrument Input Set is then created as the listed pairs of each Instrument Input Data Item and its committed value Instrument Input Data Item Fixing per currency.

Within the averaging process above, we have considered applying weightings, such as market share, to each incoming set of Dealer rates when deriving the mean. Until such time as accepted figures for swap dealer market share are available, an unweighted average is expected to be used.

In another optional embodiment which spans the input rate averaging process and parts of the index calculation process, committed index component values such as SNIPᵢ could be produced by calculating the implied index values from individual source inputs and then averaging the implied values. In a further optional embodiment of this process, committed index component values could be produced by arranging receipt of individual Dealer-calculated index component values, such as SNIPᵢ, as pre-configured Dealer data and then averaging these values directly.

In a further optional embodiment, existing accepted market fixings, for example the ISDAFIX® swap rate fixings, may be used as Input Date Item Fixings, subject to permission. A timing mismatch may introduce a loss of accuracy by this method to offset the credibility gain of using a standardised fixing.

In one optional embodiment, it will be possible to work with individual banks in producing distinct indices to support the launch of products in which only that one bank makes an active market. The role of the index calculator 5033 as an independent index provider may still prove critical in terms of client credibility. This possibility might result from the desire of one Dealer only to have indices in a particular emerging currency, for example. In such an embodiment, it is likely that 3^{rd} party data would be necessary as an input to the index calculation process, but embodiments are possible in which the only inputs to the calculation process are those sourced from the single instrument Dealer.

### Instrument Embodiments

a) Definition of Contractual Obligation

Each inventive instrument will have a contractual pay-out, and therefore a market value, linked to the prevailing spot market rate L_{q} for one (or more) Reference IRS, defined by RCDC 5028, constant maturity κ 5008 and a quotation basis summarised by Quotation Basis 5096. We denote the spot rate for each such Reference IRS, quoted at any time hh:mm:ss on any date fₛᵢ, in terms of a number of market conventions, as L_{q}≡L(hhmmss,i,RCDC,κ). We introduce further defining attributes of rate L_{q} in section Embodiment A—Secondary Market, but suppress the notation as L_{q} in the remainder of this section. We note that irrespective of the time of the quotation on day fₛᵢ, each Reference IRS will have an effective date sᵢ and a termination date s(κ)ᵢ. Also note that RCDC may differ from the instrument denomination currency IDC 5089.

For Embodiment A, each inventive security will possess an Entry Level ELᵢ, similar for example in certain respects to the concept of the “strike” of an option. Prices quoted throughout the first trading day fₛ₁ for settlement on the first day of the first ELA period in the Active Period, Issue Date s₁, are made with reference to an initial Entry Level EL₁ 5020, an identifying characteristic of the series chosen at launch by the parties involved within certain guidelines.

The intrinsic value of an instrument linked to a single Live Quote for value s₁ will be max{0,η(L_{q}−EL₁)}. For prices P_{A,q} quoted throughout each successive trading day fₛᵢ>fₛ₁, for which settlement occurs on sᵢ, the prevailing Entry Level ELᵢ is calculated as ELᵢ₋₁ plus Entry Level Adjustment ELAᵢ₋₁. The intrinsic value for value sᵢ will be max{0,η(L_{q}−ELᵢ)}.

For instruments linked to movements in the spread between Live Quotes L(1)_{q} and L(2)_{q}, we can define the instrument pay-off as max{0,η(L(1)_{q}−L(2)_{q}−EL_{q})}. We have implicitly defined the spread here as L(1)_{q}−L(2)_{q}. A Payer instrument on this spread pays off an increasing amount as the spread rises, but the contribution to this spread rise could be an increase in L(1)_{q} or a decrease in L(2)_{q}. For clarification, we define the concepts of the Lead Component and the Drop Component. In this example, L(1)_{q} is the Lead Component and L(2)_{q} is the Drop Component. In general, the Lead Component will be the rate with the higher initial value, for example the longer rate in an intra-curve spread product assuming a positive curve. Key attributes of the Lead Component are its currency 5028, its tenor 5008 and its quotation basis 5096; key attributes of the Drop Component are its currency 5036, its tenor 5037 and its quotation basis 5097.

For Embodiments B & C, each instrument will possess an Initial Fixed Rate, also denoted EL₁. Prices quoted throughout the first trading day fₛ₁ for settlement on the first day of the Active Period, Effective Date s₁, are made with reference to EL₁. For prices quoted throughout each successive trading day fₛᵢ, for which settlement occurs on sᵢ, the prevailing Fixed Rate ELᵢ is calculated as ELᵢ₋₁, plus Fixed Rate Adjustment ELAᵢ₋₁ being the sum of Reference IRS Forward CMS Adjustment SNIPᵢ₋₁ and Mark-to-market Adjustment MAᵢ₋₁. The intrinsic value of embodiment B for value sᵢ will be η(L_{q}−ELᵢ); for embodiment C, it is (1+G η(L_{q}−ELᵢ)).

Embodiment D could be a futures contract suitable for listing by one or more Exchanges as a novel contract and method by which Exchange customers transfer IRS risk between themselves.

This embodiment D differs from embodiments A, B & C in that we replace the concepts of Entry Level/Fixed Rate EL with that of Execution Level ExL. ExL is a feature of each transaction in the contract as opposed to the contract itself, and therefore does not vary over the holding period. Charges/credits to the position value are made via a distinct cash account (“Margin Account”) which must be held by the trader of the contract for the purpose of supporting its trading activities.

Consider a user entering into a position in a series (“Futures Contract Series”) of the inventive contract which has a market value linked to a single Reference IRS. We denote the execution price as the Inception Execution Level ExLₛ. ExLₛ is the rate equivalent of the contract price. One party (the “Buyer”) to the contract will be buying the Futures Contract Series. The second party (the “Seller”) will be selling the Futures Contract Series. Transactions between parties will occur at prices which vary continuously throughout a trading session.

In a first optional arrangement, the quoted Futures Contract Series price P_{F,q} would relate to the Live Quote according to the following inverse relationship:
P_{F,q}=(100%−L_{q}) (1Fa)

For example, for a live market swap rate L_{q} of 3.340%, P_{F,q}=96.660%

In a second optional arrangement, the quoted Futures Contract Series price P_{F,q} would relate to the Live Quote according to the following relationship:
P_{F,q}=L_{q} (1Fb)

We use the first optional arrangement above for the contract quotation convention as the basis for the description which follows. We note that adoption of the second arrangement as the quotation convention would serve to reverse the relationships outlined.

Long and short positions are achieved through buying and selling a single instrument. For ease of reference between the conventional IRS market and this new futures-based regime, in regime (1Fa), the Buyer is equivalent to a receiver of the fixed rate and the Seller equivalent to a payer of the fixed rate.

For all days fₛᵢ in the life of the Futures Contract Series, the live quoted price P_{F,q} for the contract for value sᵢ will be (100−L_{q}).

The value P/L of positions in contracts is given by
P/L=η(L_{q}−ELᵢ) (2F)

For example, consider a customer who first buys (η=−1 in regime (1Fa)) and then sells contracts via two offsetting transactions on the same day. Suppose they capture an intra-day contract price increase of 0.10% with a position with VaR of [symbol] 100.00, they would generate a profit of (0.10%*10,000* [symbol] 100.00)= [symbol] 1,000.00. This will appear as a credit to the trader's Margin Account. Losses would appear as debits to this account.

The evolution of the value of a position from one day to the next is described more fully in the section Adjustment Factor Calculation.

As well as tracking value changes through variation margining, the Exchange specifies an initial margin to be credited to the Margin Account by parties with a position in the instrument. This mitigates credit risk for the clearing agent. Its scale will be governed by factors including the volatility of the Live Quote L_{q} following the techniques described in evaluating Safeguard Termination Premium.

For embodiments A & C, the inventive instruments possess a characteristic denoted as Sense, which can take one of two values. Payer instruments give a holder/depositor an exposure equivalent to that obtained by paying the fixed rate and receiving the floating rate in the Reference IRS. Receiver instruments give the holder/depositor an exposure equivalent to that obtained by receiving the fixed rate and paying the floating rate in the Reference IRS.

For Embodiment B, the concept of Sense is absent, replaced by the user's position (Pay/Receive) in the contract as opposed to the contract itself.

For Embodiment D, the concept of Sense is absent, replaced by an attribute of the transaction (Buy/Sell) in the contract as opposed to the contract itself.

Before detailing the method by which the index level behind each instrument is calculated, it is important to describe a feature which, in common with other types of financial claim, underpins the pricing framework. Consider a floating rate note (“FRN”): the return on the FRN is governed by the periodic fixing of a benchmark rate. This benchmark rate has a special property. Ignoring credit risk, at each fixing date the stream of future returns from the FRN is taken to have a value of 100% of Par. In other words, the fair value of the interim income stream offsets exactly the discount associated with deferring capital repayment into the future. This property has many uses. We use it to derive grid-point swap curve discount factors below, for example, where the benchmark rate is LIBOR in the case of US Dollars and is EURIBOR in the case of euros.

By extension, any interval over which a financial instrument pays benchmark-rate-based flows can be treated as if that interval makes no contribution to the NPV of the instrument. This is a critical point for the valuation of embodiments of the inventive instruments which have a maturity greater than one business day. In relation to Embodiment A, holders have the opportunity to buy and sell the securities on a daily basis; in relation to other embodiments, there are daily opportunities for exit or for termination. Should a position be held overnight, users are charged the fair value for that overnight position. Once trading begins the following day, the price of the instrument need account only for ELᵢ applicable for that day, with the contribution to the value from the stream of future ELAᵢs reducing to zero. The future ELAᵢs play the part of the income stream to set against any decision to retain the instrument position and thereby delay capital return. As such, the ELAᵢs are the market benchmark rates for that process.

In the case of Embodiment D, these adjustments are charged/credited within the Margin Account, and the presence and availability of the Margin Account through which to direct value changes means the contract embodiment itself is freed from these elements.

Where margins are imposed, such as ELAM, this validity of this concept may be threatened on a purely theoretical basis, but provided the magnitude of the margins is kept small relative to bid/offer dealing spreads, the method and systems remains valid from a practical perspective. In this case, the issue can be dealt with by adopting suitable accounting methods for the products, for example on an accruals basis.

b) Risk Amount

We should take note at this point of a significant departure from conventional IRS dealing. Embodiments of the present invention are most naturally traded in terms of a risk amount VaR. Conventional IRS are traded in terms of Notional Amount. It is simple to convert Notional Amounts to VaR, by using a multiplier equal to Reference IRS duration. We make use of this relationship when describing an optional trading and quotation regime in Secondary Market. We also describe modifications to trading choices on an electronic platform which make the inventive instruments tradable with minimum disruption to existing methods and systems.

For all Embodiments, parties will agree a risk amount VaR for each transaction. VaR is the value at risk under the transaction to a 1 basis point movement in the relevant Live Quote L_{q}. It will be a figure expressed in units of IDC.

We use as the base assumption in the calculations that follow for all embodiments that prices P_{A,q} will be quoted as a number of basis points. We therefore describe the relationships between prices, risk amounts and invoice/payment amounts.

For embodiment A, each security will have a Sensitivity 5087, being the change in the value of one security based upon a 1 basis point move in L_{q}. To convert prices P_{A,q} into invoice amounts for a transaction, it will be necessary to multiply by a factor H*VaR. VaR may also be expressed in terms of number of securities, where VaR=Sensitivity×Number of Securities.

For embodiments B & C, transactions will have a global VaR. Transactions will be associated with a Notional Amount equal to H*VaR, allied with the use of unit daycount fraction.

For Embodiment D, we may have to further divide sensitivity into two elements. Each Futures Contract Series will have a minimum price movement Tick, defined as the smallest price increment available to the contract; for convenience, we also define Ticks per basis point Ticks/bp as 0.01%/Tick. There will also be a cash value TickVal associated with a price movement equal to one Tick per contract. Consider a contract for which the Tick is 0.001% and TickVal is $10.00; a movement in the contract price from 96.660% to 96.670% is therefore 10 Ticks, and produces a value change per contract of $100.00. By this commonly used method, VaR can be expressed in terms of number of contracts, or Number of Lots, where VaR=Ticks/bp*TickVal×Number of Lots. To convert absolute price movements {P_{D,qj}−P_{D,qi}} into Margin Account cash movements for a transaction, it will be necessary to multiply by a factor H*VaR.

c) Notation

Terms not otherwise defined in this document take the definitions given in the International Swap Dealers Association (“ISDA”) 2000 Definitions, as updated and supplemented from time to time.

“i” is a series of whole numbers from one to m, each denoting an Entry Level Adjustment Period in chronological order from, and including, the first Entry Level Adjustment Period in the Active Period.

The first good business day in the Active Period is the Issue Date 5084 s₁≡s_{1D}.

The last good business day in the Active Period is the Termination Date 5002, nₘ≡n_{TD}.

“j” and “k” are series of whole numbers starting from one, each representing the incidence of a periodic roll date in chronological order from, and including, the first incidence. In case the roll frequency is annual, the incidences will be anniversaries of the original date.

The spot settlement date (“spot”) associated with the first day of any ELA period i, adjusted for any applicable business day conventions and applicable financial centres, is sᵢ≡s(0)ᵢ 2045.

The next following settlement date (“next”) associated with the last day of any ELA period i, adjusted for any applicable business day conventions and applicable financial centres, is nᵢ≡n(0)ᵢ 5022.

The j^{th} incidence in a periodic roll schedule out of any spot settlement date sᵢ, adjusted for any applicable business day conventions and applicable financial centres, is s(j)ᵢ.

The j^{th} incidence in a periodic roll schedule out of any next following settlement date nᵢ, adjusted for any applicable business day conventions and applicable financial centres, is n(j)ᵢ.

The maturity date for a Reference IRS of constant maturity κ 5008 with effective date sᵢ 2045 and nᵢ 5022 is s(κ)ᵢ 2038 and n(κ)ᵢ respectively assuming annual fixed roll frequency. For swaps quoted with a fixed payment frequency of freq 2035 per annum, we introduce a subscript to k to enumerate sequential payment dates in a given year prior to the anniversary date itself.

We use the subscript “q” to denote variables which vary continuously throughout a trading day; we use the subscript “i” to denote variables which take on a single value in a given period i

The fixing date associated with a rate with effective date sᵢ is fₛᵢ 5013

The fixing date associated with a rate with effective date nᵢ is fₙᵢ.

The value, calculated on the first day of any future period i for value date t, of a zero coupon bond with maturity date T is Z_{i,t,T}≡Z(i, t, T).

The value, calculated on the first day of any period i for value n(0)ᵢ, of a zero coupon bond with maturity date n(j)ᵢ is Zⱼ≡Z(i, n(0)ᵢ, n(j)ᵢ).

The day count basis associated with the fixed leg of a given rate quote is denoted by dcb 2036.

The year fraction associated with a period running from, and including, start date tₛₜₐᵣₜ up to, but excluding, date t_{end} is yrf(tₛₜₐᵣₜ,t_{end}, dcb).

The discount factor 1050 calculated at date i for a cashflow payable on date T is χ(T)≡χ(i,T).

The closing rate on the first day of any ELA period i for a Reference IRS of currency RCDC 5028, constant maturity κ 5008 and quotation basis 5096 is Λi_{i,k} 5009

The derived closing rate on the first day of any ELA period i for a Curve Point of currency RCDC 5028, constant maturity κ 5008 and quotation basis 5096 is Λ_{i,k} 5110

The closing rate on the first day of any ELA period i for a Reference IRS of currency RCDC 5036, constant maturity κ 5037 and quotation basis 5097 is Λi_{i,k} 5039

The derived closing rate on the first day of any ELA period i for a Curve Point of currency RCDC 5036, constant maturity κ 5037 and quotation basis 5097 is Λ_{i,k} 5110

The issue price expressed as units of denomination currency IDC 5089 per security of an instrument of embodiment A is C≡C₁ 5012; for embodiment C, issue price C₁≡H/G.

Gearing G is the present value, expressed in basis points, of a one basis point annuity payable over dates and with a daycount as per the fixed leg of the Reference IRS

The rate for any period i for deposits in IDC 5089 made for value sᵢ maturing on nᵢ is Dᵢ 5018.

The margin to be applied to a rate for any period i for deposits with the Issuer 5024 in denomination currency IDC made for value sᵢ maturing on nᵢ is DMᵢ 5019.

The margin to be applied to a rate for any period i for implicit mark-to-market balances within the hedging contracts in IDC made for value sᵢ maturing on nⁱ is MMᵢ 5006. This margin will take one value for (customer) credit balances MtMLMᵢ and a second value for debit balances MtMBMᵢ.

The margin to be applied to a rate for any period i for implicit mark-to-market balances within the hedging contracts in IDC calculated for value sᵢ maturing on nᵢ is MMᵢ 5006. This margin will take one negative value for (customer) credit balances MtMLM (thereby generating positive value for a market-maker) and a second positive value for (customer) debit balances MtMBM.

The margin to be applied to a SNIPRᵢ rate for any period i for Curve Point balances is RAMᵢ 5118. This margin will take one negative value for (customer) long balances RALM and a second positive value for (customer) short balances RABM. The margin to be applied to a Di rate for any period i for synthetic cash balances is SCMᵢ 5117. This margin will take one positive value for (customer) synthetic cash debit balances SCBM and a second negative value for (customer) synthetic cash credit balances SCLM. SCBM & RALM will tend to operate in tandem; SCLM & RABM will tend to operate in tandem

In cases where DAᵢ is zero, we could replace the proceeds-driven option adjustment OAᵢ with a more flexible stop-loss feature. Users would be free to specify stop-loss barriers for their positions, either in terms of P/L (equating to a changing strike) or fixed strike. The safeguard termination mechanism can optionally be removed from instruments of this embodiment.

η 5021 is a logical operator: for Payer-instruments or Pay positions in instruments without Sense, η=1; for Receiver-instruments or Receive positions in instruments without Sense, η=−1. For instruments which possess Sense, we apply an additional switch ηₚ, which takes the value 1 for Long positions and −1 for Short positions. This operates over the derived instrument value to allow short positions to make a non-zero value/risk contribution which would otherwise be suppressed by minimum pay-off constraint.

The dual demands of describing the processes involved in making and using the present invention both in clear, concise text and in drawings has led us to employing text and numerical identifiers for many attributes within classes. These identifiers may appear together or separately. For example, the Option Adjustment attribute featuring in embodiment A is referred to with text identifier OAᵢ and with numerical identifier 5026, according to context.

d) Adjustment Factor Calculation 1700

For instruments of Embodiment A, B & C, the prevailing Entry Level/Fixed Rate ELᵢ 5007 will be calculated according to a step-wise chronological process, for which the unit of each time-step will be one business day. Specifically,
ELᵢ₊₁=ELᵢ+ELAᵢ (1)

ELAᵢ 5017 has up to five components, four of which relate to the terms and conditions of the instrument, and one of which relates to the Reference IRS. We can express this as follows:
ELAᵢ=SNIPᵢ+ηαOAᵢ−η(βDAᵢ+MAᵢ)+η*ELAM (2)

The values of α and β in the three alternative embodiments are tabulated as follows:

| Embodiment | α | B |
|---|---|---|
| A | 1 | 1 |
| B | 0 | 0 |
| C | 1 | 1 |

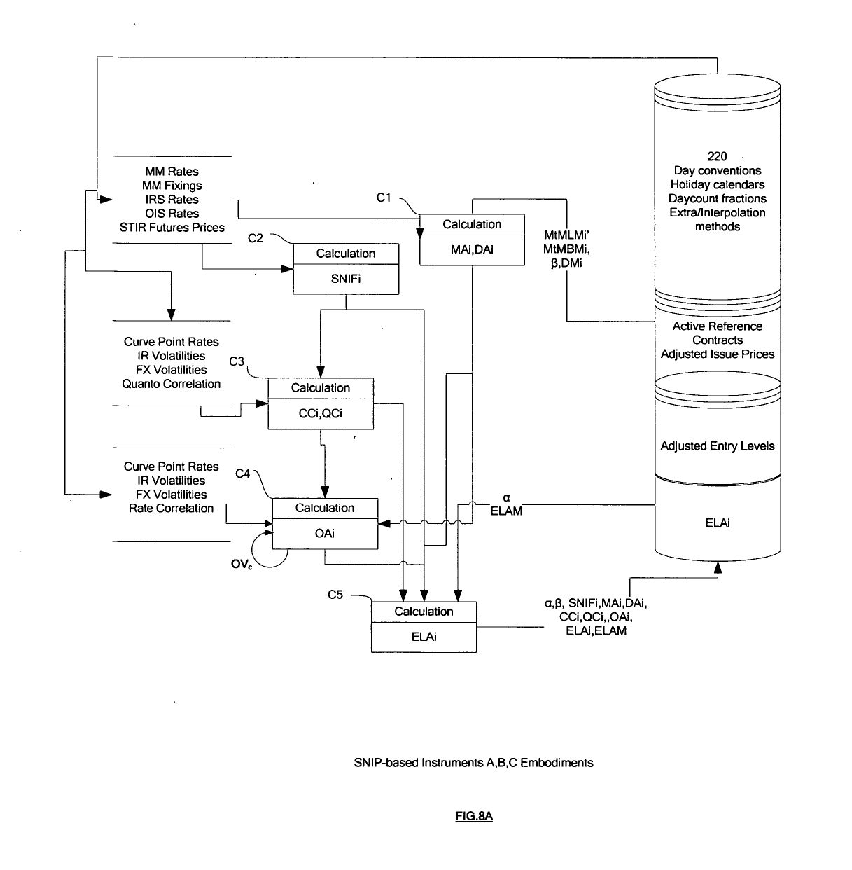

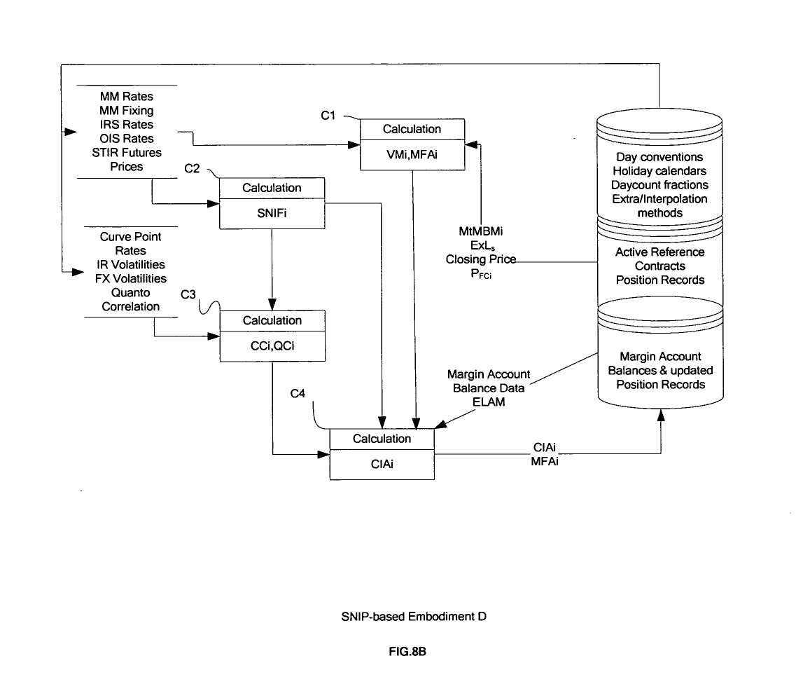

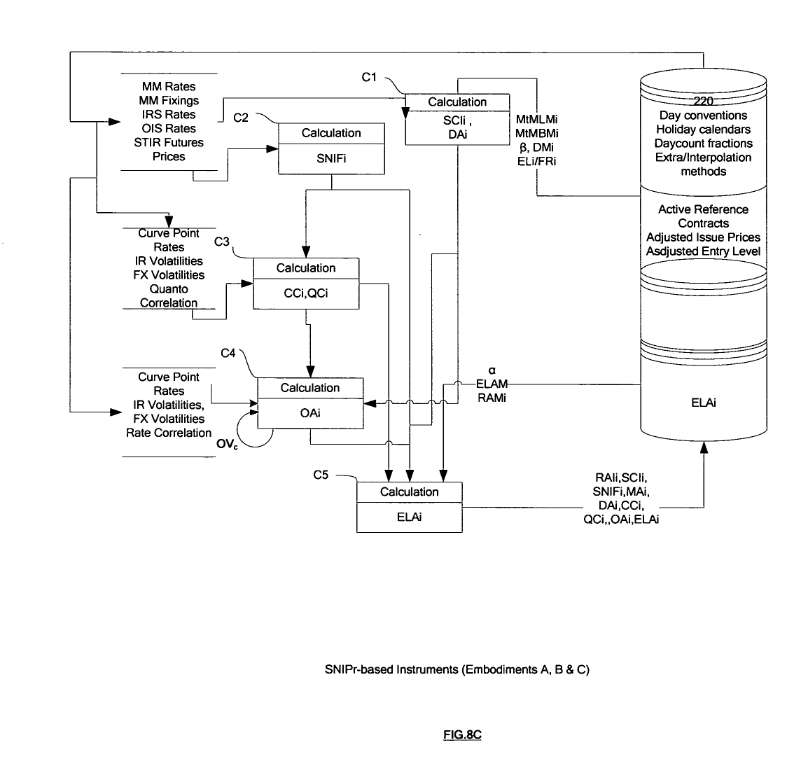

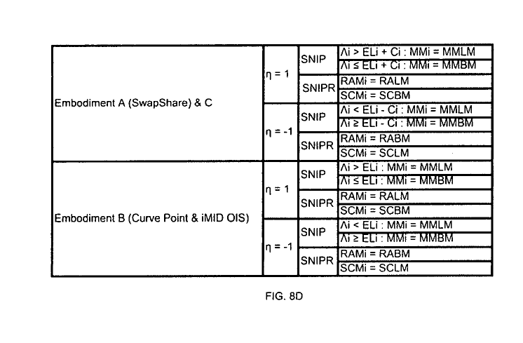

For Embodiment C, α strictly takes a value of 1; in practice, we can treat α=0. FIGS. 8A & 8B chart the process by which ELAᵢ 5017 is calculated according the pricing model which is described below and can be implemented by computer program. FIG. 8C tabulates and consolidates combinations of instrument attributes and positions in those instruments as a net result, expressed in terms of η. We note here that action “Buy” leads a position “Long”; the action “Sell” leads to a position “Short”.

All instruments will involve SNIPᵢ 5016 and a value component of form MAᵢ 5005 (or the SNIPRᵢ-based equivalent of these two components). Funded embodiments, such as examples A and C, will involve a second cash-related element DAᵢ 5098. Embodiments which incorporate a maximum or minimum pay-out, such as Embodiment A, are likely to involve a calculation of an option-related element of a form following that of OAᵢ 5026.

In step C1, we load market data from Input Data Manager 1600, data from the Yield Curve class 1000 and instrument attributes 5000 from the Instrument database 220. We then calculate index components MAᵢ 5005 and DAᵢ 5098. The figures are reported back to the Instrument database 220,5000.

Proceeds adjustment DAᵢ 5098 appears in relation to the use of cash initially raised by an Issuer/Deposit-taker upon launch of an instrument 5000. The borrower 5024 credits the instrument via the Entry Level for the interest earned on this cash on a daily basis, with compounding to reflect that repayment is deferred until maturity 5002. The value is as follows:

$${DA}_{i} = \frac{{C}_{i}}{Senstvty H} {DAF}_{i} \qquad ( 3 )$$

where for i>1

$${C}_{i} = {C}_{{l}^{*}} {\prod }_{t = 1}^{i - 1} \{ 1 + \frac{( {D}_{t} - {DM}_{t} ) ( {n}_{t} - {s}_{t} )}{{MMC}_{IDC}} \}$$

Mark-to-market Adjustment MAᵢ 5005 appears in relation to the pay-out deferral which is a repetitive feature over the life of the instruments. Market-makers will experience negative (positive) mark-to-market on its positions. These mark-to-markets will appear as debits (credits) payable (receivable) for value spot. We systematically postpone the cashflow until the following business day. The value associated with this postponement has to be captured in the instrument, and market-makers may apply margins in calculating this value. FIG. 8D tabulates preferred combinations of these margins, including those in a SNIPR regime for which SCIᵢ/RAIᵢ combine to act as SNIPᵢ/MAᵢ. We account for the value via ELᵢ on a daily basis. There is no direct compounding, since the effect is passed through from period to period via the influence on ELAᵢ
The value is as follows:

$${MA}_{i} = [ η ( {Λ}_{i , K} - ( {EL}_{1} + {\sum }_{t = 1}^{i - 1} {ELA}_{t} ) ) - β \frac{{C}_{i}}{Senstvty H} ] {MAF}_{i} \qquad ( 4 )$$

where Cᵢ 5010 is as defined above.

In step C2, we calculate the Forward Swap Premium SNIFᵢ 5015, an element of the forward-CMS adjustment SNIPᵢ 5016. Component SNIPᵢ is a charge/credit relating the risk associated with an overnight position against the Live Quote. SNIFᵢ is present to account for roll date difference for a spot-starting Reference IRS traded on day fₙᵢ versus those on day fₛᵢ.

For step C2, we must calculate at the close on day fₛᵢ the expected rate Φ_{i,κ} 5014 for the (forward-starting) Reference IRS with effective date nᵢ, expressing it as a difference relative to the fixing-corrected (spot-starting) rate Λ_{i,κ} 5009. The figure is reported back to the instrument database. A full expression for the value Φ_{i,κ} is presented in Annex A.i.
SNIFᵢ=Φ_{i,κ}−Λ_{i,κ} (5)
Via step C3, we calculate:
SNIPᵢ=SNIFᵢ+CCᵢ+QCᵢ (6)

The factor SNIPᵢ is unique to each Curve Point, IDC and Instrument Source Panel combination. The factor ELAᵢ will be unique to each instrument and/or position.

The Convexity Correction CCᵢ 5004 appears to account for a mismatch between the natural payment basis on the Reference IRS relative to the promised spot payments under the instrument.

The Quanto Correction QCᵢ 5003 appears to account for situations in which IDC is not the same as RCDC. In this situation, the index user has protection against adverse FX rate movements, specifically the weakening of RCDC 5028 relative to IDC 5089. The value of this benefit is charged back to the index by way of the third term in the expression for SNIPᵢ.

Full expressions for the values are presented in Annex A.ii. and Annex A.iii.

For spread instruments, we calculate the values for Lead and Drop components independently exactly as before, including any quanto and/or convexity corrections. However, the Lead Component makes a positive contribution to the Entry Level Adjustment, while the Drop Component contributes in the opposite sense. Stated mathematically,
SNIP(Spread)ᵢ=SNIP(Lead)ᵢ−SNIP(Drop)ᵢ

In step C4, we calculate the option-related adjustment OAᵢ 5026. OAᵢ appears for embodiments which are strict assets of the holders. In these cases, protection is provided to an instrument holder in the form of the minimum price of zero, which imposes a discontinuity in the pay-off of the instruments relative to movements in L_{q}. The value of this benefit is charged back to the holder by way of the component OAᵢ. A full expression for the value is presented in Annex A.iv for single rate instruments, and in Annex A.v for spread instruments.

In a number of optional embodiments, it is possible to incorporate an Entry Level Adjustment Margin ELAM 5001 into ELAᵢ. ELAM can be expressed as a fixed periodic amount, or in alternative embodiments could be expressed as a rate. It would represent a drain on instrument value to holders. For Embodiment D, non-zero values of ELAM will create a situation in which holders of Long position (η=−1) will be credited(debited) by an amount smaller(larger) than that at which holders of a Short position (η=1) are debited(credited). It will be possible to run this arrangement in parallel with the use of ELAM=0 for particular customer groups, for example designated liquidity providers who support the presence of an active market in the contracts.

For instruments of Embodiment D, the prevailing holding cost ELᵢ 5007 will be calculated according to a modified step-wise chronological process, for which the unit of each time-step will be one business day. Specifically,
ELᵢ₊₁=ELᵢ+ELAᵢ; EL₁=E×Lₛ (1F)

ELAᵢ 5017 has up to four components, three of which relate to contact position, and one of which relates to the Curve Point. We can express this as follows:
ELAᵢ=SNIPᵢ+η*ELAM−η*(MFAᵢ+CIAᵢ) (2F)

Mark-to-market Adjustment MFAᵢ 5005 appears as a result of marking a position to market. This is known as variation margining. To calculate the mark-to-market, we need to define a rate Λ_{F,C,i} determined from the closing price P_{F,C,i} for the Futures Contract Series on every day i. P_{F,C,i} will be closely related to the last traded price on the Exchange. On day 1, variation margin VM₁=η(Λ_{F,C,1}−ExLₛ). For each subsequent day i, the change in variation margin is given by η(Λ_{F,C,i}−Λ_{F,C,i-1}) and the cumulative variation margin VMᵢ is given by
VMᵢ=η(Λ_{F,C,i}−ExLₛ (3F)

The percentage credit MFAᵢ to the Margin Account is an interest amount on the cumulative variation margin. We can define this credit as
MFAᵢ=VMᵢ*MAFᵢ (4F)

Where negative, this figure will act as a debit to the Buyer's Margin Account.

Compound adjustment CIAᵢ 5098 appears in relation to the cumulative effects in the Margin Account from holding an open position in instrument 5000 since position inception. The account provider 5024 credits/debits the position via the Margin Account for the interest earned/payable on position-induced balance on a daily basis. The value is as follows:

$${CIA}_{i} = [ - η {\sum }_{t = 1}^{i - 1} {SNIP}_{t} - {\sum }_{t = 1}^{i - 1} ELAM + {\sum }_{t = 1}^{i - 1} {MFA}_{i} + {\sum }_{t = 1}^{i - 1} {CIA}_{t} ] {MAF}_{i} , for i > 1 \qquad ( 5 f )$$

We can then relate the lifetime profit/loss P/L of the position with reference to a rate equivalent ExL_{d} of a contract disposal price P_{F,C,d} executed on day i for value sᵢ. P/L is the sum of credits/debits to the Margin Account and is therefore
P/L=η(ExL_{d}−ELᵢ) (6F)

A non-zero ELAM, bundled with SNIPᵢ, gives rise to a margin adjustment which differentiates long positions from short positions. Stated explicitly, in regime (1Fa), long positions: SNIPLᵢ=SNIPᵢ−ELAM; short positions SNIPSᵢ=SNIPᵢ+ELAM. Further, a market host might simultaneously set ELAM=0, or make a portion of it a rebate, for price-makers as an incentive for their market-making service.

In a further optional arrangement, applicable for all embodiments and especially those of type B, we use the rate factor SNIPR so as to enable integration with the prior art in spot foreign exchange dealings. By this method, we decompose positions in L_{q} into synthetic positions in a funded equivalent of L_{q} and in cash.

Denomination currency RCDC 1001 and constant maturity κ 2002 define a Curve Point. The purchase of a Curve Point is synonymous with a Pay position in the Reference IRS; the sale of a Curve Point is synonymous with a Receive position in the Reference IRS. We have a market quote convention as per (1Fb) and we have

$${SNIPR}_{i , K} = {Λ}_{i , K} {D}_{i} - {SNIP}_{i , K} \frac{{MMC}_{IDC}}{{n}_{i} - {s}_{i}} \qquad ( 1 S )$$

SNIPR represents a spot/next funding cost for the Curve Point asset expressed in a manner consistent with rates for conventional assets. Processing of positions can therefore be integrated more straightforwardly into existing FX platforms. To elaborate, we consider Curve Point with price L_{q} as akin to a foreign currency, the purchase of which is financed by the sale of a domestic currency RCDC. Consider buying one Curve Point unit at price ExLₛ. The short domestic currency position, initially scaled as ExLₛ units, is financed at its established S/N cash rate; the long Curve Point (foreign currency) position earns interest at rate SNIPR_{i,κ}, likely to be negative, which is credited (debited where negative) daily against the domestic currency short cash balance. In this sense, it resembles the cash dividend from a share. This creates the opportunity for open-ended trading of Curve Points in line with practices well-established in the OTC FX markets.

We can retain expression (6F) for lifetime position P/L, with the terminal contractual percentage pay-off emerging as the result of a compounding step-wise process
P/L=η(E×L_{d}−ELᵢ) (7F)

However, we break down component contributions to ELᵢ differently. Under this new decomposition,

$$\begin{matrix}{EL}_{i + 1} = {EL}_{i} + {ELA}_{i} & ( 1 B ) \\ {ELA}_{i} = {SCI}_{i} - {RAI}_{i} + η ( α {OA}_{l} + ELAM ) - η β {DA}_{i} & ( 2 B ) \\ {SCI}_{i} = ( {EL}_{i} + η β \frac{{C}_{i}}{Sensitvty * H} ) \frac{( {D}_{i} + {SCM}_{i} ) ( {n}_{i} - {s}_{i} )}{{MMC}_{IDC}} & ( 3 B ) \\ {RAI}_{i} = \frac{( {SNIPR}_{i} + {RAM}_{i} ) ( {n}_{i} - {s}_{i} )}{{MMC}_{IDC}} & ( 4 B )\end{matrix}$$

where SCMᵢ and RAMᵢ are margins applied to Dᵢ and SNIPRᵢ respectively which will be agreed bilaterally between suppliers and their customers in the course of their commercial dealings. For example, margin SCMᵢ could be that employed between a prime broker and a client in respect of a consolidated cash balance in currency IDC. These margins will generally be configured to generate positive value for market-makers.

On a practical level, we expect suppliers to employ RAMᵢ more actively than SCMᵢ to extract value from positions. With respect to accuracy, we observe that short-term deposit rates such as EONIA are quoted to an accuracy of only 2 decimal places in the percent. We expect to produce SNIPRᵢ figures to greater accuracy; we note that the market here signals a high tolerance for rounding with respect to daily compounded rates. We also note that a SNIPᵢ figure rounded and published to the nearest one hundred thousandth of a percentage point corresponds most closely to a SNIPRᵢ figure expressed to the nearest thousandth of a percentage point.

As a general comment, market participants adopting the indices for inclusion as value drivers within financial contracts may bear risk against the index fixings. Within the definitions provided by the leading derivatives market trade association, ISDA®, percentage figures are, unless otherwise specified, to be rounded to the nearest one hundred thousandth of a percentage point (9.876541% is rounded to 9.87654% and 9.876545% is rounded to 9.87655%). Agreement on index values to an accuracy to one ten millionths of a percentage point can be reached off pre-agreed input data and methods, and agreement at an order of magnitude of hundred thousandths of a percentage point, the maximum accuracy prescribed by ISDA® for governing contractual payments, is likely across the family of (production) systems in commercial operation. Agreement at this order is not necessary for the validity of the present invention. We also observe that current output values (USD & EUR) of CCᵢ are 0.00001%-0.00020% and those of QCᵢ are less than 0.00010%; these values are small relative to bid/offer spreads in the IRS market, and the risks associated with the value of these elements can be managed in the general course of an IRD trading activity. Their small scale, allied with their intra-day stability, means that in practice Dealers will be willing to assume them without explicit daily notification.

Total Return Indices

There is great flexibility with respect to construction of embodiment C-type instruments. Rules regarding the nature and frequency of any Reference IRS risk linkage and rebalancing, and as to the relative risk weightings of distinct Reference IRS, may vary. For example, the scale of the Live Quote-based risk position at inception could be derived from the PV01 Γ_{i,κ} of a market-priced spot-starting Reference IRS, or from the PV01 G_{κ} of a spot-starting Reference IRS with pre-specified fixed rate. The scale of the risk could be static (fixed at inception) or dynamic. Where dynamic, the rescaling of risk could be carried out a fixed time intervals, for example each day in response to market-driven changes to G_{i,κ}, or at fixed risk deviations, for example when a market movement first causes the mismatch between the risk as last scaled into the index and that in a market-adjusted equivalent to rise above a pre-specified threshold irrespective of time taken. These total return measures may also incorporate a resealing of risk according to prevailing present value, or may be permanently referenced against the inception cash value. They may also incorporate minimum and maximum constraints, through inclusion of an option adjustment component, either as a percentage of prevailing value or of inception value. In all cases, the T-R Indices will capture realised market movements relative to daily expectations. Critically, the composition of these T-R Indices can be governed by published rules, and they can be designed such that their performance can be captured by way of real investment actions which adhere to these rules. Embodiment C is an example, with static gearing Γ_{i,κ} based off rates prevailing at inception.

In one example, a T-R Index can be created which involves daily rebalancing to a prevailing market constant maturity risk equivalent and which involves scaling relative to cumulative performance since inception. This is best considered as a string of daily risk positions, closed out and reset at the closing rates for a given day. In this example, from an inception value C₁=10,000, set so to give base value TRI₁=100.00%,
TRI(live)_{q,i+1}=TRI(close)ᵢ{1+(Λ_{i,k}+ELAᵢ−L_{q,i+1,κ})G(n)_{i,κ}};
TRI(close)ᵢ₊₁=TRI(close)ᵢ└1+(Λ_{i,κ}+ELAᵢ−Λ_{i+1,κ})G(n)_{i,κ}┘

where G(n)_{i,κ} denotes the gearing of the κ year Reference IRS, with effective date nᵢ, based off closing rates on day fₛᵢ, where ELAᵢ=SNIPᵢ+DA*ᵢ and where

$${DA}_{i}^{*} = \frac{{C}_{1} G}{{G ( n )}_{i , K} H} {DAF}_{i}$$

In this special case, MAᵢ 5005 is absent as a result of benchmarking against daily closing values. For an investable version, in which respective bids and offers would need to be considered for rebalancing, component MAᵢ 5005 would return.

In an extension to this and other optional T-R Index embodiments, it would be possible to combine risks across a set of maturities according to rules regarding weightings, for example splitting inception value into fixed constituent weightings C(κ)₁ across maturities κ such that

$${\sum }_{K = 1}^{30} {C ( K )}_{1} = 10 \text{,} 000$$

Annex A.i—Forward IRS Premium SNIFᵢ 5015 Calculation (All Embodiments)

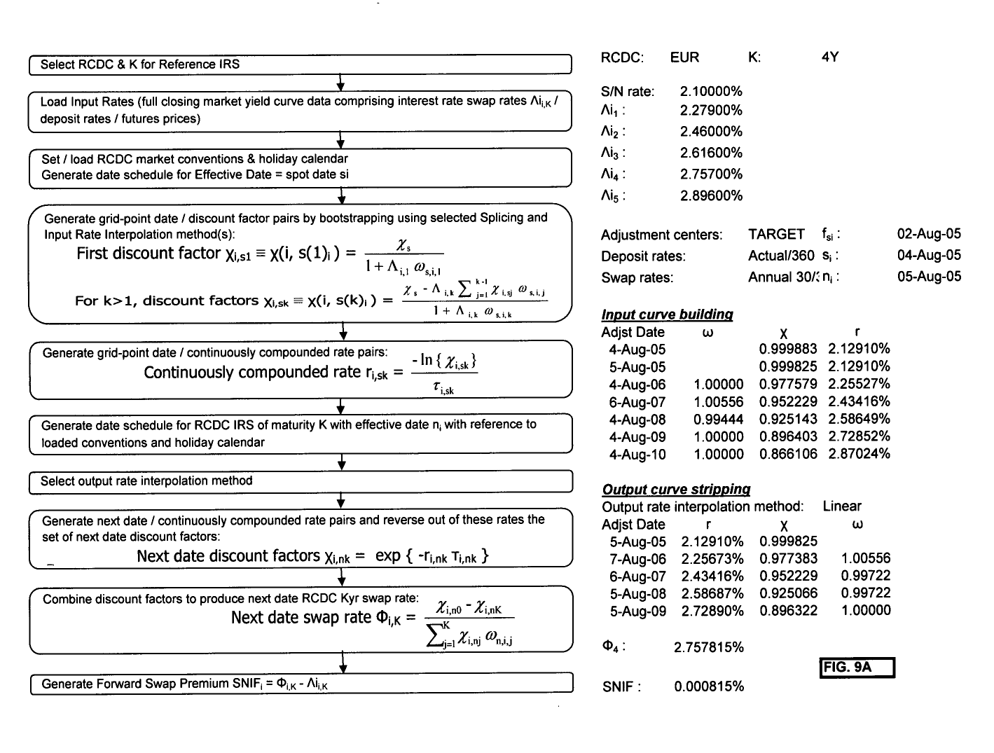

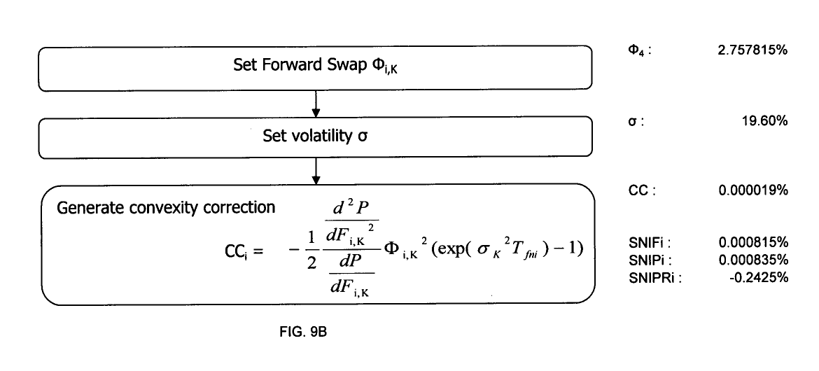

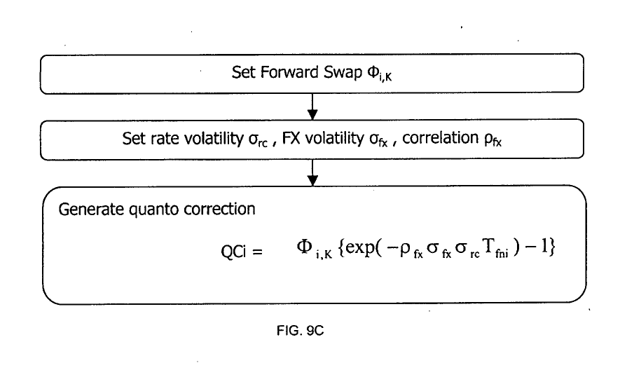

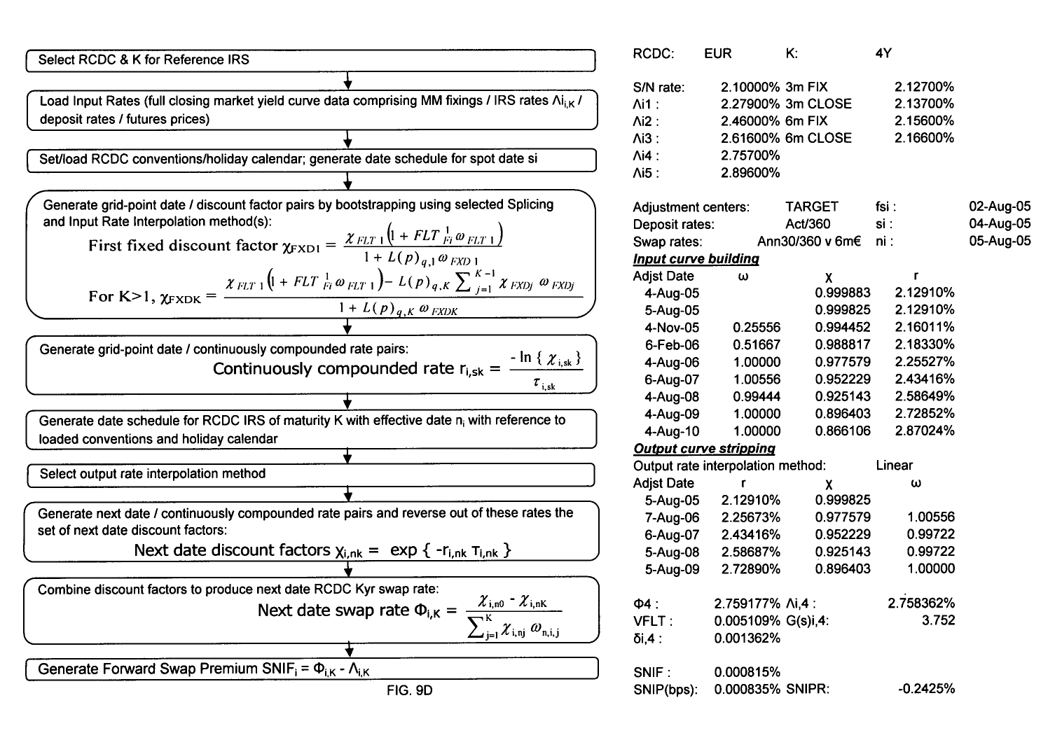

We illustrate the key stages involved in the method of evaluating the Forward Swap Premium in FIG. 9A.

The standard method by which market practitioners generate forward IRS rates proceeds via the production of zero coupon discount factors. The process is implemented by many commercially available analytics software packages, such that we need only summarise the important steps and choices here. The present invention relies upon the presence and use of these existing data structures, methods and systems. Among the conventions and methods used are date adjustment schemes (e.g. Business Day Convention, Business Centres), weighting methods (e.g. Daycount Fraction Scheme), interpolation methods (e.g. Linear, Splines for example as described in Bartels et al. (1998)) and extrapolation methods (e.g. Linear, Flat).

We load Input Rates for a given RCDC term structure into Yield Curve Manager 3800. Yield Curve Manager 3800 sets and loads currency and yield curve conventions 1000 and builds a yield curve for distribution.

Where we require intermediate rates not present in the Input Rate set for fully defining the curve, Yield Curve Manager employs splicing and interpolation methods to generate them from Input Rates. It is equipped to use short-term interest rate futures prices as part of this curve-building process where necessary.

We convert Input and intermediate Rates into grid-point date discount factor by a series of methods including a bootstrapping method. These can in turn be converted into grid-point date zero coupon rates by a series of methods.

We need to generate discount factors applicable to non-grid-point dates. To do so, we first produce non-grid-point date zero coupon rates by a series of methods, and convert them back into discount factors by a series of methods.

The non-grid-point discount factors can be reconstituted via a series of methods into a forward swap rate Φ_{i,κ} as per FIG. 9A and also to create PV01 G_{i,κ}.

Consider the payments associated with the “next” Reference IRS: the n(0)ᵢ value of receiving one unit of Reference IRS denomination currency as an annuity over the fixed leg payment dates is

$$PV 01 {G ( n )}_{i , K} = {\sum }_{j = 1}^{K} {Z}_{j} {ω}_{n , i , j} \qquad A . i .1$$

Consider also the payments associated with the “spot” Reference IRS: the s(0)ᵢ value of receiving one unit of Reference IRS denomination currency as an annuity over the fixed leg payment dates is

$$PV 01 {G ( s )}_{i , K} = \frac{{\sum }_{j = 1}^{K} {χ}_{j} {ω}_{s , i , j}}{{χ}_{s}} \qquad A . i .1 . a$$

Sampling of FLT_{Lq}¹

The deposit rate for index tenor 2028 from source 2056 is not directly available on a live basis, since the averaging process is only conducted once per day at the time of the fixing. We can, nonetheless, develop a method for determining FLT_{Lq}¹. We can also sample a closing market rate FLT_{Ci}¹ as a special case of FLT_{Lq}¹ at the close. FLT_{Lq}¹ acts on an intra-day basis to reference the value contribution of the floating fixing prior to the close. FLT_{Ci}¹ marks the fixing FLT_{Fi}¹ to market and also acts as the base from which to project the first fixing on tomorrow's spot-starting IRS. In one embodiment of the process, we snapshot the OIS with maturity 2028 at the time of the floating fixing. We then apply a constant basis assumption, adding the change in the OIS rate to FLT_{Fi}¹ to arrive at FLT_{Lq}¹ and FLT_{Ci}¹. We moderate this with a parallel exercise covering the (two) front STIR futures contracts, adjusting proportionately for the period of overlap between these contracts and the rate fixing. The change in price acts as a reference for the OIS-derived deposit-rate move.

Optional Post-Fixing Curve Definition

In one preferred optional curve-building embodiment, we use the constant basis assumption which gives a value FLT_{Lq}¹. We define the discount factor χ_{FLT1} applicable to payments scheduled for the termination date of the deposit contract of tenor 2028 as

$$\frac{{χ}_{s}}{( 1 + ( {FLT}_{Lq}^{1} {ω}_{FLT 1} ) )} .$$

Now, consider a 1 yr IRS, quoted vs a floating index which sets FLTk times a year, at rate L(p)_{q,1}. The known payments under this swap are: (i) L(p)_{q,1} ω_{FXD1} on the fixed leg, and (ii) FLT_{Fi}¹ ω_{FLT1} on the floating leg. We use this information to determine the discount factor at the 1 yr point for the LIBOR curve.

The PV of payments on the floating leg is given by FLT_{Fi}¹ω_{FLT1} χ_{FLT1}+χ_{FLT1}−χ_{FLTk}. The value of the fixed leg payment is L(p)_{q,1} ω_{FXD1} χ_{FXD1}. We note that χ_{FXD1}=χ_{FLTk}

Equating the value of these two sets of flows and substituting,

$${χ}_{FXD 1} = \frac{{χ}_{FLT 1} ( 1 + {FLT}_{Fi}^{1} {ω}_{FLT 1} )}{1 + {L ( p )}_{q , 1} {ω}_{FXD 1}}$$

We derive closing discount factors when FLT_{Lq}¹=FLT_{Ci}¹ and L(p)_{q,κ}=Λ_{i,κ} for all κ.

Let us now consider longer-dated IRS. We can deal here with a switch of short-rate floating indices (for example in EUR from 3m to 6m EURIBOR as the floating leg index for IRS with a maturity of 2yrs or more) as necessary.

The present value of the floating leg (FLT_{Fi}¹ is here the rate for the κ>1 designated maturity) is FLT_{Fi}¹ ω_{FLT1} χ_{FLT1}+χ_{FLT1}−χ_{FXDκ}. The present value of the fixed leg is L(p)_{q,κ}

$${\sum }_{j = 1}^{K} {χ}_{FXDj} {ω}_{FXDj}$$

By equating these values and manipulating

$${χ}_{FXDK} = \frac{{χ}_{FLT 1} ( 1 + {FLT}_{Fi}^{1} {ω}_{FLT 1} ) - {L ( p )}_{q , K} {\sum }_{j = 1}^{K - 1} {χ}_{FXDj} {ω}_{FXDj}}{1 + {L ( p )}_{q , K} {ω}_{FXDK}}$$

When this optional curve-building embodiment is employed to the closing curve, we apply adjustments δ_{q,κ} to closing rates Λ_{i,k} to produce SNIFᵢ and OAᵢ, as per-FIG. 9D.

Annex A.ii—CCᵢ 5004 Calculation (All Embodiments)

The second term in the formulation of SNIPᵢ, the convexity correction CCᵢ 5004, uses attributes of variable F_{i,κ} including its calculated closing rate Φ_{i,κ} as an input. The term relates to differences in payment basis between the security, which condenses the rate movements to “spot” value adjustments, and the natural rate. Key stages in its calculation are illustrated in FIG. 9B.

For instruments with a value linked to SNIPᵢ, by design a one basis point (1 bp) change in the Curve Point rate results in a fixed change in instrument value across all yield levels; there is no convexity

$$( \frac{ⅆ P}{ⅆ {L}_{i}} = 1 , \frac{ⅆ {}^{2} P}{ⅆ {L}_{i}^{2}} = 0 ) .$$

By contrast, the change in Reference IRS value for a 1 bp rate change is contingent on yield levels i.e. convexity is present

$$( \frac{ⅆ P}{ⅆ {L}_{i}} \neq constant , \frac{ⅆ {}^{2} P}{ⅆ {L}_{i}^{2}} \neq 0 ) .$$

There are two steps to evaluating the convexity correction. The first step is to model the yield curve movements, and the second is to evaluate the expected value of the change in payment basis under this model. Following Brotherton-Ratcliffe and Then (1993) as amended by Haug (1998), we have

$${CC}_{i} = - \frac{1}{2} \frac{\frac{ⅆ {}^{2} P}{ⅆ {F}_{i , K}^{2}}}{\frac{ⅆ P}{ⅆ {F}_{i , K}}} {Φ}_{i , K}^{2} ( exp ( {σ}^{2} {T}_{fni} ) - 1 ) \qquad A . ii .1$$

where P is the value of the fixed leg of a forward swap with fixed coupon and roll dates matching F_{i,κ}, σ is the implied volatility of forward rate, and T_{fni} is the period in years between fixing day fₛᵢ and fixing day fₙᵢ calculated according to an Actual/365 calendar. Values for the partial derivatives can be generated numerically or by using 3^{rd} party financial analytics libraries.

In one optional embodiment, we take

$$\frac{ⅆ P}{ⅆ {F}_{i , K}} = PV 01 and \frac{ⅆ {}^{2} P}{ⅆ {F}_{i , K}^{2}} = \frac{ⅆ PV 01}{ⅆ {F}_{i , K}}$$

There is some evidence that volatility on trading days exceeds that on non-trading days. In one optional embodiment, we implement the variable T_{fni} in the above formulation as the number of trading days between fixing day fₛᵢ and fixing day fₙᵢ divided by the number of trading days per calendar year. This has the effect of increasing the convexity value between weekdays while decreasing the convexity correction applicable over weekends. This alternative method may also apply to the daily option values OAᵢ.

Annex A.iii—QC₁ 5003 Calculation (All Embodiments)

Quanto instruments settle in one currency IDC while having a value determined relative to a Reference IRS in a second currency RCDC. We can model the change in value via the forward swap rate Φ_{i,κ} and incorporate the value via our expression for SNIPᵢ. Key stages in its calculation are illustrated in FIG. 9C.

We find in practice that the quanto correction and convexity correction for the present invention can be calculated independently, and are additive.

Valuation of quanto options was pioneered by Derman, Karasinski & Wecker (1990) and is summarised in Haug (1998). As applied to our interest rate environment, we find
QCᵢ=Φ_{i,κ}{exp(−ρ_{fx}σ_{fx}σ_{rc}T_{fni})−1} A.iii.1
where ρ_{fx} is the correlation between forward rate F_{i,κ} and the exchange rate, σ_{rc} is the implied volatility of the forward rate (previously σ), σ_{fx} is the implied volatility of the exchange rate from the Market Data Manager, and T_{fni} is the period in years between fixing day fₛᵢ and fixing day fₙᵢ calculated according to an Actual/365 calendar.

For quanto correlation ρ_{q}, we consider IDC as domestic currency. RCDC is considered as the foreign currency, and we take the exchange rate to be quoted as domestic currency per foreign currency i.e. IDC/RCDC. ρ_{q} is then the correlation between that exchange rate and the rate for the Reference IRS. If strength in the domestic currency (IDC/RCDC ↓) is accompanied by falls in the Reference IRS rate (F_{i,κ}↓), meaning ρ(IDC/RCDC, F_{i,κ})>0, the quanto correction is negative, and vice versa.

Let us denote this new quanto-corrected forward CMS rate as Φ_{i,κ, fx}. Bearing in mind the sequential nature of the calculation of ELAᵢ, for the avoidance of doubt, we can state that the convexity correction is calculated as before from the original Φ_{i,κ}, but that the option adjustment is calculated using Φ_{i,κ,fx} in place of Φ_{i,κ}.

Annex A.iv—OAᵢ 5026 Calculation—Single Reference IRS (Embodiment A)

This calculation is iterative, and the strike of the option in each successive iteration is a function of the output value from the previous iteration. For the first iteration, we set strike as ELᵢ₊₁ calculated prior to inclusion of this value component, which we denote for this purpose with an additional subscript EL_{i+1,1}. We solve until the results for successive iterations do not differ at the degree of rounding 5099 employed. Given the very low strike sensitivity dP/dX, this occurs in practice after very few iterations.

We need to invoke a model to place a value on this. A suitable model is the Black-76 model, which assumes the forward rate is lognormally distributed, consistent with our model for the convexity correction.

For any day i, our input parameters to the model are:

Strike, iteration 1=X₁≡EL_{i+1,1},

Strike, iteration c (c>1)=X_{c}≡EL_{i+1,1}+ηOV_{c-1}

Forward CMS rate=Λ_{i,κ}+SNIPᵢ

Time to expiry=T_{fni}

Implied volatility=σ

Risk-free interest rate=0

Note that Φ_{i,κ}, T_{fni} and α take identical values to those used in calculating CCᵢ 5004, unless there is a significant volatility smile associated with an option struck at X_{c}, in which case a distinct volatility can be employed, either directly supplied or interpolated from a supplied surface. The directly supplied figure may be calculated by adding a fixed upward adjustment to α to account for fat tails in the underlying distribution. The option value needs no discounting, since it is charged on its expiry date.

A Payer-instrument incorporates an implicit long put option on the rate, and

$$\begin{matrix}{OV}_{c} = {X}_{c} N ( - {d}_{2} ) - ( {Λ}_{i , K} + {SNIP}_{i} ) N ( - {d}_{1} ) \\ {d}_{1} = \frac{ln ( ( {Λ}_{i , K} + {SNIP}_{i} ) / {X}_{c} ) + {σ}^{2} {T}_{fni} / 2}{σ \sqrt{{T}_{fni}}} , \\ {d}_{2} = \frac{ln ( ( {Λ}_{i , K} + {SNIP}_{i} ) / {X}_{c} ) - {σ}^{2} {T}_{fni} / 2}{σ \sqrt{{T}_{fni}}} ,\end{matrix} \qquad A . iv .1$$

N(z) denotes the cumulative normal distribution function
Then OAᵢ=OV_{c}, where c is the smallest integer for which OV_{c-1}=OV_{c}

A Receiver-security incorporates an implicit long call option on the CMS rate, and
OV_{c}=(Λ_{i,κ}+SNIPᵢ)N(d₁)−X_{c}N(d₂) A.iv.2
where d₁ and d₂ are as defined above and where N(z) denotes cumulative normal distribution function
Then OAᵢ=OV_{c}, where c is the smallest integer for which OV_{c-1}=OV_{c}

Annex A.v—OAᵢ 5026 Calculation—Spread

As in the single rate case, the calculation is iterative. For the first iteration, we set strike as ELᵢ₊₁ calculated prior to inclusion of this value component, which we denote for this purpose with an additional subscript EL_{i+1,1}. We solve until the results for successive iterations do not differ at the degree of rounding 5099 employed. Given the very low strike sensitivity dP/dX, this occurs in practice after very few iterations.

We need to invoke a model to place a value on this. Kirk (1995) created a suitable model via transformation of the Black-76 model, which achieves consistency with previous model assumptions.

For any day i, our input parameters to the model are:

Strike, iteration 1=X₁≡EL_{i+1,1}

Strike, iteration c (c>1)=X_{c}≡EL_{i+1,1}+ηOV_{c-1}

Forward rate, Lead=F₁≡Λ(1)_{i,κ1}+SNIP(1)ᵢ

Forward rate, Drop=F₂≡Λ(2)_{i,κ2}+SNIP(2)ᵢ

Time to expiry=T_{fni}

Implied volatility, Lead=σ₁

Implied volatility, Drop=σ₂

Rate correlation=ρᵣ

Risk-free interest rate=0

Note that Φ(1)_{i,κ1}, Φ(2)_{i,κ2}, T_{fni}, σ₁ and σ₂ take identical values to those used in calculating the convexity correction. The option value needs no discounting, since it is charged on its expiry date.

A Payer instrument incorporates an implicit long put option on the Spread, and

$${OV}_{c} = ( {F}_{2} + {X}_{c} ) [ N ( - {d}_{2} ) - F N ( - {d}_{1} ) ] \\ where {d}_{1} = \frac{ln ( F ) + {σ}_{F}^{2} {T}_{fni} / 2}{{σ}_{F} \sqrt{{T}_{fni}}} , \\ {d}_{2} = \frac{ln ( F ) - {σ}_{F}^{2} {T}_{fni} / 2}{{σ}_{F} \sqrt{{T}_{fni}}} , \\ F = \frac{{F}_{1}}{{F}_{2} + X} , \\ {σ}_{F} = \sqrt{{σ}_{1}^{2} + {[ {σ}_{2} \frac{{F}_{2}}{{F}_{2} + X} ]}^{2} - 2 ρ {σ}_{1} {σ}_{2} \frac{{F}_{2}}{{F}_{2} + X}} \qquad A . v .1$$

and where N(z) denotes the cumulative normal distribution function as before.

Then OAᵢ=OV_{c}, where c is the smallest integer for which OV_{c-1}=OV_{c}

A Receiver instrument incorporates an implicit long call option on the Spread, and
OV_{c}═(F₂+X_{c})[FN(d₁)−N(d₂)] A.v.2
where d₁ and d₂ are as defined above and where N(z) denotes the cumulative normal distribution function

Then OAᵢ=OV_{c}, where c is the smallest integer for which OV_{c-1}=OV_{c}

Annex A.vi

Post-fixing on trading day fₛᵢ, a proxy for prevailing market rate FLT_{Lq}¹ for deposits from source 2056 with tenor 2028 can be sampled.

The intra-day mark-to-market V_{FLT} of the floating leg is then given by

$${V}_{FLT} = ( {FLT}_{Lq}^{1} - {FLT}_{Fi}^{1} ) {ω}_{FLT 1} \frac{{χ}_{FLT 1}}{{χ}_{s}}$$

where ω_{FLT1} is yrf(s(0)ᵢ, s(1₁)ᵢ, dcb(FLT_{Fi})) and χ_{FLT1} is the discount factor applicable to payments on s(1₁).

Now, this floating leg value is common to all spot-starting IRS in currency RCDC, irrespective of tenor κ. However, its impact on the rate for each. κ-year IRS is variable. We must convert from units of price into units of rate. The conversion factor into the κ-year index is the PV01 G(s)_{q,κ}, where we apply the suffix q to represent the fact that this PV01 is a dynamic function of prevailing market conditions.

Thus, the adjustment δ_{q,κ} is given as

$${δ}_{q , K} = \frac{{V}_{FLT}}{{G ( s )}_{q , K}}$$

A sample calculation is featured in FIG. 9D.

e) Index Publication/Distribution 900

ELAᵢ and its components, particularly SNIPᵢ, as well as packaged embodiments such as T-R Indices, must be distributed to users. A choice of distribution channels is available, according to the degree to which users will expect to interact with the published data.

The SNIPᵢ indices in USD and EUR are being produced and published by the index calculator 5033 under as yet unregistered trade mark “SNIP”, an acronym denoting Spot Next IRS Points. The figures have been distributed over the Reuters data platform, on Reuters pages SNIPFIXUSD and SNIPFIXEUR, commencing 7 Oct. 2005. They have also been published on internet site www.midanalytics.com.

Further series of pages onto which daily index information will be made available are expected to be established. Each location to which an executed financial claim of one of more parties refers for its contractually-binding index fixings will be an ELA Source 5044. For example, ELA source “EUR-SNIP-IMID” might mean that the fixing applicable for a given ELA period will be the rate appearing on Reuters page SNIPFIXEUR under heading “SNIP Fixing” in relation to EUR IRS of Reference Tenor κ at or around 18H30 on the days that is two TARGET Settlement Days prior to the first day of that period. Implicit to the figures quoted on each ELA Source will be a panel 5045 of data providers contributing input data for use in that fixing calculation process.

The large market data vendors, including but not limited to Bloomberg LP and Telerate, Inc., can be approached with respect to the distribution of information. In another preferred embodiment, users will take advantage of existing electronic data exchange infrastructures and protocols between themselves and these market data vendors such as Reuters Group plc and Bloomberg LP. In this embodiment, the factors will be given identification codes under these protocols, for example a RIC or a field within an existing form class for securities in the case where the commercial data vendor is Reuters Group plc, so as to enable efficient data retrieval, manipulation and application by Dealers and by customers. This follows practices in place for daily-published indices such as EONIA and LIBOR.

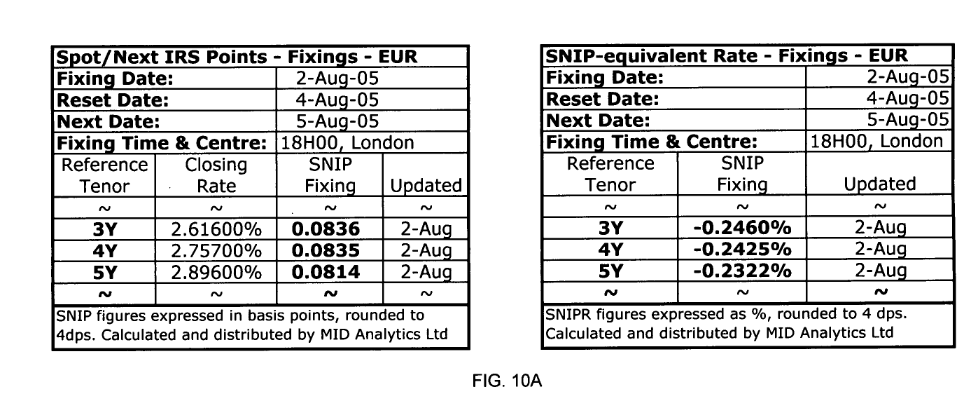

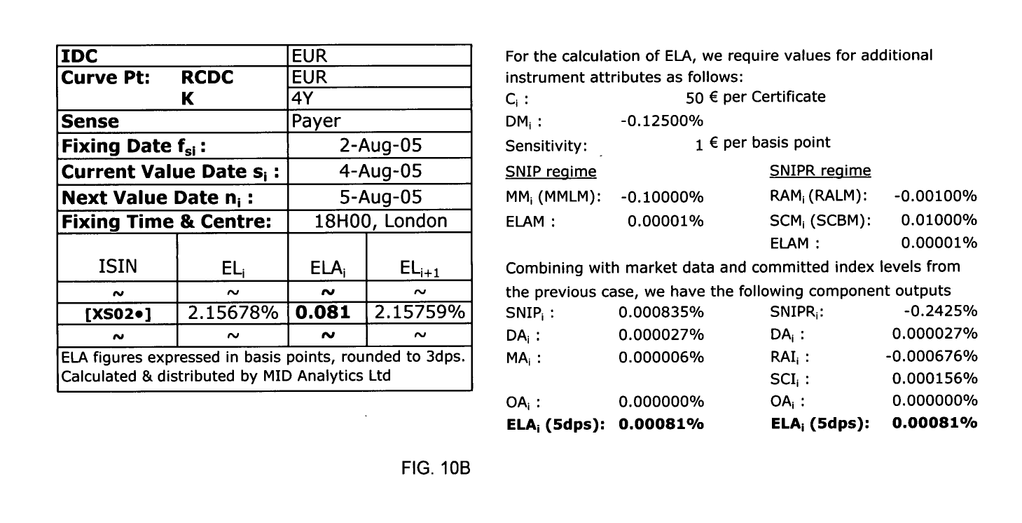

Examples of a potential read-only screen lay-out for daily publication of SNIPᵢ and ELAᵢ indices is provided in FIGS. 10A and 10B respectively.

Index fixings may also potentially be communicated directly to involved parties so that they prepare efficiently for the next day of trading. Datafiles in a variety of formats, including XML, can be exchanged for this purpose.

In a further optional embodiment, expected index values may be distributed to participating Dealers a number of hours ahead of the closing Adjustment Factor Calculation process in order to synchronise calculation library inputs and thereby eliminate avoidable data input discrepancies prior to publication of committed figures.

For Embodiment D, where the inventive contract may be a futures contract listed on an Exchange, each Exchange will be supplied directly with the factor SNIPᵢ via process 6010 in FIG. 6. In one optional arrangement, this will be a factor SNIPᵢ calculated specifically for an Exchange, based on incoming Exchange data, which cause it to differ from other factors SNIPᵢ published for the same date and Curve Point.

Clients of the Exchange with positions in contracts to which such charges apply will be notified by the exchange itself, and may be offered access to independent resources to check figures in line with commercial arrangements between the parties.

### Embodiment D—Secondary Market

The specifications of each Futures Contract Series are loaded into trading platforms via process 6020 in FIG. 6 This process includes requesting and obtaining identification codes for use within third party trading systems. It is then made available for settlement according the standard terms of instruments listed and settled via the clearing systems operated by each Exchange. Once launched, the instruments can be priced and traded by dealers, whether designated market-makers or opportunistic traders. To become involved in their trading, participants will require access to settlement facilities for the futures clearing system in question, either through an own account or more often via arrangements with a futures broker. A variety of systems for trading exist, including voice-based trading, pit-based trading and electronic Exchange platforms for trading.

An electronic Exchange platform for trading is a wide area network of computers connected in such a way as to allow the Exchange members and their customers to execute transactions between each other on that Exchange in contracts listed on that Exchange.

Secondary markets in the instruments will be the only entry and exit routes for users, except for settlement of open contract positions at expiry. The relationship between live reference rate L_{q}≡L(hhmmss,i,RCDC,κ) and contract price is defined in (1Fa) or (1Fb).

We must distinguish between bid rates and offer rates prevailing in the market. Let us denote the bid and offer Live Quotes from each Dealer h as L_{h,P,q}≡L(hhmmss,i,RCDC,κ,Pay,h) and L_{h,R,q}≡L(hhmmss,i,RCDC,κ,Receive,h) respectively. Let us denote the Futures Contract Series bid and offer prices in a given reference rate from a Dealer h as P_{h,b,q}≡P(hhmmss,i,RCDC,κ,Bid,h) and P_{h,a,q}≡P(hhmmss,i,RCDC,κ,Ask,h) respectively. Note also that under certain trading regimes, for example electronic, it will be possible to conduct the trading anonymously, such that the association between quotation and Dealer may be suppressed within the trading system. This will represent an advantage of the inventive contract for certain users relative to conventional IRS.

Now, we need to consider the relationship between the reference rate bid and offer quotes and the contract bid and offer quotes. They are as follows:

| Quotation | Contract Quote | Source |
|---|---|---|
| Basis | type | rate |
| (1Fa) | Bid, P_{h, b, q} | L_{h, R, q} |
| (1Fa) | Offer, P_{h, a, q} | L_{h, P, q} |
| (1Fb) | Bid, P_{h, b, q} | L_{h, P, q} |
| (1Fb) | Offer, P_{h, a, q} | L_{h, R, q} |

In terms of transaction size, prices on the Exchange may be quoted in terms of numbers of contracts or “Lots”, and the relationship with PV01 can be calculated as detailed above.

### Embodiment A—Secondary Market 1950

For secondary trading, in one optional embodiment, each Series will have a set of designated market-makers. Instruments can be traded with customers by private negotiation, over exchange trading systems and over other selected e-commerce platforms. By this method and system, users will therefore be capable of buying and selling a commoditised IRS risk (i.e. Series) freely from a number of potential suppliers.

The securities are available for settlement according the standard terms of an instrument which can be settled via a major securities clearing system. Once launched, the instruments can be priced and traded by dealers, whether designated market-makers or opportunistic traders. To become involved in their trading, participants will require access to settlement facilities for the securities clearing system in question, either through an own account or more often via custodial arrangements.

A variety of systems for trading exist, including voice-based trading and electronic fixed income trading platforms. The electronic platforms are likely to include both exchange- and non-exchange-based systems, for example Bloomberg, Eurex, MarketAxess & TradeWeb.

An electronic fixed-income trading platform is a wide area network of computers connected in such a way as to allow the participants to execute transactions between each other. These could be auction systems, cross-matching systems, interdealer systems, multi-dealer systems or single-dealer systems. The wide area network of computers could optionally be the Internet. Further optional embodiments exist in which the risk exchange is in bi-lateral form, for example a contract-for-difference and the trading platform is a wide area network of computers, for example the Internet or Bloomberg.

In the section titled Trade Execution—e-commerce platforms, we have described a number of novel elements of the data structure, method and system as well as graphical interfaces implemented by computer program. Embodiments B and A are covered in this section. By its nature, this description covers aspects of the secondary market trading of Embodiment A, but we describe other aspects in detail here.

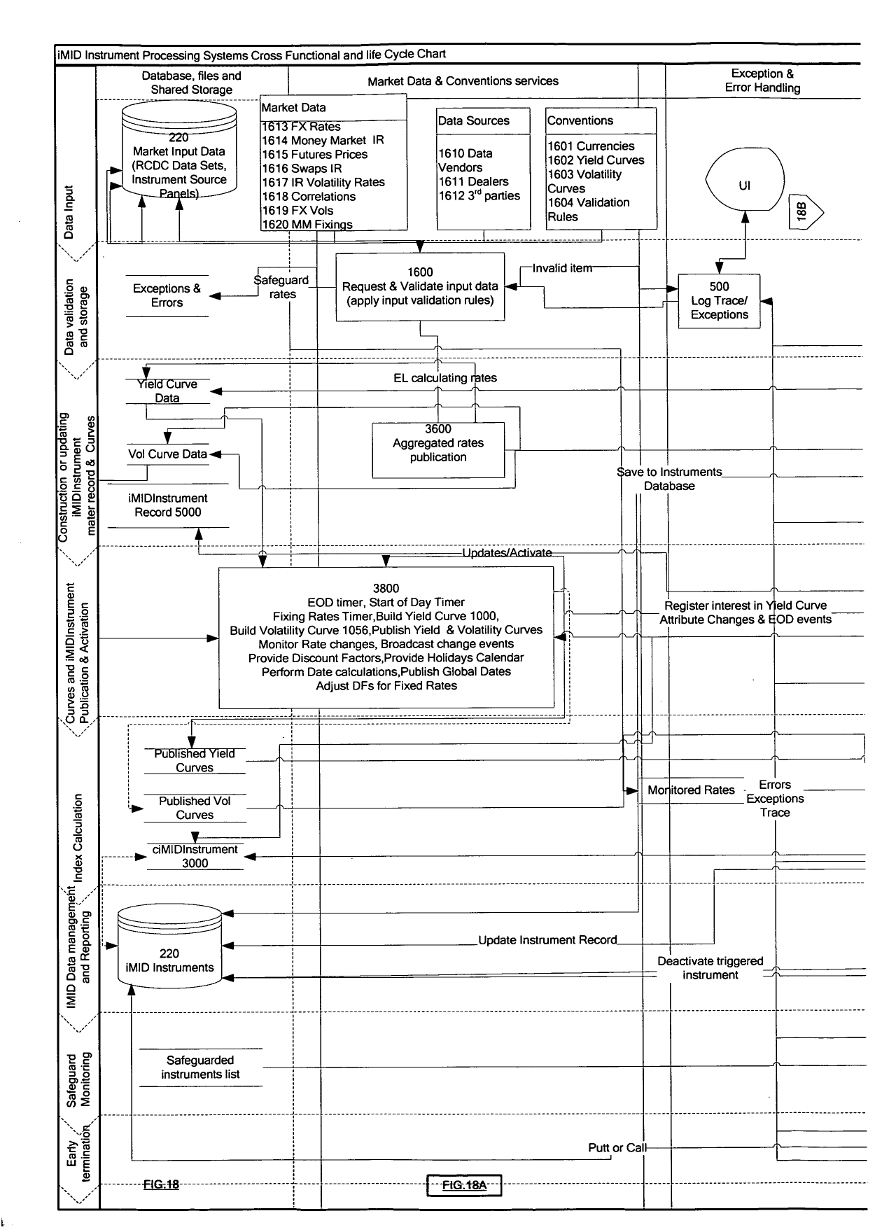

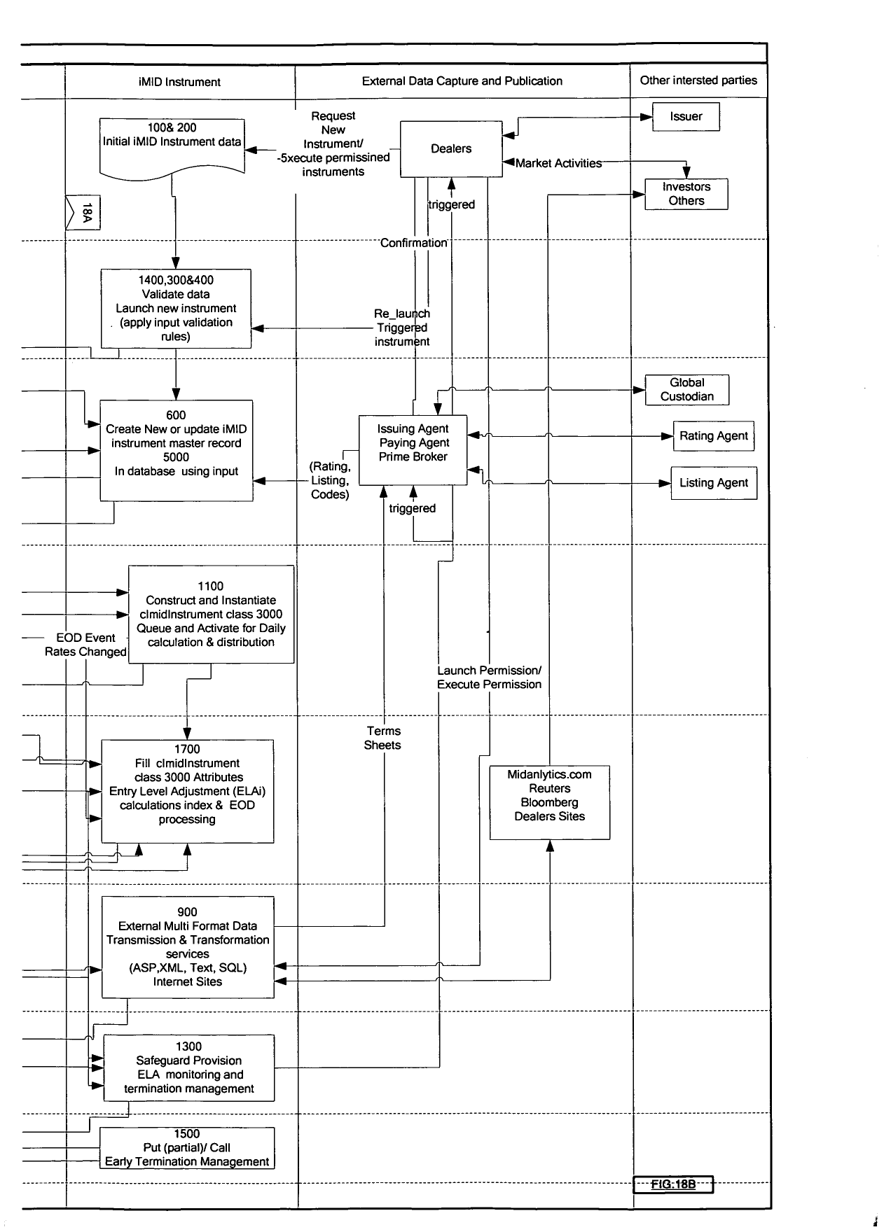

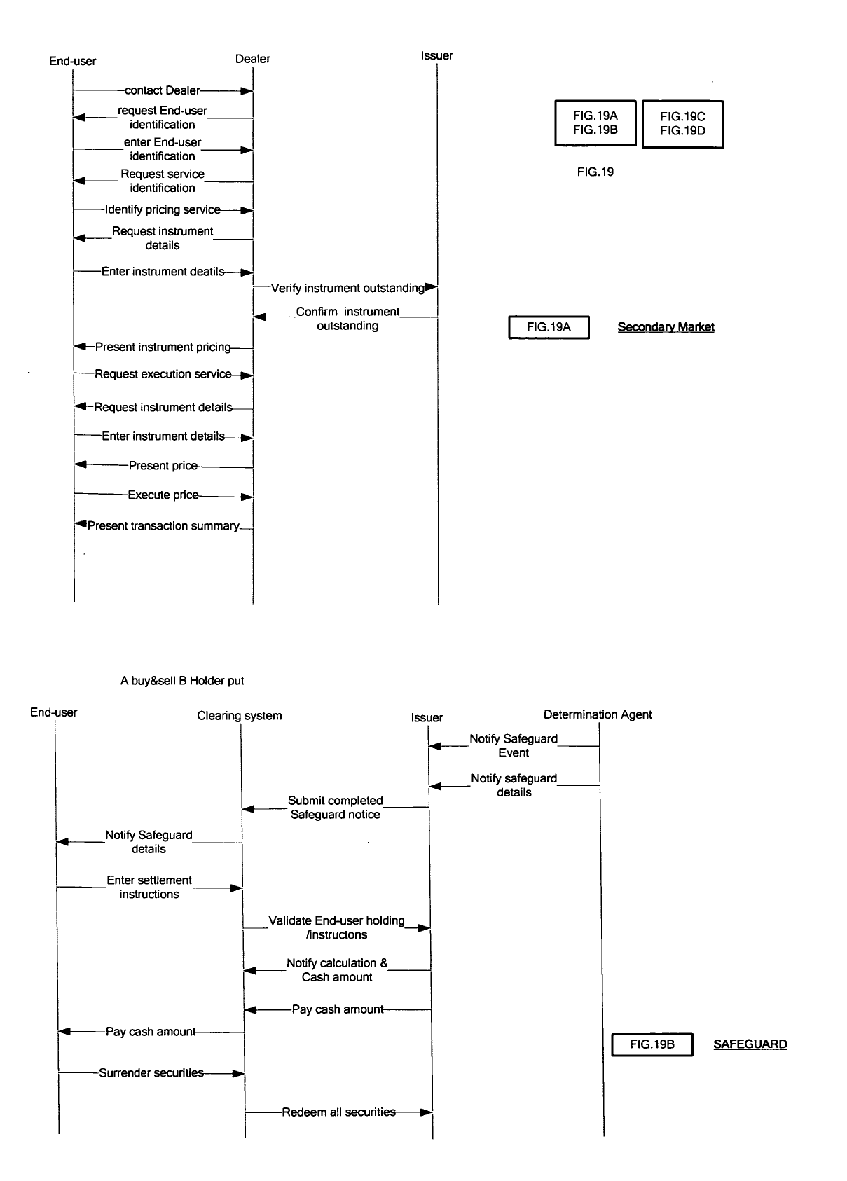

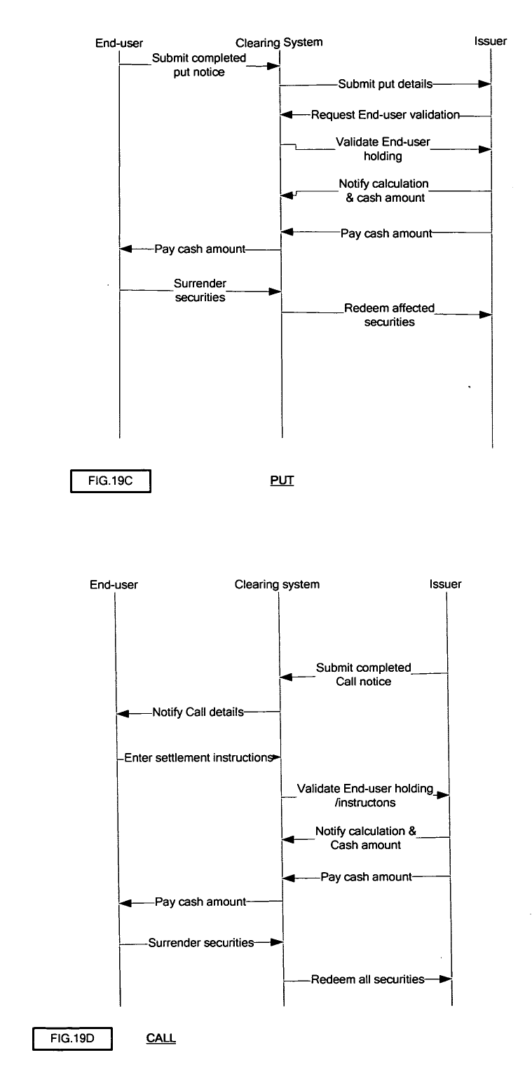

Secondary markets in the instruments will be the main entry and exit routes for users. FIG. 19A is an event trace diagram for this process. From before, we have price P_{A,q} based on intrinsic value as max{0,η(L_{q}−EL₁)}.

We must distinguish between bid rates and offer rates prevailing in the market. We denote the bid and offer Live Quotes from each Dealer h as above. Let us denote bid and offer prices in a security with initial entry level EL₁ from Dealer h as P_{h,b,q}≡P(hhmmss,i,RCDC,EL₁,κ,Bid,h) and P_{h,a,q}≡P(,hhmmss,i,RCDC,EL₁,κ,Ask,h) respectively. Note also that under certain trading regimes, for example via brokers acting as principal, it will be possible to conduct the trading anonymously, such that the association between quotation and Dealer h may be suppressed within the trading system. This will represent an advantage of the inventive contract for certain users relative to conventional IRS.

Now, we need to consider the relationship between bid and offer Live Quotes and security bid and offer quotes. They are as follows:

| Security | Security Quote | Source |
|---|---|---|
| type | type | rate |
| Payer | Bid, P_{h, b, q} | L_{h, P, q} |
| Payer | Offer, P_{h, a, q} | L_{h, R, q} |
| Receiver | Bid, P_{h, b, q} | L_{h, R, q} |
| Receiver | Offer, P_{h, a, q} | L_{h, P, q} |

In words, the bid rate in the Curve Point drives the bid price of a Payer security and the offer price of a Receiver security. Equally, the offer rate in the Curve Point drives the offer price of a Payer security and the bid price of a Receiver security.

Since the performance of these securities will be initially unfamiliar to potential users, new market conventions must be established to ensure homogeneity across the Dealer community in the manner in which security prices are displayed, and in the manner in which trading is conducted.

In one optional embodiment, prices for the securities will be quoted by a Dealer's IRS traders, and certainly within that Dealer's vanilla swap trading business. Traders will quote prices in terms of the prevailing Live Quote L_{q}, and trade capture systems will be designed to calculate invoice amounts in each Series from a Curve Point rate input. To do so, trade capture systems will require a daily upload of prevailing Entry Levels. Manual price entry will be possible, taking advantage of the simple arithmetic relationship between rates and prices.

Transaction size may be quoted on one of two bases. End-users may request a quote in terms of an IRS-equivalent nominal amount, which will be translated into a number of securities by dividing through by the PV01 G(s)_{q,κ} calculated with reference to the Reference IRS and the executed rate. For these purposes, the G(s)_{q,κ} will be a standard bond-market risk measure e.g. a modified duration as produced from a standard 3^{rd} party financial analytics software library with the prevailing transaction rate and additional prevailing curve data as necessary as an input. G(s)_{q,κ} and number of securities will be rounded according to market conventions to be agreed amongst Dealers and end-users. End-users may request a quote directly expressed as a number of securities.

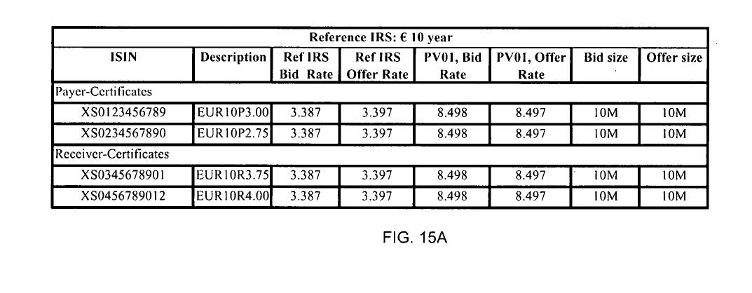

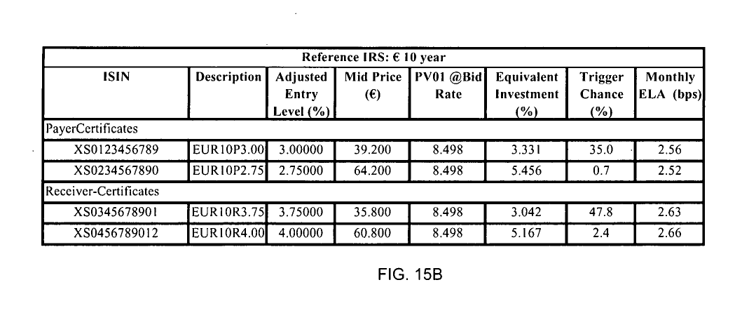

An example of price display screen is given as FIG. 15A.

The Description field may adopt the following conventions for a single currency instrument: [RCDC][κ][P/R][EL₁], where RCDC is the SWIFT code of the currency, by definition both denomination currency for the reference rate and denomination currency for the security; κ is the tenor in years of the Curve Point; P/R denotes the Sense of the security (P=Payer,R=Receiver); EL₁ is the initial entry level.

In a further optional embodiment, a number of other key instrument characteristics could be supplied via real-time processes 1900 for display for each security on an auxiliary set of screens, including Vendor screens and Internet pages. These items may include Trigger Chance (defined below), Bond-equivalent Nominal per H securities (Sensitivity*H/G_{q,κ}), Investment in securities as a percentage of Bond-Equivalent Nominal (=P_{A,q}(offer)*G_{q,κ}), and estimated monthly ELA ((Σₜ₌ᵢ₋₅ⁱ⁻¹ELAₜ)*30/(nᵢ₋₁−sᵢ₋₅)). An example of such a display screen is given as FIG. 15B.

Trade Execution—e-commerce platforms 1950 P For instruments of embodiment B&A, it is possible to integrate the trade execution into existing electronic trading platforms (“eIRS-Platforms”) for IRS, as well as those for spot foreign exchange. This is important because it ensures the usefulness of the inventive contract is fully realised.

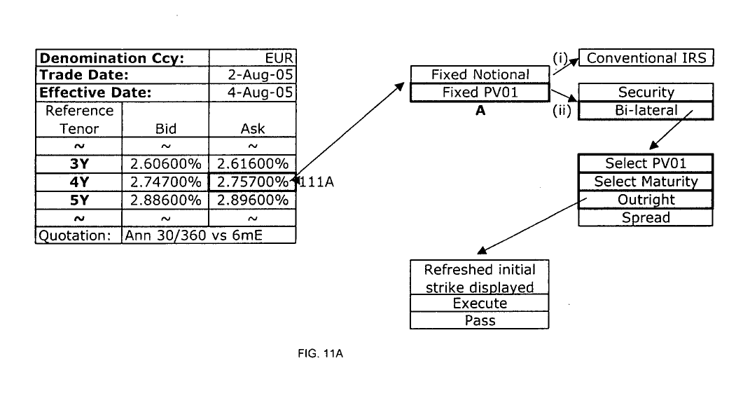

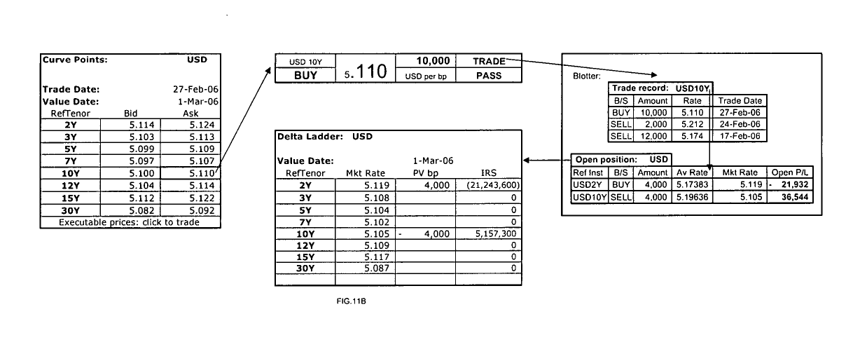

We illustrate the modifications for embodiments B & A in FIGS. 11A, 11B & 12 respectively. In the absence of standardised APIs across the eIRS-Platforms in commercial operation, the illustrations are schematic.

Clients approaching execution of a conventional IRS within existing eIRS-Platforms select the rate they wish to trade 111A. Normally, this would lead to the display of a new GUI as per Contract 1&2 in FIG. 1, into which the customer inserts, amongst other things, details of the counterparty in whose name they are trading and the Notional Amount of the transaction that they wish to execute.

As shown in FIG. 11A, we can insert an additional choice A in response to the initial rate selection 111A. Choice A will require clients to select from a new GUI whether they wish to execute a transaction in (i) a fixed Notional Amount or (ii) a fixed PV01. Choice (i) will take the client back into the conventional IRS description screen of a form as per FIG. 1. Choice (ii) will lead to a new GUI for execution of a transaction of a type described in embodiment B, at which stage the adjustment δ_{q,κ} may be applied. Clients will be asked for details of the counterparty in whose name they are trading and the Risk Amount, or PV01, of the transaction that they wish to execute. In one optional embodiment, clients will be able to view the conventional fixed IRS notional amount equivalent to their PV01 choice. They will also be asked additionally to insert a maturity for the contract. This new choice occurs because the rate against which they are trading has been decoupled from its conventional maturity, and an independent maturity for the contract to be executed must be selected. This maturity may either be open-ended, as per conventions in FX trading, or may be short-dated (a matter of days, weeks or months) in the case of the OIS embodiments.

Having selected counterparty, size and contract maturity, in one optional embodiment the client will be required to select whether their transaction is Outright or as part of a Spread. Selection Outright will lead to a new GUI in which a refreshed price for the transaction is displayed to the customer. They will choose whether to proceed with execution or whether to pass. Selection Spread will lead to the client being required to provide details of a second Curve Point against which the original rate is to be traded as a spread. In one optional embodiment, this could be achieved by returning the client to the original Reference Tenor/Rate matrix window, in which the original chosen rate is highlighted for ease of reference, and in which only the appropriate maturities (all except 10yrs in our example) and prices (bids in our example) are available for selection. Choice of one such price will lead to a new GUI in which a refreshed price for the spread is displayed, with details of the counterparty, size and contract maturity redisplayed for convenience. The client will choose whether to proceed with execution of whether to pass.

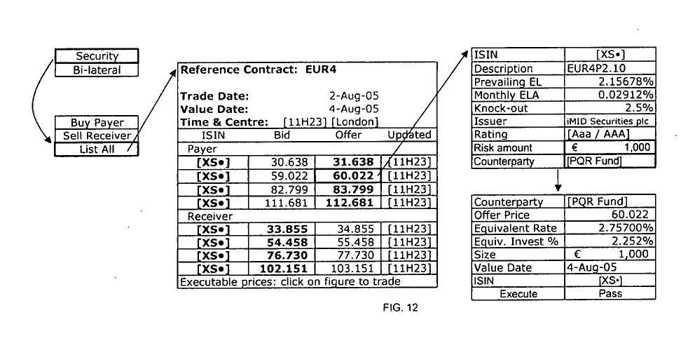

Transactions in instruments of embodiment A can also be offered by extension of the decision process facing a customer under the prior art. Specifically, after making choice (A)(ii) described above in FIG. 11A, the customer will be asked whether they wish to proceed with a bi-lateral transaction, or whether they wish execute a transaction in a security instrument of Embodiment A. The subsequent choices upon selection Security are detailed in FIG. 12. In one optional embodiment, the ability to execute securities to create a spread position can also be offered, by inclusion of the choice “Outright/Spread” within the GUI immediately prior to the display of the refreshed instrument price.

We should highlight at this point a key advantage of embodiment A of the present invention, relating to market access. Customers who are not currently enabled for IRS activity, and cannot therefore act upon IRS rates presented to them over an e-commerce platform, can be given a new IRS risk execution possibility, as follows: customers of this type can be recognised by the trading system, for example by suitable classification of their customer identity, so that an attempt to act upon an IRS rate presented to them will immediately be translated into a request to execute a securitised IRS risk product such as embodiment A. In other words, as represented in FIG. 11A, we bypass choice A and choice (ii) and will be immediately presented with choice of type “Buy Payer/Sell Receiver/List All” shown in FIG. 12. Alongside this customer advantage, we also have a platform advantage. Specifically, platforms which cannot currently offer conventional IRS execution, and which therefore currently present passive IRS rate market data if any to users, can now offer an execution possibility in IRS risk. Here too a customer wishing to act upon an IRS rate presented to them is immediately shown a choice of type “Buy Payer/Sell Receiver/List All” shown in FIG. 12. By this system and method, the risk classes available to users of “securities only” e-platforms is significantly enhanced.

In this case, the client will be required to select whether their transaction is Outright or as part of a Spread. Selection Outright will lead to GUIs as shown in FIG. 12. Selection Spread will lead to the client being required to provide details of a second Curve Point against which the original rate is to be spread. In one optional embodiment, this could be achieved by returning the client to the original Reference Tenor/Rate matrix screen, in which the original chosen rate is highlighted for ease of reference, and in which only the appropriate maturities (all except 10yrs in our example) and prices (bids in our example) are available for selection. Choice of one such price will return the client to a menu structure illustrated in FIG. 11A.

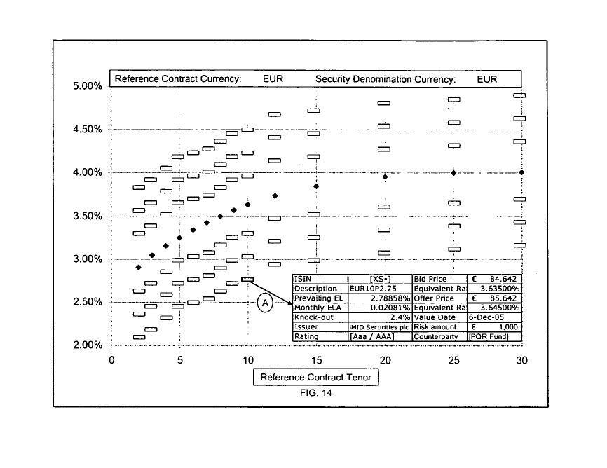

FIG. 11B illustrates the integration of IRS risk trading into spot foreign exchange trading platforms. In line with the development of the rate L_{q} as an asset in its own right according to the present invention, we display quoted rates as “Curve Point”. A client selecting a specific Curve Point for trading, for example the Ask rate opposite the caption 10Y, is presented with an opportunity to buy that Curve Point by specifying the number of units, for example 10,000, for the transaction. Should the client elect to transact, the client would be presented with a summary of recent transactions in that Curve Point. By the method outlined in (8F) for each position, multiple positions in this Curve Point can be aggregated to a single quantity and average price, as for trading in an FX rate. Such aggregation is not possible for conventional IRS. A client might subsequently query the trading system for their open positions across Curve Points, and such positions can be represented in novel ways. Positions might be displayed as per FIG. 11B in the manner of a delta ladder, a common display format relating back to a conventional IRS position nominal equivalent. Positions might also be displayed in the manner of FIG. 14, retaining Reference Tenor of the Curve Point along the horizontal axis while displaying average position price on the vertical axis as opposed to the prevailing Entry Level. Active Curve Points (those in which a client has an exposure) could be displayed in different colours (for example, blue for long and red for short) relative to a neutral colour (for example light brown) for inactive grid-points. In an alternative embodiment, active Curve Points could be identified with an arrow (pointing upwards for long positions or downwards for short positions). In a further embodiment, both identification systems could be employed. In a further optional embodiment, clients might interact with a display of this type by selecting a particular Curve Point so as to initiate a transaction as an alternative starting point for FIG. 11B.

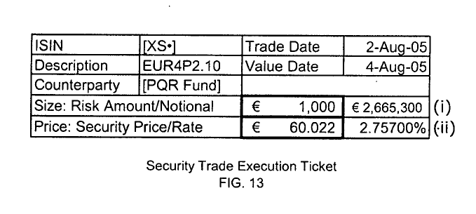

Clients may also approach execution of securities instruments of type A within an electronic securities trading platform. In this situation, clients will be able to look up a specific security, for example via its ISIN 5025, and be presented with a securities execution screen which is conventional in many respects to those presented for regular bond business. There are two novel elements relative to a standard bond execution screen to which we draw attention. They are shown via FIG. 13. The two novel elements of the execution data structure, method and system are (i) the security price/equivalent Curve Point rate toggle and (ii) the security risk amount PV01/equivalent Reference IRS Notional amount toggle. The relationships underpinning these toggles are described elsewhere in this document, and they implemented within real-time processes 1900.

We also present a novel graphic display within the electronic platform's graphic user interface (“GUI”) menu, illustrated in FIG. 14, which will enhance the execution process for certain customers approaching execution within this environment. Clients will be presented with a GUI which will show all securities available to the client on that platform referenced to a selected currency RCDC and denominated in a selected currency IDC. The GUI will display Curve Point Tenor along one axis, and Rate along the other axis. The GUI will display the prevailing set of Curve Point rates as a central element. Selection of any one of these Curve Points may then act as a basis for integration with the novel scheme illustrated in FIG. 11B, for the trading of Embodiments B & D. The display may also accommodate display of securities, such as those of Embodiment A, as follows. If we consider an individual Curve Point Tenor, security instruments will be displayed as cells according to their Prevailing Entry Level. In one optional embodiment, the cells will be labelled according to a security identifier, such as ISIN. As a result, outstanding Payer instruments will appear below the prevailing IRS yield, and Receiver instruments above. In one optional embodiment, customers will be able to select individual instruments. As illustrated in step A, using the example of the least leveraged Payer instrument referenced to the 10yr EUR IRS rate, this will lead to the presentation to the customer of a new descriptive instrument GUI, containing information relating to that security, including but not limited to ISIN, Prevailing Entry Level, projected monthly ELA and Trigger Chance, as well as price information. In one optional embodiment, a chart of recent price history will be available. In one optional embodiment, customers will be able to progress to subsequent GUIs via a series of choices, resulting ultimately in execution of a transaction.

This schematic approach has the benefit of presenting the set of available instruments to customers in a readily digestible form. It will become apparent to users as they gain experience that instruments ranked closest to the prevailing yield curve level will be characterised by, for example, highest leverage and highest knock-out likelihood. Those furthest away from the prevailing yield curve level will be characterised by, for example, highest investment equivalent.

Trigger Chance

Provision of Trigger Chance is an example of one novel real-time data stream to support use of instruments of the present invention.

For those instrument types which incorporate a mandatory early termination mechanism, such as Embodiment A, end-users and dealers will be exposed to the risk of a mandatory close-out of their position. This will occur when instrument prices decline. It is an event which holders may wish to avoid. One method by which a user might manage their risk would be by switching out of an instrument which becomes likely to experience mandatory termination into a second instrument referenced against the same Curve Point for which the likelihood of early termination is smaller. One measure of likelihood is Trigger Chance TC_{q}, the probability that L_{q} breaches the Safeguard Termination Level STLᵢ for the instrument over a pre-specified horizon. In one optional embodiment, users will be able in a suitably interactive environment such as the index calculator's internet site to specify a Trigger Chance Horizon TCH and receive an individually calculated TC_{q}(TCH) relating to that horizon. In another optional embodiment, in a display of pre-configured instrument characteristics, the horizon will have been chosen for the viewer in line with conventions established for the instrument and the associated probability will be displayed.

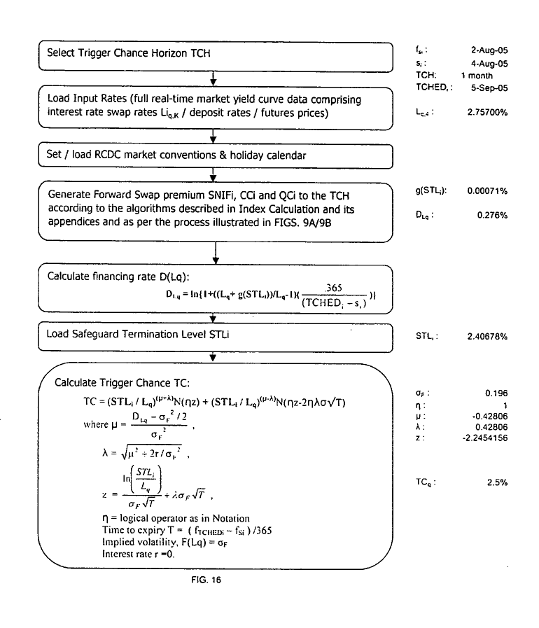

FIG. 16 shows the process of calculating TC_{q}. First, select TCH, for example 1 month. Driven by this selection 1202, and the day i on which selection is made, we define a TCH End Date TCHEDᵢ. We call on algorithms as defined above in the Index Calculation Process for SNIFᵢ 5015, CCᵢ 5004, & QCᵢ 5003, substituting the S/N input rate for a S/TCH input rate and a 1 business day implied volatility input for a TCH expiry implied volatility input and substituting a S/N forward horizon for a TCH forward horizon. From this, we derive a convexity-adjusted forward rate F(L_{q}).

The likelihood of a mandatory termination event can be approximated by treating STL as the barrier in a binary barrier cash-at-hit option. However, we must account for the presence of a daily-stepped barrier level. In a preferred optional methodology, we observe that the projected growth g(STLᵢ) of STLᵢ relative to F(L_{q}) reduces to

$${\sum }_{t = i}^{TCHEDi - 1} ( η ( {DA}_{t} + {MA}_{i} - {OA}_{t} - {ELAM}_{t} ) ) .$$

In this treatment, the likelihood of a mandatory termination event can be approximated by taking STLᵢ as the static barrier in a binary barrier cash-at-hit option. We derive a financing rate D_{Lq} for this treatment as follows:

$${D}_{Lq} = ln \{ 1 + ( ( {L}_{q} + g ( {STL}_{i} ) ) / {L}_{q} - 1 ) ( \frac{365}{( {TCHED}_{i} - {s}_{i} )} ) \}$$

We may then proceed to evaluate the probability. Following Reiner and Rubenstein (1991) as quoted in Haug (1998), solving for knock-out probability TC, we have TC=(STLᵢ/L_{q})^{(μ+λ)}N(ηz)+(STLᵢ/L_{q})^{(μ-λ)}N(ηz−2ηλσ√T)

$$where μ = \frac{{D}_{Lq} - {σ}_{F}^{2} / 2}{{σ}_{F}^{2}} , \\ λ = \sqrt{{μ}^{2} + 2 r / {σ}_{F}^{2}} , \\ z = \frac{ln ( \frac{{STL}_{i}}{{L}_{q}} )}{{σ}_{F} \sqrt{T}} + {λσ}_{F} \sqrt{T} ,$$

η=logical operator as in Notation

Time to expiry T=(f_{TCHEDi}−f_{Si})/365

Implied volatility, F(Lq)=σ_{F}

Interest rate r=0.

For spread instruments, we observe that the projected growth g(STLᵢ) of STLᵢ relative to [F(L(1)_{q})−F(L(2)_{q})] reduces to

$${\sum }_{t = i}^{TCHEDi - 1} ( η ( {OA}_{t} + {ELAM}_{t} - {DA}_{t} - {MA}_{t} ) ) ,$$

and we employ the following formulations:

$$\begin{matrix}{D}_{{SPR}_{q}} = {D}_{L ( 1 ) q , L ( 2 ) q} \\ = ln \{ 1 + ( ( {L ( 1 )}_{q} + g ( {STL}_{i} ) ) / {L ( 1 )}_{q} - 1 ) ( \frac{365}{( {TCHED}_{i} - {s}_{i} )} ) \}\end{matrix}$$

$$TC = {( STL ( m ) / {L ( 1 )}_{q} )}^{( μ + λ )} N ( η z ) + {( STL ( m ) / {L ( 1 )}_{q} )}^{( μ - λ )} N ( η z - 2 η λσ √ T )$$

$$where$$

$$μ = \frac{{D}_{SPRq} - {σ}_{F}^{2} / 2}{{σ}_{F}^{2}} , \\ λ = \sqrt{{μ}^{2} + 2 r / {σ}_{F}^{2}} , \\ z = \frac{ln ( \frac{STL ( m )}{{L ( 1 )}_{q}} )}{{σ}_{F} \sqrt{T}} + {λσ}_{F} \sqrt{T} ,$$

η=logical operator as in Notation

Time to expiry T=(f_{TCHEDi}−f_{Si})/365

$$Implied volatility = {σ}_{F} = \sqrt{{σ}_{1}^{2} + {[ {σ}_{2} \frac{{F}_{2}}{{F}_{2} + STL ( m )} ]}^{2} - 2 {ρσ}_{1} {σ}_{2} \frac{{F}_{2}}{{F}_{2} + STL ( m )}}$$

Interest rate r=0.

STL(m)=L(2)_{q}+STLᵢ

### Securities Lending (Embodiment A)

There will be repo markets in the securities (borrowing/lending securities versus cash), to facilitate short-selling securities.

We have described the presence of a cash-related elements DAᵢ and MAᵢ within the daily Entry Level Adjustment ELAᵢ. These elements represent a compounding credit to the buyer for the use of its cash.

The break-even repo rate or effective deposit rate EDR can be expressed in terms of the instrument's prevailing secondary market price P_{q} as

$$EDR = \frac{{C}_{i}}{{HP}_{q}} ( {D}_{i} - {DM}_{i} ) + \frac{( {HP}_{q} - {C}_{i} )}{{HP}_{q}} ( {D}_{i} - {MM}_{i} ) - \frac{ELAM}{{P}_{q}} \frac{{MMC}_{IDC}}{{n}_{i} - {s}_{i}} ,$$

where ELAM 5001 is a fixed periodic amount.

This rate may act as a basis for repo market rates, although rates may deviate significantly in the event of significant position taking in the instruments. Buyers should, on this basis, have no incentive to move between instruments referenced against a given Curve Point. The instruments can be treated as general collateral.

Termination Features

Contractual embodiments of the present invention will possess a maturity date. Scheduled terminal contractual payments will occur on this date in the absence of a prior termination event.

For certain embodiments, for example leveraged security embodiment A, there are early termination features, both optional and mandatory. We classify these below.

Optional Customer/Holder Termination Manager 1500

The security embodiment A has been designed with secondary market-making as the predominant method of instrument transfer between parties. The optional presence of a Dealer panel for each security means that holders will have a choice of prices at which to execute their business. Nonetheless, the holder of the Securities benefits from a second choice of exit route, an optional early Holder Termination provision 5060, which we now describe.

In the case of Embodiments B, C & D, the contracts remain bilateral between a Customer and a Market-Maker. Early termination at a Customer's request can occur via this provision as an alternative to an open-market termination request.

In case Embodiment D is a Futures Contract Series, this benchmarked exit route may also be provided to users, for example at monthly intervals. Liquidity providers may be required to support this process as an extension of their market-making responsibilities.

In securitised embodiments, the security is a debt obligation of the Issuer. Each holder will have the option to require the Issuer 5024 to repay the obligation on certain dates 5061. Subject to a pre-specified notice period defined by attributes 5062,5063 given by the holder, the specified number of securities must be repaid by the Issuer for immediate value with reference to a credible, independent rate source (CIRS_{κ,i}) defined by attributes 5064, 5066, 5067, such as the once-daily. ISDAFIX® fixings. The contractual repayment HTPA 5068 per Security will be governed by an algorithm of the form:
HTPA=H*max{0,η(CIRS_{κ,i}−ELᵢ)}−EF_{C}
where EF_{C} 5065 is a fee payable by the Holder upon exercise which may optionally be imposed by the dealer panel for any individual instrument.

Holders will be free to exercise rights over owned Securities independent of each other, subject to a set of exercise constraints, such that each instrument may be subject to multiple holder puts. FIG. 19C is an event trace diagram for this process. Note that this feature, as well as offering additional comfort to holders, is necessary for classifying the instrument as debt.

In bi-lateral embodiments, subject to a pre-specified notice period given by the holder, the obligation must be repaid by the Market-Maker/Deposit-Taker for immediate value with reference to a credible, independent rate source (CIRS_{κ,i}) such as the once-daily ISDAFIX® fixings. In these cases, the presence of a bi-lateral link between parties means that the notice periods can be shorter than via a clearing system, and can be agreed relative to a wider choice of reference sources. The contractual repayment CTPA will be governed by an algorithm of the form:
CTPA=VaR*H*[η(CIRS_{κ,i}−ELᵢ)−EF_{C}]
where EF_{C} is a fee payable by the Customer upon exercise which may be expressed as a rate as above or as an amount.

Note that in these Embodiments, the amount can be negative i.e. a payment from the Customer to the Market-Maker or to the Deposit-Taker before netting with the return of the Deposit Amount.

This feature is likely be absent from Exchange-listed contracts of embodiment D, but can be present in privately-negotiated margined contracts-for-difference.

By this feature, price-takers in bi-lateral embodiments may, where a conventional IRS dealing framework has been established between the parties, convert inventive contracts into their IRS equivalent. Payment CTPA is made as detailed above. Simultaneously, the parties enter into an IRS contract denominated in RCDC with effective date sᵢ, tenor κ, quotation basis QB, with fixed rate CIRS_{κ,i} and notional amount

$$\frac{Var H}{{G ( s )}_{q , K}} ,$$

where G(s)_{iκ} is determined with reference to the wider set of rates CIRSᵢ. Positions would retain their Sense for each party on conversion. In this process, we would often set EF_{c}=0.
Safeguard Termination Provision (“STP”) Manager 1300

Leveraged security embodiments, such as Embodiment A, are likely to possess a mandatory early termination provision. FIG. 19B is an event trace diagram for this process. For embodiments in which Live Quotes L_{q} feed continuously into contract pay-out without constraints and for which parties are liable for the full extent of any move, no such feature is necessary.

Entering into a conventional IRS contract can create a notionally unlimited liability of both parties. The inventive security embodiment A, on the other hand, is a strict liability of one party, its Issuer, and an asset of the other party, the Holder. We achieve this change in treatment by introducing an issue price 5012 for the security, and manage it by introducing the STP 5040.

The presence of the Issue Price means the holder pays cash to acquire the instrument. This cash is equivalent to a margin against adverse price movements. This margin is an attribute of the contract in Embodiment A, which distinguishes it from Embodiment D in which margin is an attribute of the customer position. In embodiment A, the Holder cannot lose more than this initial cash investment. In exchange for protecting the Holder in this way, the Issuer (and therefore by extension the Hedge Counterparty) earn the premium OAᵢ.

The STP is equivalent to a margin monitor. Should the margin become inadequate on some measure, the security is subject to mandatory early redemption at that then prevailing price.

In one optional embodiment, margin adequacy is measured by a Safeguard Termination Level STLᵢ 5043. STLᵢ is offset relative to ELᵢ 5007 according to the characteristics of the Reference IRS, for example as a multiple of the standard deviation of the daily swap rate move based on an input volatility level, or for example to within a certain confidence interval relative to a historical data set. We call this offset Safeguard Termination Premium 5042. Safeguard Termination Premium may be fixed or reset periodically, according to individual contractual terms. A Live Quote L_{q} move beyond STLᵢ triggers mandatory early redemption.

In a second optional embodiment, the value of the option component OAᵢ is the measure of margin adequacy. A Live Quote L_{q} move which drives the option value OAᵢ above a pre-defined maximum threshold (“OTL”) causes mandatory early redemption. The level OTL could be zero at the degree of rounding 5099 employed. The option value could be monitored on a continuous basis (in which case it would strictly for these purposes take the subscript “q”) or could be monitored at its daily closing value as per its contribution to ELAᵢ or at some other periodicity as defined within the contractual terms.

On a breach of margin adequacy, the contractual repayment STPA 5058 per Security will be governed by an algorithm of the form:
STPA=H*max {0,η(STSRRS_{κ,i}−ELᵢ)}
where STSRRS_{κ,i} 5053 is the Safeguard Termination Settlement Rate.

The Safeguard Termination Settlement Rate will be the settlement rate for determining payments on instruments following a Safeguard Termination Event, defined by attributes 5056,5057. Its relationship to executable market rates immediately following the occurrence of the termination event is governed by a set of rules and methods 5054,5055,5092. These rules include time limits for activity and assignment rights over Hedging Derivative Contracts. This is distinct from the Safeguard Termination Event Relevant Source (“STERS”) rate, which will be the rate observed for the purpose of determining the occurrence of the termination event and is governed by its own set of rules and methods 5046-5052,5092,5093. The STERS rate may be from a single source or be a panel average, it may be a bid-, offer or mid-market rate, it may be executable or non-executable, and it may be instantaneous or time-averaged.

Market-maker Early Termination Provision (“MMETP”) (Issuer Call Provision (“ITP”) of Embodiment A) Manager 1500

The market-maker may benefit from an ability to terminate its exposures under the inventive contracts. For example, for Embodiment B, this will represent a device via which credit exposure to the end-user can be managed.

For Embodiment A, the Market-Maker, via its hedging arrangements with the Issuer, will drive the actions of the Issuer, who may, in certain circumstances, benefit from the ability to redeem the outstanding instruments of a particular series at the then prevailing market price. For example, partial holder terminations may have taken the outstanding series amount below some threshold, or market movements might have made the series unsuitable for trading.

In circumstances where this provision 5069 is incorporated into the inventive contract terms and conditions:

(i) for securitised embodiments, the repayment amount ITPA 5075 per Security would be of the form:
ITPA=H max{0,η(CIRS_{κ,i}−ELᵢ)}+EF₁
where CIRS_{κ,i} is the Issuer Call Settlement Rate, governed by attributes and methods 5070,5073,5074,5076 and EF₁ 5072 is a fee payable by the Issuer upon exercise. The Issuer would in these circumstances be required to redeem a series in full. FIG. 19D is an event trace diagram for this process.

(ii) for bi-lateral embodiments, the indexed repayment amount MMETPA would be of the form:
MMETPA=VaRH[η(CIRS_{κ,i}−PRCIᵢ)+EF₁]
where EF₁ is a fee payable by the market-maker upon exercise, which may be expressed as a rate as here or as an amount.

The market-maker would in these circumstances be required to redeem a contract in full. Note again that in these Embodiments, the amount can be negative i.e. a payment from the End-User to the Market-Maker.

Risks to Dealers

In trading products with a pay-off linked to these indices, traders will take on risk. These risks fall within the existing family of risks taking by an interest rate trading operation. Indeed, it is an advantage of the present invention that the parameters necessary for producing these indices, and the analytics necessary for evaluation of the risks associated with the indices, are implicit within the interest derivatives pricing engines of the majority of large international banks.

The market risk from dealing in the contractual embodiments of the present invention can be managed by traders within the framework of an existing interest rate risk management business. The first-order (delta) risk can be offset by trading in conventional IRS. This will leave two second-order risks within the hedged portfolio.

Fixing risk is defined as the difference between the value for the instrument adjustment anticipated by the dealer's system relative to the value published by the index calculator 5033. It will be this latter value which is contractually binding. This risk will be examined within the commercial validation through which dealers are likely to channel product development & product approval from their risk control functions. The willingness of Dealers to automatically assume this risk, thereby creating timing flexibility for end-users, is a key element of the inventive system.

Realised Convexity risk can be defined as the difference between the value of the convexity component embedded within last night's published index (an expectation) and the value experienced as time passes through today's realised market movements (a realisation). It occurs by virtue of slicing the passage of time, and therefore the convexity value, into units of one business day. Broadly, the implied volatility input in the index calculation process will imply an expected market move over the period in question. If the realised market movement exceeds this expectation, the index will in hindsight prove to have been an under-estimate of the value, and a portfolio will experience profits and losses according the direction of the portfolio exposure. Option strategies could be employed by dealers to manage this risk.

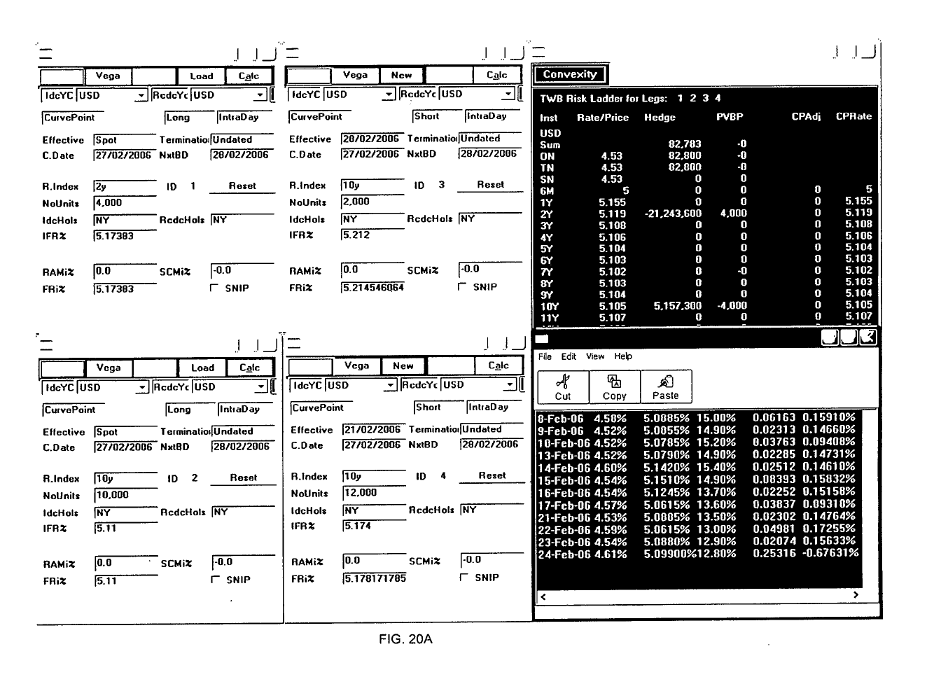

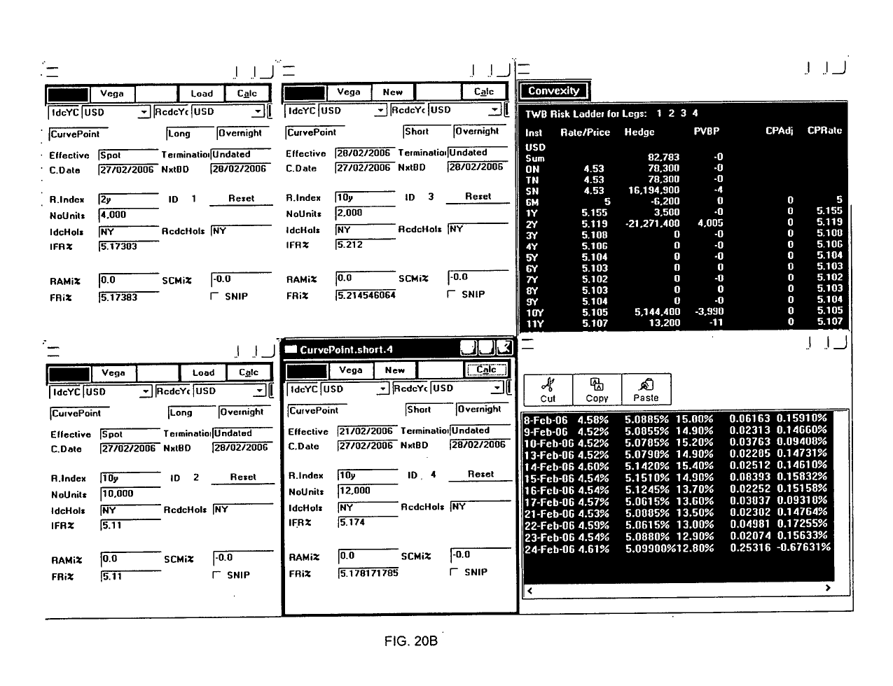

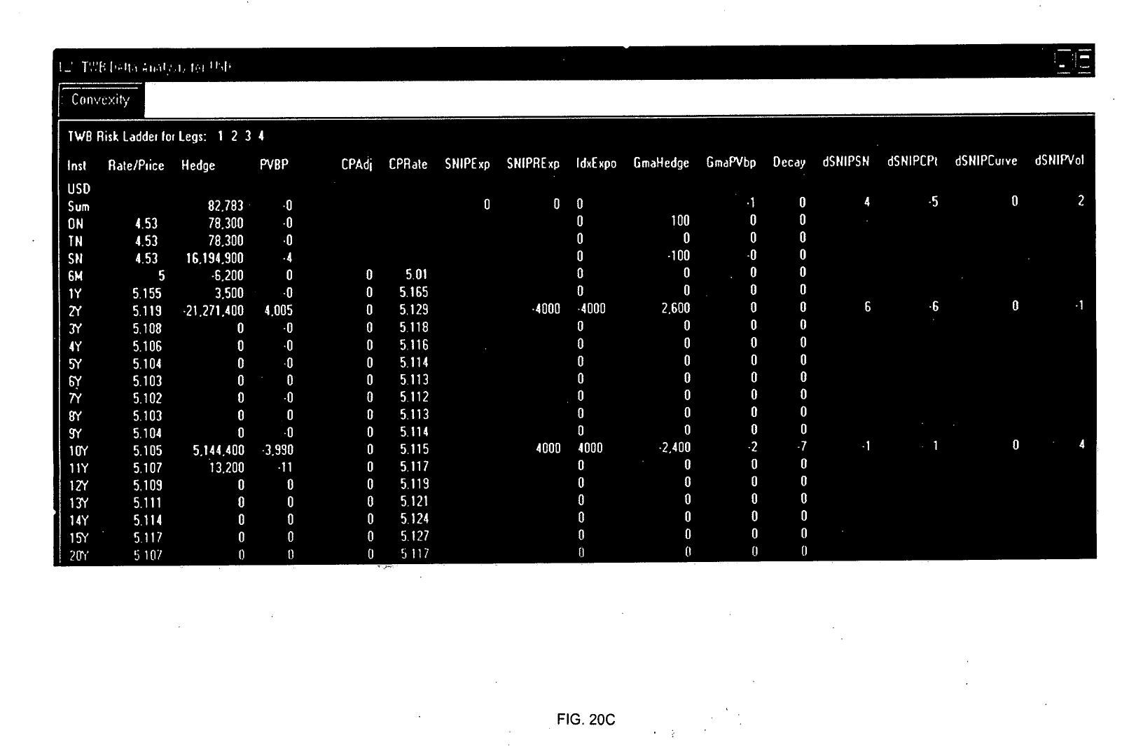

FIG. 20 illustrates an example embodiment of the graphical user interface via which these risks can be reported to users for ongoing management. Risks are split per Curve Point/Reference IRS pair.

Risk managers may elect to view risks from one of at least two perspectives Intra-day and Overnight. The requirement to apply these distinct perspectives comes from the timing flexibility associated with positions in inventive instruments. Since they are typically open-ended, we cannot revalue against a definitive maturity. This characteristic is shared with FX positions, but not with the prior art in IRS.

For the Intra-day perspective, risks are reported as if inventive instrument positions will be closed out at or prior to market closing. The dominant risk in this case is the Realised Convexity mismatch, which is reported via GmaHedge, GmaCash and Decay. SNIPExp, SNIPRExp & IdxExpo are also reported. Inventive instruments are valued as if both legs in the contract are set and paid early.

For the Overnight perspective, risks are reported as if inventive instrument positions will be held open overnight. Inventive instruments are valued as if both legs are set and paid one-business-day in arrears. In the absence of margins within ELAᵢ, there is no change to position NPV. This is because, excluding fees, the adjustment ELAᵢ to the fixed leg of the contract compensates exactly for the risks borne in having an arrears-set floating leg. Measures of Fixing risk (dSNIPSN, dSNIPldx, dSNIPIdx2, dSNIPCurve & dSNIPVol) become relevant and are reported.

SNIPExp is defined as the aggregate PVBP equivalent across SNIP-indexed instruments referenced against the Curve Point in question.

SNIPRExp is defined as the aggregate PVBP equivalent across SNIPR-indexed instruments referenced against the Curve Point in question.

IdxExpo is the sum of SNIPExp and SNIPR-Exp values. A negative value in each case means that a positive SNIP value will be a charge to the position.

GmaHedge is the change in Hedge for a 1 bp upward movement in Li_{q} instruments, with a positive figure indicating a long gamma position.

For inventive instruments in isolation, as in FIG. 20C, GmaCash can be the PVBP equivalent of GmaHedge, being GmaHedge*G(s)_{q,κ}. More generally, and for mixed prior art and inventive instrument positions, GmaCash is the change in PVBP of the combined position for a 1 bp increase in rates.

Decay is the prevailing cash value to the instrument position of instrument gamma ahead of its next reset. A negative figure indicates the cost expectation of a long gamma position. At the point it is reset, it will equal the cash charge to the position embedded within the SNIP fixing.

The subsequent figures are sensitivities of the position, via the IdxExpo and expressed as cash value, which result from potential discrepancies between a user's input values and those market averages which are implicit within the published SNIP figure.

dSNIPSN is the sensitivity of the index position to a 1 bp increase in the S/N rate in isolation. A positive figure indicates that a higher S/N will benefit the position, by contributing to a reduction in the SNIP figure.

dSNIPIdx is the sensitivity of the index position to a 1 bp increase in that Curve Point-rate in isolation. A positive figure indicates that a higher rate will benefit the position, by contributing to a reduction in the SNIP figure through a pronounced impact on the interpolation.

dSNIPIdx2 is the sensitivity of the index position to a 1 bp increase in that Curve Point rate and the immediately longer Curve Point rate. A positive figure indicates that this change will benefit the position, by contributing to an increase in the SNIP figure.

dSNIPCurve is the sensitivity of the index position to a 1 bp parallel increase in the yield curve. A positive figure indicates that a higher curve level will benefit the position.

dSNIPVol is the sensitivity of the index position to a 1% increase in implied volatility. A positive figure indicates that a higher implied volatility will benefit the position, by contributing to an increase in the SNIP figure.

Hedging tools will emerge with increased adoption of these indices. For example, in the prior art, an overnight index swap (“OIS”) is an instrument in which a daily compounded overnight interest rate such as EONIA is exchanged for a fixed payment. A novel OIS in which the SNIPr index replaces the EONIA index is a hedging tool for dealers who find that, as a result of imbalances in their client flows in inventive indexed products, they experience potentially long-term (1 week or more) index exposure.

As for other index-linked transactions, the notional amounts for these swaps will be the product of risk amount VaR multiplied by H. For a single Calculation Period SNIPr-OIS running from effective date s₁ to termination date n_{T}, we define the single floating rate payment according to the following formulation:

$$Floating Payment = {\sum }_{t = 1}^{T} [ \frac{( {SNIPR}_{t} + {RAM}_{t} ) ( {n}_{t} - {s}_{t} )}{{MMC}_{IDC}} {\prod }_{u = t + 1}^{T} \{ 1 + \frac{( {D}_{u} ) ( {n}_{u} - {s}_{u} )}{{MMC}_{IDC}} \} ] ,$$

where T is the number of business days in the Calculation Period from and including the Effective Date up to but excluding the Termination Date, t is a series of whole numbers running from one to T, SNIPrₜ for any day t is a reference rate equal to the overnight rate as published by the Index Calculation Agent in respect of that day, and RAMₜ is a margin applicable to the reference rate set equal to zero for generic market quotation.

The fixed rate FXD can be quoted and be payable according to standard methods and schemes within the Interest Rate derivatives markets. For a fixed rate quoted on a money market basis, the net payment for value n_{T} would be:

$$( FXD \frac{( {n}_{T} - {s}_{1} )}{{MMC}_{IDC}} - Floating Payment ) Var H$$

Floating Payment) Var H

The fixed rate for differing maturities for each Curve Point would be set by the market.

### EXAMPLE 1

The manager of a fixed income credit portfolio who is unable to execute conventional IRS is offered a 10yr fixed rate new issue at a pre-specified spread to the mid-swap rate L(10)_{q}. They like the credit, and want to buy the bonds, but they have a restriction on the scale of the absolute risk position they are allowed to take in the maturity in question.

The manager would immediately have to reduce their holding of some other credit bond(s) in order to accommodate the new issue, or would have to short-sell a suitable Government bond to offset the new issue risk. This exposes the manager to basis risk between the chosen Government bond and the swap rate against which the new issue was launched and priced, and exposes the manager to repo rate risk in that Government bond.

New alternative using Embodiment A—the manager can buy the new issue and can simultaneously buy a Payer-Certificate referenced to L(10)_{q} (or sell a holding of Receiver-Certificates referenced to L(10)_{q}). This combination locks in the spread to mid-swaps at which the new issue is executed. We coin the term “to exchange MIDs” to describe this combination, and it is analogous in risk concept to the market practice of “exchanging Treasuries/Govts” in current use. The interest rate profile of the long Payer-Certificate position offsets the profile of the long new issue position, with an added advantage of a long convexity profile (paid for via the Entry Level Adjustments). The cash required to put on this position will typically be less than 105% of the cash required to buy the new issue alone, and the securities are eligible for repo if cash is not available outright. With the credit spread securely tied up in this way, the manager is then free to dispose of other holdings at a time of its choosing. For example, if the manager is generally positive about credit spreads, they can wait for this move to happen before selling positions which tighten beyond fair value.

New alternative using Embodiment D—the manager can buy the new issue and simultaneously execute a sell transaction in a Futures Contract Series with price relationship (1Fa) referenced to the Reference Contract of appropriate maturity. This combination locks in the spread to mid-swaps at which the new issue is executed. The interest rate profile of the short futures position offsets the profile of the long-new issue position, with an added advantage of a long convexity profile (paid for via charges to the Margin Account). There is no additional cash requirement to put on this position apart from margin requirements at the Exchange. With the credit spread securely tied up in this way, the manager is then free to dispose of other holdings as with Embodiment A.

### EXAMPLE 2

The manager of a fixed income portfolio wishes to lengthen the duration of their interest rate exposure from 5yrs to 30yrs without disrupting portfolio credit composition or increasing the absolute sensitivity of the portfolio to a parallel yield curve move. They are able to execute conventional IRS.

The manager would enter into two IRS transactions, paying fixed in the 5yr maturity and receiving fixed in the 30yr maturity. The relative Notional Amounts of each swap would be selected so as to offset each other in absolute terms at the time of execution, as a ratio of inception PV01s. Movements in absolute rates; coupled with the passage of time, will alter the delta sensitivities of the two swaps such that they no longer offset each other. The manager is required to actively monitor the two positions, and make adjustments to the relative sizes in order to maintain the original neutrality. Upon exit, the manager will receive an amount equal to the net of the two swap unwind values, which will not compare readily to the individual exit rate quotes or to the lifetime spread change.

New alternative using Embodiment B—the manager can enter into a CFD, in which the pay-out to the manager is driven by a spread {L(30)_{q}-−L(5)_{q}}. The fixed rate on the CFD is adjusted daily according to a net SNIP index contribution (SNIP(30)ᵢ−SNIP(5)ᵢ) and position-wide MAᵢ. Market neutrality is maintained without the need for active management. The exit pay-out will be transparently linked to individual exit rate quotes, and directly identifiable against a lifetime spread change.

### EXAMPLE 3

A credit bond trader has a net position in the interest rate market as a result of their positions, both long and short, across a variety of individual bonds. They wish to protect themselves from interest movements overnight by macro-hedging the portfolio. They can evaluate the net risk, and select the most suitable maturity bucket in which to execute a hedge.

The trader could enter into a long-term IRS to a maturity date in the selected bucket. At some point during the next trading session, when the net positions have changed, the trader may have no further need of the executed IRS. In this situation, the trader is likely to enter into further IRSs to manage new risks, thereby building up a portfolio of swap positions which are expensive to maintain but often offsetting in risk. Alternatively, the trader could execute a transaction in the most suitable available government bond, and dispose easily of the position once it has run its course. This exposes the trader to basis risk between the chosen Government bond and the swap rates against which bond positions are priced, and potentially to repo rate risk in that Government bond (if short).

New alternative using Embodiment B—the trader enters into an overnight transaction, extendible at its discretion for longer periods, linked to Curve Point quote L_{qκ} of a tenor and currency equal to that of the conventional swap into which they would otherwise have chosen to enter. The trader agrees an Initial Fixed Rate and VaR with the price-maker upon execution. The following day, the trader exits the position. Specifically, the exit payment is determined by first agreeing a Final Rate. This can be a prevailing Live Quote agreed at execution between the parties, or it can be a rate fixing from an information source specified at the inception of the transaction, for example from the ISDAFIX® page series. This rate is then subtracted from the Initial Fixed Rate adjusted by the applicable overnight adjustment factor, and the difference multiplied by the VaR to derive the amount. This amount is payable for value spot, and is a direct contractual output.

Other embodiments, extensions; and modifications of the ideas presented above are comprehended and within the reach of one versed in the art upon reviewing the present disclosure. Accordingly, the scope of the present invention in its various aspects should not be limited by the examples and embodiments presented above. The individual aspects of the present invention, and the entirety of the invention should be regarded so as to allow for such design modifications and future developments within the scope of the present disclosure. The present invention is limited only by the claims that follow.

The following references are hereby incorporated herein in their entirety
(1) Bartels, R. H.; Beatty J. C.; & Barsky, B. A. (1998) “Hermite and Cubic Spline Interpolation”, Ch. 3 ‘An introduction to Splines for use in Computer Graphics and Geometric Modelling’ pp. 9-17, Morgan Kaufmann.
(2) Black, F. (1976) ‘The Pricing of Commodity Contracts’, Journal of Financial Economics, 3, p. 167-179.
(3) Brotherton-Ratcliffe, R.; & Iben, B. (1993) “Yield Curve Applications of Swap Products”, in ‘Advanced Strategies in Financial Risk Management’, Robert J. Schwartz and Clifford W. Smith, New York Institute of Finance.
(4) Derman, E.; Karasinski, P.; & Wecker, J. S. (1990) ‘Understanding Guaranteed Exchange-Rate Contracts in Foreign Stock Investments’, International Equity Strategies, Goldman Sachs, June
(5) Haug, E.G. (1998) ‘The Complete Guide to Option Pricing Formulas’,p. 146-147 (Convexity Correction), p. 104-106 (Quanto Correction) McGraw-Hill
(6) Kirk, E. (1995) ‘Correlation in the Energy Markets’, in Managing Energy Price Risk. London: Risk Publications
(7) Reiner, E. & Rubinstein, M. (1991) “Unscrambling the Binary Code”, Risk Magazine 4(9).

What is claimed is:

1. A computer implemented method of trading interest rate risks comprising at least one of the sequential, sequence independent and non-sequential steps of:
a first party trading, a first interest rate risk, to a second party for a second interest rate risk;
applying a daily adjustment to the first interest rate risk; and
determining a trade value of the trade of interest rate risks, the trade value being responsive to a live spot quote and the daily adjustment.

2. A computer implemented method of trading interest rate risks, according to claim 1, wherein the first interest rate risk is fixed during each trading day.

3. A computer implemented method of trading interest rate risks, according to claim 2, wherein the second interest rate risk is floating.

4. A computer implemented method of trading interest rate risks, according to claim 3, wherein the trade value changes in response to the second interest rate risk.

5. A computer implemented method of trading interest rate risks, according to claim 4, wherein the trade value changes linearly in response to the second interest rate risk.

6. A computer implemented method of trading interest rate risks, according to claim 4, wherein the trade value changes based on an intra-day adjustment applied to the second interest rate risk.

7. A computer implemented method of trading interest rate risks, according to claim 4, wherein the second interest rate risk is identical to a live market rate for an interest rate swap.

8. A computer implemented method of trading interest rate risks, according to claim 4, wherein the second interest rate risk is equal to a live market rate for an interest rate swap plus an intra-day adjustment.

9. A computer implemented method of trading interest rate risks, according to claim 1, wherein the daily adjustment to the first interest rate risk is based on a published index value.

10. A computer implemented method of trading interest rate risks, according to claim 9, wherein the published index value is published once daily.

11. A computer implemented method of trading interest rate risks, according to claim 1, wherein the trading of interest rate risks is completed using at least one of a securities exchange and a futures exchange.

12. A computer implemented method of trading interest rate risks according to claim 1, wherein the daily adjustment for a particular day is computed according to:
ELA=SNIP+ηOA−η(DA+MA)+η*ELAM
where SNIP=a capitalised forward constant maturity swap adjustment; η=a switch having the value of 1 for a pay position and a −1 for a receive position; OA=an option related adjustment; DA=a proceeds adjustment; MA=mark-to-market adjustment; ELAM=a entry level adjustment margin; and a computed value ELA is an adjustment to the first interest rate risk.

13. A computer implemented method of trading interest rate risks according to claim 1, wherein the daily adjustment for a particular day is computed according to:
ELA=SNIP−ηMA+η*ELAM
where SNIP=a capitalised forward constant maturity swap adjustment; η=a switch having the value of 1 for a pay position and a −1 for a receive position; MA=mark-to-market adjustment; ELAM=a entry level adjustment margin; and a computed value ELA is an adjustment to the first interest rate risk.

14. A computer implemented method of trading interest rate risks according to claim 1, wherein the daily adjustment for a particular day is computed according to:
ELA=SCI−RAI+η(αOA+ELAM)−ηβDA
where SCI=a cash equivalent balance adjustment, denominated in IDC; RAI=a Curve Point dividend, payable in IDC, dependent on SNIPR; SNIPR=is a Curve Point financing rate; η=a switch having the value of 1 for a pay position and a −1 for a receive position; OA=an option related adjustment; DA=a proceeds adjustment; ELAM=an entry level adjustment margin; α=a switch having the value of 1 for a contract whose value is subject to a maximum level or a minimum level and 0 otherwise; β=a switch having the value of 1 for a contract involving an upfront payment and 0 otherwise; and a computed value ELA is an adjustment to the first interest rate risk.

15. A computer implemented method of trading interest rate risks according to claim 1, wherein the daily adjustment for a particular day is computed according to:
ELA=SNIP+η*ELAM−η*(MFA+CIA)
where SNIP=a capitalised forward constant maturity swap adjustment; η=a switch having the value of 1 for a pay position and a −1 for a receive position; MFA=a mark-to-market adjustment; CIA=a compound interest adjustment; ELAM=an entry level adjustment margin; and a computed value ELA is an adjustment to the first interest rate risk.

16. A computer implemented method of trading interest rate risks according to claim 1, wherein a value sensitivity risk associated with a trade of interest rate risks is reported as units of a hedging instrument.

17. A computer implemented method of trading interest rates risks according to claim 1, wherein a value sensitivity risk associated with a trade of interest rate risks is reported as absolute cash sensitivities to movements in the prices of hedging instrument.

18. A computer implemented method of trading interest rate risk according to claim 1, further comprising displaying risk information for at least one of the first interest rate risk and the second interest rate risk, wherein the risk information is at least one of one of sensitivity of a trade value to a Curve Point Rate, sensitivity of a hedging unit equivalent to the Curve Point Rate, sensitivity of the Curve Point Rate value sensitivity, sensitivity of the published index value to the Curve Point Rate, the Curve Point Rate volatility, an overnight interest rate, and a general level of interest rates.

19. A computer implemented method of trading interest rate risks based on an index value comprising the sequential, sequence independent and non-sequential steps of:
setting an initial value based on a trade of interest rate risks;
computing an adjustment to the initial value based on a published index;
adding the adjustment to the initial value; and
trading at least one reference interest rate risk transfer contract based on the adjusted initial value.

20. A graphical user interface method for use in electronic interest rate swap trading systems comprising at least one of the sequential, sequence independent and non-sequential steps of:
displaying an interest rate curve;
displaying at least one instrument along a first axis by reference interest rate length;
displaying the at least one instrument along a second axis by interest rate; and
displaying the at least one instruments symbolically responsive to said first and second axes to be used in the electronic interest rate trading system.

21. A graphical user interface method, according to claim 20, wherein the additional information is at least one of an international stock identification number, a prevailing holding cost, a risk amount, an equivalent reference IRS notional amount, a projected monthly holding cost adjustment, and a probability of early termination.
